(19) United States
(12) Patent Application Publication
(10) Pub. No.: US 2009/0106140 A1
(43) Pub. Date: Apr. 23, 2009

(54) GLOBAL FIDUCIARY-BASED FINANCIAL SYSTEM FOR YIELD & INTEREST RATE ARBITRAGE

(76) Inventor: Alain L. De La Motte, Hillsboro, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/764,175

(22) Filed: Jun. 15, 2007

Related U.S. Application Data
(63) Continuation-in-part of application No. 11/298,314, filed on Dec. 8, 2005.
Application No. 11/298,314 is a continuation-in-part of application No. 11/754,287, filed on May 26, 2007.

(51) Int. Cl. G06Q 40/00; G06Q 90/00

(52) U.S. Cl. 705/37; 705/35; 705/39

(57) ABSTRACT

A supply-and-demand-driven, bankless, interest-rate and yield-setting mechanism for a fiduciary-based financial system that includes parties who want to trade cash and assets as a way of originating arbitrage transactions for the purpose of making money, includes an interest-rate and yield-setting mechanism constructed to provide the parties with the rates and yields necessary to cooperatively mine arbitrage opportunities and, in turn, make money. The mechanism is constructed to operate according to a market-driven, rate-setting process that establishes interest rates without the participation of banks, and may be constructed for a global fiduciary-based financial system to operate in parallel with the global banking system. Many system and method embodiments are proposed, including an automated arbitrage trading-platform system, and a method of providing an alternative international fiduciary financial system that manages investments and risks associated with the transfer of funds between different parties, while enabling non-banking entities to provide traditional banking services without violating national and international banking laws.

### CROSS-REFERENCE TO RELATED APPLICATIONS

This application is a continuation-in-part of U.S. patent application Ser. No. 11/298,314, filed Dec. 8, 2005 and entitled “System and Method for the Creation of a Secure Internet-Based Global Computerized Electronic Market-Making Exchange for Yield Arbitrage”, and also is a continuation-in-part of U.S. Continuation-in-Part patent application Ser. No. 11/754,287, filed May 26, 2007 and entitled “A Revenue-Producing Bank Card System & Method Providing the Functionality & Protection of Trust Connected Banking”; and claims priority to U.S. Provisional Patent Application Ser. No. 60/634,897, filed on Dec. 8, 2004 and entitled “System & Method to Allow Investors and Financial Institutions to Profit Through the Creation of Synthetic Interest Rate Arbitrage Transaction Opportunities that Minimize or Eliminate all Risks for Investors and Financial Institutions Alike”, all of which are incorporated herein by reference.

### TECHNICAL FIELD

The Invention relates to electronic exchanges that facilitate online interaction of individuals, institutions, or corporate entities to close and settle desired financial transactions.

### BACKGROUND

Every United States Dollar bill (currency of the United States) has on its face, these words: “Federal Reserve Note.” Each is an unsecured promissory note, or an unconditional commitment of the Federal Reserve Board to pay the bearer face value on demand. By definition, it is “fiat money,” or more commonly, “paper currency made legal tender by law or fiat, though not backed by gold or silver and not necessarily redeemable in coin.” In other words, it comes into being by an order of legal authority (fiat). In the United States, this currency is only backed by the “faith and trust” placed in the US government. This same government causes every note to be issued. There are no tangible assets or commodities backing its issuance.

Following the passage of the US Gold Standard Act in 1900, US currency was secured by gold reserves. All US currency bore the following words: “Gold Certificate—this certificate is a legal tender in the amount thereof in payment of all debts, public and private—payable to the bearer in gold coins on demand.”

The gold standard became “a commitment by participating countries to fix the price of their domestic currencies in relation to a specified amount of gold. National currency and other forms of money (bank deposits and notes) could be freely converted to gold at the fixed price.” Each country which adopted the gold standard would set a price for its gold; e.g. $100 an ounce, and would buy and sell gold at that price, effectively setting a value for its currency.

In 1933 the administration of President Franklin Roosevelt outlawed private gold ownership by US citizens, following a large decrease in US gold reserves and a large increase in foreign claims on US dollars. At that time, the US suspended the convertibility of its dollar currency to gold. Preparing to rebuild the international economic system as World War II was still raging, 730 delegates from all 44 Allied nations gathered at the Mount Washington Hotel in Bretton Woods, N.H. for the United Nations Monetary and Financial Conference. The delegates deliberated upon and signed the Bretton Woods Agreements during the first three weeks of July 1944. The Bretton Woods system of international monetary management established the rules for commercial and financial relations among the world's major industrial states. The Bretton Woods system was the first example of a fully negotiated monetary order intended to govern monetary relations among independent nation-states.

The Bretton Woods System created a system of fixed exchange rates that allowed countries to sell their gold to the United States treasury at a price of $35/ounce. It further envisaged a system of convertible currencies, fixed exchange rates, and free trade that gave birth to the International Monetary Fund and the International Bank for Reconstruction and Development (now called the World Bank) and the General Agreement on Tariffs and Trade (GATT). By 1969 all countries had dispensed with internal circulation of gold and most did away with gold backing for their currencies.

The Bretton Woods system ended on Aug. 15, 1971, when the administration of President Richard Nixon ended trading of gold at the fixed price of $35/ounce. With the breakdown of a system of fixed exchange rates, the US devalued its dollar twice and then gave up any further attempt to fix its price in terms of gold. For the first time in history, formal links between the major world currencies and real commodities were severed and currencies were allowed to float. The gold standard has not been used in any major economy since then.

Central banks of the world now use a variety of econometric models to measure and forecast various sectors of a country's economy so it may be stimulated or contracted to keep unemployment and inflation in balance. As an example, in the U.S., there are three primary ways that the Federal Reserve Board manages the money supply to expand the economy. 1) Buying back U.S. debt (US Treasuries) from commercial banks, those funds that commercial banks collect from the sale of government securities, thereby increasing the amount they can lend. 2) Loosening credit requirements, thereby increasing the amount of money generated by the banking system. 3) Cutting the prime lending rate, the rate at which the Federal Reserve loans to commercial banks. To contract the economy, the Federal Reserve takes the exact opposite actions.

As long as the primary economic concern of the world's central banks is the stimulation of local employment and world trade, while simultaneously keeping inflation in check, exchange rates, interest rates and investment yields will continue to fluctuate globally, thereby creating differences in interest rates and concomitantly the yields paid for each country's notes.

As an example, at the time of this writing, interest rates on a ten year loan in Japan were less than 1% per annum, while investors in South Africa were being paid a yield of 7.98% on its R153 government obligations, with a buy-back repo (repurchase) rate of 7.00% per annum.

The realities of a country's economy and its balance of trade are normally reflected in the strength of the exchange rate of the currency and the prevailing central bank rates and retail bank rates. Since central banks are frequently adjusting monetary policy to control their respective economies, there will always be differences in interest rates by country, therein simultaneously reflected in the exchange rates of global currencies. These differences drive arbitrage opportunities tied to differing currencies, and as long as such disparities between interest rates and yields exist, the present arbitrage Technology will present enormous opportunities.

There are several other factors that are important to understand as background to this invention.

### Overview

### General Considerations

Fiat money is that currency issued under a government's legal authority. It is an unsecured promissory note of a central bank to pay the note holder (backed by the full “faith and trust” of the government) based on that country's credit strength, itself supported by its economy.

By comparison, commodity-backed currencies offered holders the option to redeem “paper money” for a unit of a commodity (e.g. gold) on simple demand. In that commodities are limited by nature and seldom decrease in value, commodity-backed currencies seldom decreased in value.

By contrast, the global fiat monetary system eliminated the individual, transferable wealth creation nature afforded its owner by a commodity-backed currency, and reduced the function of money to that of a settlement or trade medium only (it is a means of transferring value for services rendered or goods purchased).

More importantly, in the absence of a commodity-backed national currency, a nation's government has the unlimited capacity to print and distribute it's currency at will, to finance those programs and services it deems necessary, from social programs to war. The more currency put in circulation, the more quickly the currency decreases in value and buying power.

Though the words, “Federal Reserve Note” are on the face of all US currency, that currency is actually issued by the Federal Reserve Board, a privately owned and operated central bank (a bank of banks) that holds an exclusive license from the US Government to print and place into circulation US currency. The Federal Reserve Board in effect operates as an exclusive franchise to print, distribute, and lend money at interest. However, unlike any other entity that contracts to provide services to a country, US currency is fully guaranteed by the full faith and trust of the United States Government (“the people” of the country).

In law, a promissory note is a legally binding obligation of one party in a trade to pay the counterparty a specified “value” on demand (when the note is presented for redemption). In exchange the note issuer must receive “consideration” (value) in order for the note to have “legal” standing. Without “consideration” paid for the issuance of a promissory note, the note, a legal agreement between two counterparties, has no legal basis in a court of law. Therefore, “consideration” is of significant import.

The world's fiat currencies are an effective and convenient means to buy, sell and trade. However, by foregoing commodity-based currencies and accepting the global monetary system, every country's citizens have traded control of their own “paper wealth” for transactions convenience. In this system paper wealth (assets) are placed with a retail bank, thereby creating a liability for the bank, but simultaneously affording the same bank to treat deposits as an asset, which can then be leveraged and arbitraged at will.

### Other Factors Concerning the Global Monetary System

The following additional factors are important in understanding the global monetary system.

1. Since 1973 and the end of commodity backed currencies, central banks and their respective governments have determined that the total production (labor, services, & products) of a country would be measured by a country's Gross Domestic Product (GDP) or Gross National Product (GNP), or variations thereof. The gold standard was replaced by a mathematical model which calculated the aggregate productivity of its citizens and became the new security, or collateral, for a government's indebtedness. This model, in turn, allowed central banks to calculate how much currency to produce and place in circulation to sustain the economy, as well as control inflation. The objective of money production became that of stimulating employment and external trade while controlling inflation. In one broad sweep, the legal nature of currencies (or notes) changed. Every currency/note is now “legal tender for all debts, public and private.” Currency became, no more, no less a medium for a government and its citizens to settle individual transactions or debt. The impact of this change was monumental and the long-term consequences seldom understood: a monetary system in which fiat currency could only be exchanged for similar fiat currency. In effect, the security offered by a valuable commodity was replaced by mathematical formulas derived from the measurement of an economy. This system created a method of total dependency of the citizens to support a country's economic development. A country's poor economic performance or government mismanagement results in the devaluation of that country's currency and the wealth of its citizens.

2. Retail banks became the collection and distribution “arm” of each central bank, connected to central bank as a member bank, thereby gaining access to the services offered by the central bank. Each central bank, in turn, is a member of a larger fraternity of central banks linked through the Bank of International Settlement in Basle, Switzerland, the central bank of central banks, which serves as a global settlement bank between countries.

3. Each retail/member bank has access to all the services provided by its central bank including “discounting” facilities. It is the discounting process that justifies the printing and distribution of money. When a bank customer purchases a $1,000 certificate of deposit, the issuing bank receives a cash deposit and issues a note or certificate that is redeemable at maturity. Having received $1,000 for a term deposit, the bank is then free to lend the deposit at a rate that is usually several percentage points above the interest rate paid to the depositor. This spread differential represents the bank's profit, or arbitrage, a function of the interest one customer is willing to accept and another is will to pay to receive a loan. Through a process known as discounting (or as the US Federal Reserve Board describes the process, “borrower in custody”), a retail bank can immediately regain liquidity following a loan by pledging to the central bank, or other money center banks involved in the inter-bank loan market (LIBOR or EURIBOR), its perfected security interest in the collateral it holds for loans made. The cash liquidity it receives through this process can then be re-lent again at a profit, the difference between the central bank discount rate and the new loan placement rate (again an arbitrage between the bank's cost of money and the interest rate a borrower is willing to pay). This process of a banks borrowing from one customer (say at 3%) and lending to another (say at 6%) and then recovering liquidity through the discounting process (say at 3%), and re-lending that liquidity (say at 6% again) is commonly referred to as the 3-6-3 principle of banking (refer to FIGS. 25 and 26 attached hereto). What the 3-6-3 principle describes is simply the “arbitrage” process that banks engage in to make money by intermediating transactions between a lender, a borrower and the source of liquidity (the central banks, money center banks or other banks).

4. Central bank regulations require each member bank to maintain a portion of its cash deposits in its non-interest-earning account at the central bank. This reserve set-aside is designed to protect depositors in case of a run on a bank. Larger banks are often required to maintain larger reserves than smaller ones due to increased liquidity risk. Bank reserves, also known as fractional reserves, are a tool of central bank monetary policy to tighten or loosen its credit policy. An increase in the ratio of required reserves to deposit indicates a tightening in credit policy whereas the opposite indicates a desire to stimulate credit, which in turn results in economic expansion. A reserve requirement of 10%, as in the United States, simply means that the bank can lend only $90 on a $100 deposit ($10 is left on account at the central bank). When re-deposited in the bank by the borrower, the $90 loan proceeds qualifies as a new deposit which can be re-lent again at 90% ($81). This process can continue until there is, in essence, a net zero balance left to loan. This “multiplier” effect of money is also referred to as leverage, because a $100 cash deposit can be leveraged into loans totaling $900, a net 9:1 leverage so long as the bank's capital ratios (Tier I and Tier II capital) are satisfactory. Therefore, significant profits are achieved by banks through this process of leveraging deposits and making loans at an interest rate greater than the cost of money. Reserve requirements differ by country, resulting in economic disparities between economies in terms of the leverage afforded the banks.

5. Banks profit by taking deposits, which they then re-lend to borrowers. In that sense, a bank is no more no less than an intermediary that is licensed to collect money from Party A and lend to Party B.

6. Central banks hold an exclusive license to print and distribute currency so as to support the economy of a country. It is reported that the cost to print $1 mM in US currency is approximately $133, possibly making the Federal Reserve, and its member banks, the most profitable business in the world. Banks make money by charging interest and, to regain liquidity, by discounting the collateral of such loans with the central bank. It is the discounting process which drives the printing and distribution of money. In this same process, central banks accumulate a country's wealth in a central repository (the reservoir of wealth), which citizens can access by borrowing. The acquisition and centralization of the wealth of a nation is then accomplished by the issuance of notes (currency). Thereby, each central bank controls those who may, and those who may not borrow from the “treasury” (the reservoir of a nation's wealth). Thus the rise of credit ratings which favor or disfavor borrowers based on the ability to manage debt. Recognizing the power central banks hold over a nation, perhaps even greater than that of its government, the patriarch of today's international bankers, Mayer Amschel Rothschild confidently stated, “Give me the power to issue and control the money of a nation and I care not who makes its laws.”

Money is only placed into circulation by the creation of debt (the issuance of promissory notes designed to centralize true wealth). As a result, central banks regulate the value of money by controlling the cost of debt by arbitrarily raising and lowering interest rates to expand or contract a country's economy. Central banks can single-handedly influence or change the relative values of the currencies of the world by intervening as market participants (individually or in cooperation with each other), in the purchase or sale of currencies they wish to favor or disfavor. Central banks can control indebtedness by regulating borrowing and lending that favors one party over another. This kind of control offers central banks incredible rate-setting powers, in that a simple vote of central bank directors can cause engender displacements of wealth to occur, from one group of citizens to another, from one country to another, from one people to another, bringing with it a tsunami-like impact on individuals, groups, and nations.

7. When a corporation issues and sells a note (corporate debt) into the capital markets (e.g. a senior unsubordinated note), it increases cash liquidity that flows directly to its balance sheet. There are two primary types of notes—with interest or without. Notes that pay no interest until maturity are frequently referred to as zero coupon notes for the interest earned, or payable is deferred until maturity. Corporate Notes are fixed-income instruments that pay interest quarterly, semi-annually or annually (or at maturity in the case of a “zero’) and are sold at a discount or at a premium based on prevailing interest rates. At maturity the note holder redeems the note for cash equal to the note's face value. In the case of a zero-coupon note, it is purchased at a deep discount relative to its face value. For instance, if the US 10 year treasury yield is 4.2% p.a., a ten year zero-coupon note will sell at 66.25% of its face value. The interest is then collected, along with the principal at maturity.

8. A note is for all practical purposes a security. The sale of non-bank or government issued notes is highly regulated by governments, at the instigation of the banks, since such notes compete with the central bank's own notes. Therefore, a prospective note issuer must incur significant expense (often $100 Ms) to engage the necessary legal and tax counsel prior to issuance. For this reason, the issuance of notes by small businesses and individuals is prohibitively expensive for those that otherwise might raise operating capital outside the banking system. There is no known source, process or system anywhere in the world in which a party desiring to issue a security/note could cause the instantaneous underwriting, issuance and sale of a note, while meeting all regulatory and legal requirements.

9. Should one attempt to arbitrage the difference that exists between a high investment yield (lending interest rate) available in one country (e.g. South Africa with a 7.98% current annualized yield) and a low borrowing (interest) rate offered in another (e.g. Japan with less than 1% current interest rate), wisdom would dictate the establishment of a forward currency hedge to eliminate the long-term currency fluctuation exposure risk. However, despite the arbitrage opportunity, the foreign exchange futures markets have become so efficient that the cost of such a hedge would without a doubt eliminate the potential profits of such an arbitrage . . . risk.

10. Globally, the central banks have created an efficient market for currency futures, options, swaps and swaptions, as well as for interest rate swaps (fixed rate for variable and variable for fixed). Therefore, were one tempted to borrow in a currency that has a low interest rate, convert the proceeds and reinvest same in a higher yielding currency, it is highly probable that the cost of hedging the currency risk during the transactions term would entirely offset any profit potential that might be achieved through the two differing interest/yield rates. Arbitrage opportunities lost due to currency risk costs are a function of those institutions that underwrite currency risk. Those underwriting currency risk are generally the global money center banks and financial institutions. They most often are the ones able to capture the profit in arbitrage opportunities by charge a hedging cost (e.g. a futures contract) that equals the arbitrage, easily calculated through knowledge of the currencies involved.

11. Loans normally carry an annual interest rate computed on the outstanding balance due. Similarly, an investor willing to lend funds by purchasing a financial instrument (e.g. a certificate of deposit) from a bank will be guaranteed a fixed or variable rate of return on the investment. The interest paid on a loan is a cost to the borrower while it is income to the one that purchased the financial instrument.

From the perspective of both, the future value of an interest payable or an interest receivable can be reduced to a present values using the following formula:

PV*(1+Rate)^{nper}+pmt(1+Rate*type)*(((1+Rate)^{nper}−1)/Rate)+FV=0

V(rate,nper,pmt,fv,type) in which:
Rate is the interest rate per period.
Nper is the total number of payment periods in either.
Pmt is the payment made each period and cannot change over the life of the loan or deposit. Typically, Pmt includes principal and interest. If Pmt is omitted, the Fv calculation must be included.
Fv is the future value, or a cash balance that needs to be achieved following the last payment.

Type is either 0 or 1, indicating whether the calculation is based on 360 or 365 days.

13. An excerpt from the Financial Times sheds an interesting light on an aspect of the global financial markets that is not generally recognized, and that is the world of derivatives: “When the Bank for International Settlements, the central banking group, did its last triennial survey of the global derivatives and foreign exchange world in 2004, the results shocked some. The Basel-based group put daily global derivatives turnover at almost $6,000 billion—half the size of the US economy¹. Now the BIS could startle again. Yesterday, it announced another survey of the derivatives market that it hopes to complete “before the end of 2007” and which will cover the credit derivatives world for the first time . . . ²” These are numbers are difficult to comprehend, or even imagine, particularly in light of the revelation that “credit derivatives” were not included in the 2004 figures, and are expected to be greater in total than all other derivatives. There must be recognition that there are currently more than $1,380 Trillion in derivative instruments traded annually, excluding credit derivatives which are anticipated to be an even larger figure. If one were to consider that the total annual US economy is only $12 trillion and that the entire world economy is slightly above $40 trillion, there is a need to recognize that 2004 global derivatives trading was more than 30 times greater than the global economy. ¹ Assuming a total of 230 banking days a year, that puts the total market size at some $1,380,000,000,000,000 [that's 1,380,000×$1 Billion] or $1,380 Trillion a year).² Innovation Combat Zone, by Gillian Tett. The Financial Times—Jul. 19, 2006.

With this in mind it will be easier to understand the critical nature of the invention which is presented herein and why it could provide much needed accountability to the global financial system through an interest rate-setting and yield mechanism that is entirely market-driven by supply and demand.

### SUMMARY OF THE INVENTION

The invention may be thought of in many ways as is described below. One embodiment is a supply-and-demand-driven, bankless, interest-rate and yield-setting mechanism for a fiduciary-based financial system that includes parties who want to trade cash and assets as a way of originating arbitrage transactions for the purpose of making money. This embodiment includes an interest-rate and yield-setting mechanism constructed to provide the parties with the rates and yields necessary to cooperatively mine intra-currency or cross-currency arbitrage opportunities and, in turn, make money. The mechanism is constructed to operate according to a market-driven, rate-setting process that establishes interest rates without the participation of banks, and may be constructed for a global fiduciary-based financial system to operate in parallel with the global banking system.

Many other embodiments involving systems, system components, and methods are proposed, including an automated arbitrage trading-account system, and a method of providing an alternative international fiduciary financial system that manages investments and risks associated with the transfer of funds between different parties, while enabling non-banking entities to provide traditional banking services without violating national and international banking laws.

### DESCRIPTION OF THE DRAWINGS

FIG. 1 is a diagram which describes a global fiduciary-based financial system that operates in parallel with the current global banking system and uses a network of interconnected trust to duplicate, in structure and functionality, the global banking system.

FIG. 2 is a diagram that describes the unit participation trust structure envisioned by this invention and the relationship of individual account holders to the trust. In this example the fractional ownership system is described wherein the issuance and sale of a trust-preferred variable rate note issued by the trust gives the holder a beneficial interest in the trust for the amount for the amount of his outstanding balance.

FIG. 3 is a diagram that explains the interconnectivity of the trusts and their individual relationship to an in-country or regional master trust, and the standard list of service providers to the trusts.

FIG. 4 is a flowchart that describes the process for establishing a master unit participation trust and the relationship of that one trust to its sub-trusts, the trading platform of the exchange, the custodial bank and the commercial bank that offers a net zero pass through account system for trust-connected debit cards.

FIG. 5 is a diagram that shows how nested sub-accounts relate to trust sub-accounts, that themselves are encompassed within a particular unit participation trust, which is itself connected to a master trust for the purpose of allowing funds to be aggregated for investment purposes all the way from the nested sub-account to the master trust so as to deliver an investment profit to trust beneficiaries pro-rata their account balance.

FIG. 6 is diagram that illustrates how account balances of each trust of the global network can be aggregated at the master trust level daily for investment in “permitted investments” of the trust.

FIG. 7 is a diagram that illustrates how the principal balance and the investment profits are redistributed back to account holders after each investment cycle permitted by the trust agreement.

FIG. 8 is a diagram that illustrates the local structure that a master trust and its local trusts have and the inter-connectivity that may exist between sub-trusts for the purpose of transferring liquidity from one trust to another, from one master trust to another. In this example a network of trusts in Japan is superimposed on to of a similar one in South Africa. The two networks are presented as if on two different planes. The purpose of this diagram is to show that by connecting the master two master trusts to each other through a contractual or ownership arrangement (the two central hubs), all the spokes (the sub-trusts) are automatically connected for the purpose of being to do business with each other. Extrapolating now from 2 countries to the countries of the world, this diagram illustrates how a global network of inter-connected trusts is possible by connecting all the in-country or regional master trusts to each other via the local master trust.

FIG. 9 is a diagram that illustrates the same connectivity at a country level, whereas this diagram shows how global connectivity can be achieved by connecting all master trusts to a Global Master Trust which itself is connected to a market-driven global exchange for efficient arbitrage of interest rates and yields in cross-currency opportunities.

FIG. 10 is a diagram that is similar to FIG. 5 above, but with the difference that it shows how accounts are connected via a switch infrastructure to facilitate the automatic aggregation and investment of trust funds and trust account balances.

FIG. 11 is a diagram that describes the process of aggregating and investing idle funds of the various trusts in permitted investments through designated investment managers of each trust.

FIG. 12 is a diagram that explains the fiduciary accounting structure that supports each trust sub-account and how they relate to bidding on the exchange.

FIG. 13 is a diagram that explains the function of the switch and how a debit card can be offered trust sub-account holders in conjunction with the trading and trust accounts.

FIG. 14 is a flowchart that shows the initial processing specifications of the switch infrastructure and how the switch connects to a variety of accounts, both on the trust side and on the exchange.

FIG. 15 is a flowchart that shows how a debit card is linked to a net-zero pass through bank account and is able to draw funds directly from the trust sub-account through the connecting switch.

FIG. 16 (a) is a flowchart that shows how a trading account on the exchange is interconnected via the switching infrastructure to the trust sub-account so that the balance in the trust sub-account in a local currency can serve to derive a notional currency balance amount in the trading account so that the notional currency can be used by the account holder to trade on the exchange.

FIG. 16 (b) is a summary diagram that shows all the connections of the switch infrastructure and how, through it a variety of accounts that perform a variety of functions and serve a variety of purposes to support the trading requirements of the exchange and the cash-backed securitization process required by it.

FIG. 17 is an example of the Transaction Unit Index. In addition this diagram contains an example of a bond calculator and the parameters used to convert a yield to maturity to a discount or premium price and vice versa.

FIG. 18 is a diagram that describes the trust sub-account structure of trusts sponsored by employers, affinity groups, retailers, etc.

FIG. 19 is a diagram that is similar to FIG. 18, except that it shows how these same organizations can, through the sponsorship of their own trust, offer a trust-connected debit card to their employees, members, customers or business partners.

FIG. 20 is a diagram that shows the connection between individual trust accounts and the escrow account process that must support all trading activities on the exchange.

FIG. 21 is a diagram that shows the way the fiduciary plane of the system interacts with the retail plane of the exchange.

FIG. 22 is a summary diagram that shows all the component parts of the system as well as the process flow for trading on the exchange and the system infrastructure required to support a full-cycle arbitrage opportunity origination in local or global interest rates/yields, in a single or multiple currencies, and the closing of such opportunities for profit.

FIG. 23 is a flowchart that illustrates the account opening process for a sub-trust account that also requires connectivity to a trading account on the exchange.

FIG. 24 is a diagram that explains how through a process of offer and bid an arbitrage opportunity can be created that will deliver significant profit opportunities to the arbitragers. The diagram further illustrates the critical points of the transaction that eliminate risk.

FIG. 25 is a diagram that explains the well-known 3-6-3 principles applicable to banks. It shows a bank earning a 3 point spread at the retail level (left side of the diagram) and another 3% spread by discounting a loan made at 8% at a lower 5% discount rate. The diagram shows how banks generate profits by attracting depositors' funds, making loans and discounting or borrowing against those loans to regain liquidity which they can lend. This process can be repeated by the leverage permitted by the local central bank so long as the bank's Tier I capital will support such leverage.

FIG. 26 is a diagram that explains the process of bank customers benefiting from the disintermediation that takes place when a lenders and borrowers work cooperative to borrow and lend to each other directly, not via a bank acting as a middleman.

FIG. 27 is a diagram that illustrates the bidding ranges that are likely to result when residents of countries around the world start to submit offers and bids to the exchange and the arbitrage opportunities that will result from it as a result.

FIG. 28 is a diagram that explains the process used to cause the origination of an arbitrage of interest rates and yield to occur and the closing process that ensues to limit or completely eliminate all risks.

FIG. 29 is a diagram that explains the process used to cause the origination of an arbitrage of interest rates and yield to occur and the closing process that ensues to limit or completely eliminate all risks. In this diagram however, specific offer and bid examples populate each variable.

FIG. 30 is a diagram that explains the process used to cause the origination of an arbitrage of interest rates and yield to occur and the repo lending and hedging operations that support it.

FIG. 31 is a diagram that illustrates how offers and bids from each bin interact between the retail and the whole planes of the exchange in order to cause a profitable arbitrage transaction to result. It shows also how offers and bids at the wholesale level can flow to the retail and how deal originations can flow from retail to wholesale also.

FIG. 32 is a diagram that explains how offers and bids are grouped into 10 different groups called bin (identified by bin numbers) and the bid matching process that causes one offer or bid to be chosen over another.

FIG. 33 is a diagram that shows how a full-cycle arbitrage opportunity origination in a local or global interest rates/yield is done.

FIG. 34 is a diagram that shows the objectives of the ten bins and their respective contributions to the full arbitrage origination and closing structure that produces a profit without risk of loss of principal for the arbitragers.

FIG. 35 is a flowchart that shows the process of evaluation that each offer and bid must go through before it is accepted as a closing component for a full-cycle arbitrage transaction closing.

FIG. 36 is a diagram that illustrates the offer and bid-process for a single currency for either an interest rate in the case of a loan or a yield to maturity in the case of a fixed income investment.

FIG. 37 is a diagram that illustrates the offer and bid-process for a two-currency arbitrage involving two different local interest rates or yields.

FIG. 38 should be reviewed with FIG. 23 above. This diagram illustrates how the offer and bid process is originally distributed for processing at the lower level part of the process before being aggregated into each of 10 separate bins that are designed to provide a very specific type of product for the origination of the arbitrage opportunity. This diagram (together with FIG. 23) illustrate how at the onset, the opening of a trading account requires the adoption of standardized agreement that will govern all loans and all issuances of trust securities by the trusts.

FIG. 39 is a flowchart that shows the process of evaluation that each offer and bid for a swap must go through for processing, posting and closing on the exchange.

FIG. 40 is a diagram that illustrates how bidders from around the world can profitably participate on the exchange by making offers and bids. In this example, we use two countries, one (A) where there is a very low interest rate, and the other one (X) where there is a very high investment yield. In this case two successful bidders in country A will have respectively borrowed locally at 1.5% and 2.5% each and placed their bids at 2.5% and 3%, thereby making a local profit of 1% and 0.5%. In contract, in country X, two parties are able to raise money through the issuance of notes at 7% and 8% respectively, whereas they can reinvest the proceeds (after conversion from the currency of Country A to that of Country X via the current TU index rate) at 9% each, thereby making a profit of 2% and 1% in their own currency. The swap process in this invention demonstrates further how the transaction is further unwound for profit to eliminate the currency risk if the notes are kept to maturity.

FIG. 41 is a diagram that illustrates how a zero coupon of $1,000 paying a yield of 5% per annum to maturity is priced at a discount rate of 61.027% of face value ($610.27 in this case), and the accounting treatment that both issuer and buyer must adopt in their respective books. This diagram illustrates in a different manner also how a zero coupon note purchased at 61% of face will appreciate to the face value of the instrument over a ten year period, thereby delivering a 5% yield to maturity.

FIG. 42 is a diagram that illustrates how two zero coupon notes issued in different currencies are priced at swap time. The swap illustrated in this example shows one party desiring to swap a South African Rands note payable in ten years with a Yen-denominated note payable in ten years. At maturity the party holding a yen note today will collect South African Rands and vice-versa.

FIG. 43 is a diagram that illustrates the bid matching process and the bidding parameters for each bin category. When assembled together in a single simultaneous closing, the assembly of individual offers and bids that meet the requirements of this process will deliver an automatic arbitrage profit to the arbitragers.

FIG. 44 is a diagram that further describes the switching mechanism and the controller process that drives it.

FIG. 45 is a flow chart that should be looked at in conjunction with the 3 pages that make up FIG. 46. This diagram illustrates the process described in the figures presented on FIG. 46. This process demonstrates that it is possible to secure a guaranteed arbitrage profit when all the transaction parameters and pre-engineered closing conditions are met.

FIG. 46 consists of 3 consecutive pages that describe the steps of the process of creating a profitable (single currency) arbitrage and provides mathematical support for the assumptions made in this invention.

Important Note: The Game herein constitutes one of several embodiments in accordance with claimed subject matter. It is, of course, not intended that claimed subject matter be limited to this particular embodiments. This particular embodiment is provided merely as an illustrative example of one of several potential implementations of claimed subject matter; however, this example is not intended to limit the scope of claimed subject matter in any way.

FIG. 47 through 52 represent game pieces that can be printed and individually cut to play the illustrative game provide herein to demonstrate in graphical form one embodiment of an arbitrage process done through a repetitive process followed by the exercise of an option to call and a subsequent offset.

FIG. 53 shows the financial standing of Customer 1 at the end of the game. This is further supported by the description and amounts of all the game pieces left on the board at the end.

FIG. 54 shows the financial standing of Customer 2 at the end of the game. This is further supported by the description and amounts of all the game pieces left on the board at the end.

FIG. 55 shows the financial standing of Customer 3 (the party who exercises the option to call the loan and investment portfolios of Customers 1 and 2) at the end of the game when it becomes desirable to offset matching assets and liabilities that have similar maturities. This is further supported by the description and amounts of all the game pieces involved in the offset.

FIG. 56 shows the increased financial holdings of Customer 3 at the end of the game after he receives a refund of prepaid interest that had been deposited in a sinking funds to secure ten future years of interest. This is further supported by the description and amounts of all the game pieces involved in the offset.

FIG. 57 shows how the game started out with an investment of $3,314,528 (by 2 investors) to start the process and at the end, the total monetary value created is $7,316,528 in a matter of days, thus allowing all the parties in the transaction to make a profit (without risk), including the participating banks.

Attachment A is a copy of co-pending U.S. patent application Ser. No. 11/298,314, entitled “System and Method for the Creation of a Secure Internet-Based Global Computerized Electronic Market-Making Exchange for Yield Arbitrage”.

### DETAILED DESCRIPTION OF THE PREFERRED EMBODIMENT

Briefly, several embodiments are described below in accordance with claimed subject matter. It is, of course, not intended that claimed subject matter to be limited to these particular embodiments. Such embodiments are provided merely as illustrative examples of potential implementations of the invention; however, these examples are not intended to limit the scope of claimed subject matter in any way.

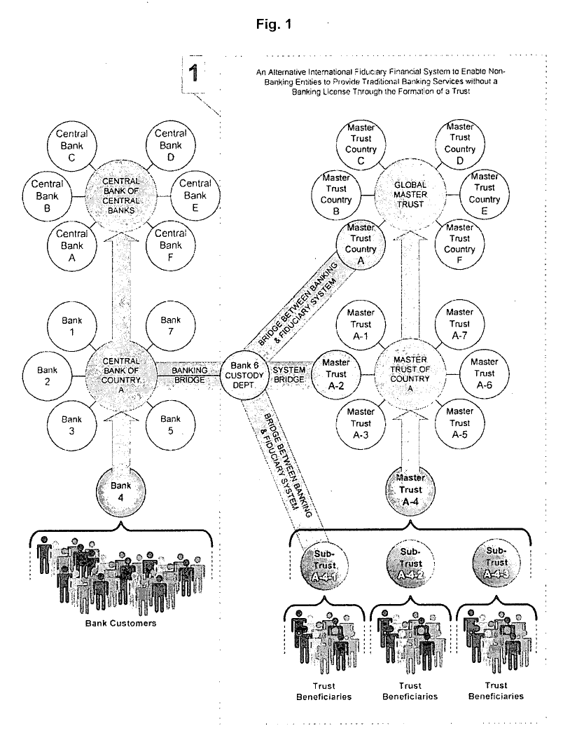

For example, briefly, in one possible embodiment is a supply-and-demand-driven, bankless, interest-rate and yield-setting mechanism for a global fiduciary-based financial system that operates in parallel with the current global banking system [Refer to FIG. 1] but delivers a market driven rate-setting process for the establishment of global interest rates rather than through the decisions of central banks. The term bankless is coined to describe an important feature of the invention, namely, that the invention is usable to set interest rates and yields without bank action or decisions.

Also, from an overview, the invention is described below by reciting certain mechanisms and other components designed to carry out the to-be-described details. To implement any and all of the to-be-described details, it is presently planned to utilize suitable software, firmware and hardware technology, as well as suitable electronic and telemetric communication technologies. Also, to provide communication devices/mechanisms, also referred to as communicators below, any suitable combination of software, firmware and hardware may be used, as well as conventional communication devices (e.g. a PDA, a phone, a computer).

It will also be understood from the description below that the timing of actions and, particularly with respect to-be-described transactions, is important. As described below, adjectives such as “immediate” and “simultaneous” are used to show the preferred timing of certain actions/transactions. However, it should also be understood that the invention is by no means limited to this timing requirements.

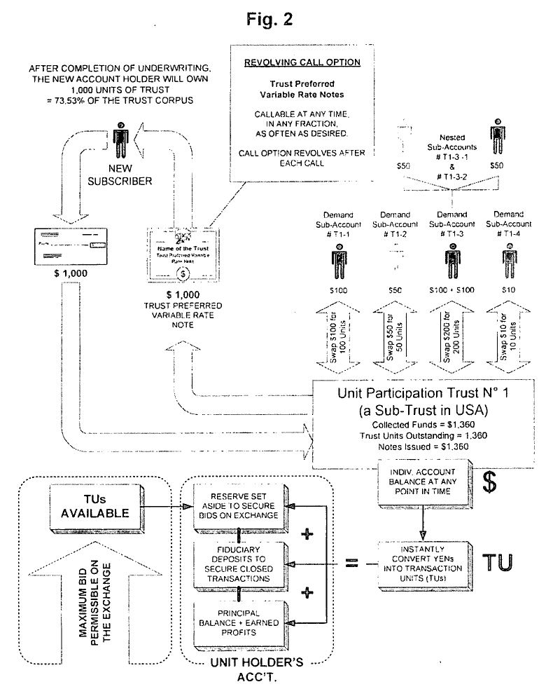

The invention is also not limited in scope to a system providing a global trust network or an electronic exchange. Nonetheless, continuing with this example, for this particular embodiment, such a system may, for example, use a legal structure for each node of the master hub comprising of a unit participation trust in which trust beneficiaries are fractional beneficial units owners through the acquisition (settled in a particular local currency) of a Trust-Preferred Variable Rate Note which entitles each holder thereof to share in the profits of the trust in pro-rata of his holdings relative to the total assets of the trust [Refer to FIGS. 2 & 5]. In this embodiment, such a note is designed to have a put option which allows the note holder to put the note back to the trust at any time for the purpose of redeeming all of part of his investment in the trust on simple demand. In another embodiment, it can be envisioned that such an option would not exist and that trust deposits would be subject to other conditions.

Through the use of a trust which is governed both by the trust laws of the country of domicile and by an agreement duly executed between the original grantor (a nominal contributor to start the trust) and a trustee, this new system of interrelated trusts, as will be explained later, provides the type of fiduciary protection which the current banking system does not. If a bank becomes insolvent, depositors may loose their entire account balance over and above the insured limit. By contrast a trust can only be managed in accordance with the terms and conditions of the trust agreement and cannot become insolvent if the trust agreement precludes investments that place trust funds at risk. Additionally, since the cash of the trust which is on deposit in the custody of a bank are not considered assets of the bank in the same manner that bank depositors' funds are trust funds placed in the custody of a bank may not under any circumstances be the attached by the creditors of a defaulted or insolvent bank.

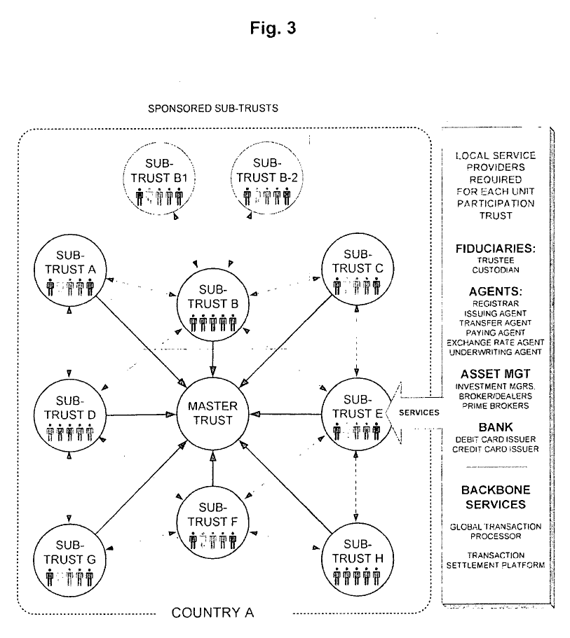

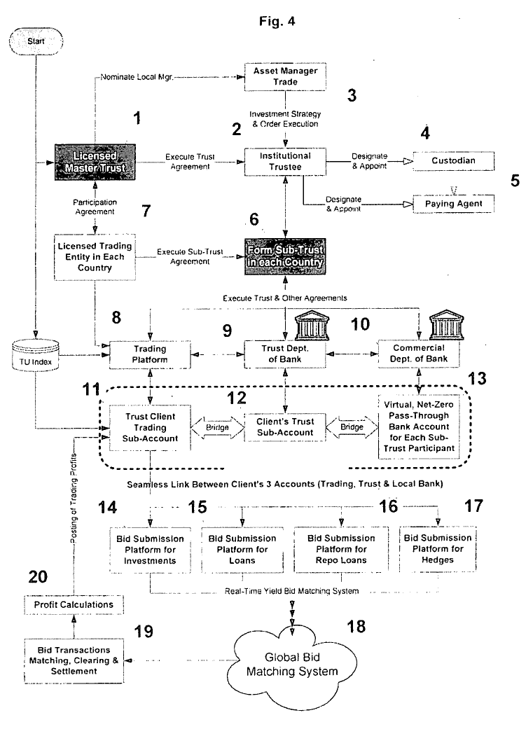

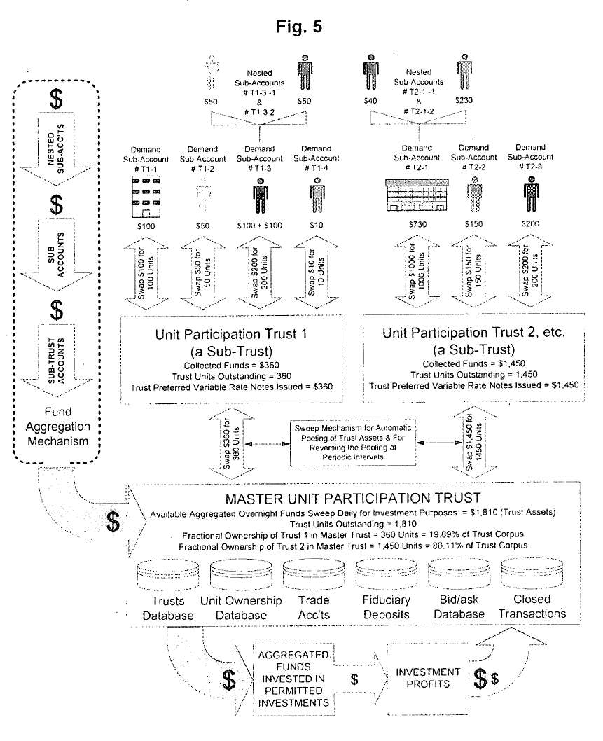

In a trust structure envisioned under such an embodiment [Refer to FIG. 3], a trust is formed and registered with the local authorities. Formation of the trust requires the execution of a trust agreement between a grantor (a nominal contributor of cash to form the trust) and a trustee, or in some instances multiple trustees acting as co-trustees [Refer to FIG. 4].

Furthermore the trust agreement can make provision for the appointment of a variety of services providers to the trust, including, but not limited to: auditors, accountants, tax accountants, legal counsel, global custodians, registrars, issuing agents, transfer agents, calculation agents, paying agents (or paymasters), exchange rate agents, TU Index calculation agents (addressed below), underwriting agents, investment managers, broker/dealers, prime brokers, debit card issuers, credit card issuers, global transaction processors, card transaction settlement platforms, system integrators and managers, and other service providers such as information system integrators and computer services providers, all acting as agents of a trust for the delivery of a service under contract.

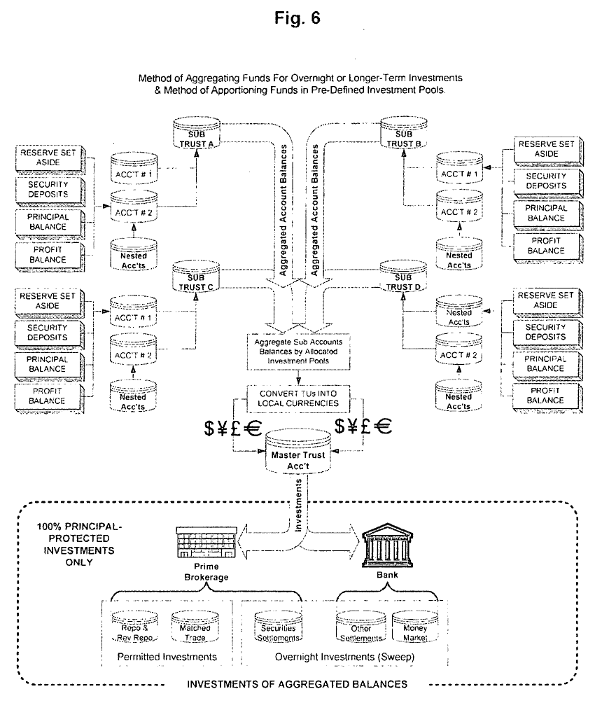

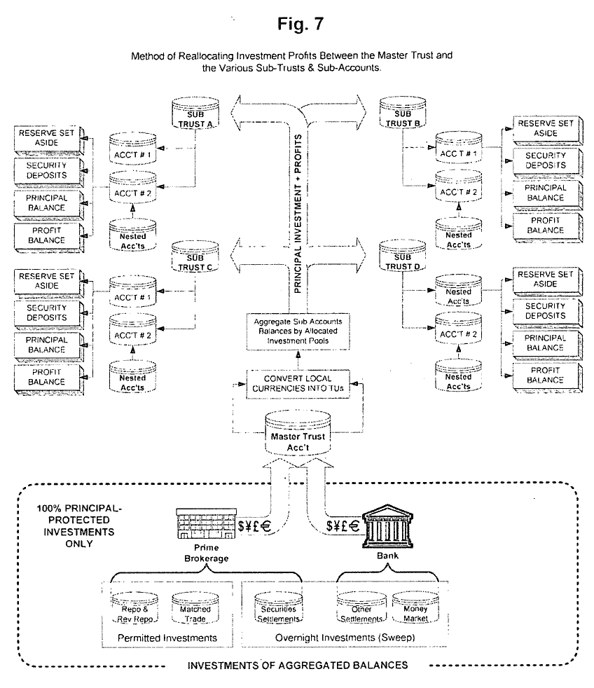

In the system described in this embodiment, the trust agreement that governs the management and administration of each trust permits the periodic aggregation of idle funds [Refer to FIGS. 5 and 6] on deposit in each account and the investment of the aggregated total in pre-defined investments designed to eliminate or minimize the risk while providing a maximum return on investment within the guidelines of what the trust agreement calls the “permitted investments” of the trust. In this system, trust note holders receive periodic dividends [Refer to FIG. 7] on their notes in the form of trust distributions which, to the account holder, represents investment profits.

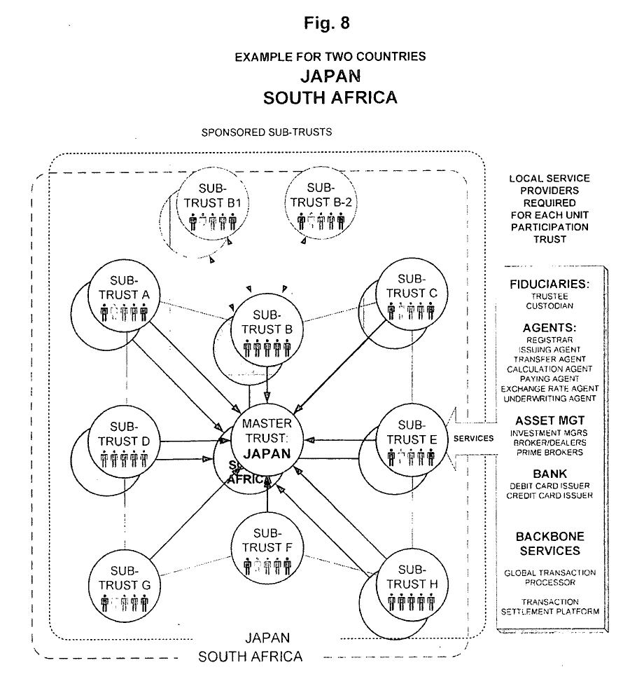

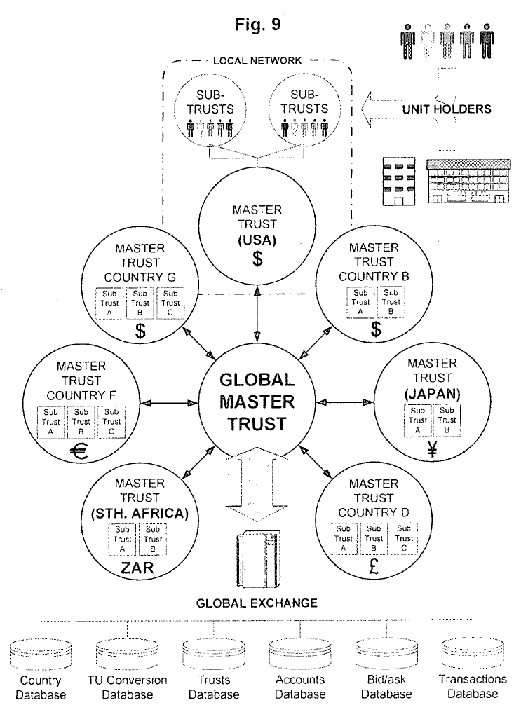

For this particular embodiment, a series of trusts and sub-trusts may be related or connected via a master trust operating at, for example, a country-wide level [Refer to FIG. 1], although this is mere one example. Likewise, financial transactions may be executed, for example, in such an embodiment, through a transfer of assets upstream from a subsidiary trust, such as a trust or sub-trust, for example, to a parent trust, such as a trust or master trust, or laterally from one trust to another trust, or one sub-trust to another sub-trust, in exchange for a trust preferred variable rate note [Refer to FIG. 9] giving the subsidiary trust a fractional ownership interest in the master trust. Likewise, multiple country-specific master trusts may be employed [Refer to FIG. 8], if desired, which, in turn, may be linked upstream to another regional or global trust to form a local, regional or global structure of trusts [Refer to FIG. 9] which may likewise be inter-related and/or inter-connected, and wherein subsidiary trusts, for example, may with relative ease and freedom buy and/or sell trust-preferred variable rate notes to each other or to the public to move assets or make liquidity adjustments from one trust to another with a modest amount of efforts and/or complications. For instance, a trust based in New York might wire funds at the close of business to a trust based in Hong Kong so that the Hong Kong Trust might be able to trade on the funds of the New York trust during the night and return the funds with profits by the next morning. Additionally, investment opportunities that may exist in one country may be made available to trusts in other countries through simple communication that allows funds to aggregate in the country where funds are able to capture that particular investment opportunity.

Although claimed subject matter is not limited in scope in this respect, in that a Trust Preferred Variable Rate Note issued by one trust to the benefit of another for this particular embodiment will govern multiple deposits and withdrawals between the two trusts, the note purchase agreement executed between the two trusts at the onset of a new relationship may make provision for a form of note that has a floating principal balance rather than a fixed note principal amount, wherein the amount due at a particular point in time is the outstanding account balance at that particular time. Therefore, in such an embodiment, for example, a single note purchase agreement executed between two trusts may be employed to govern future debits and credits between the various trusts, for example.

In this embodiment, for example, the trusts may employ a substantially identical unit participation structure through adoption of a standardized set of trust agreements and master agreements that govern the relationships among the various trust entities (e.g., master trust, trusts, and sub-trusts) including the flow of money from one trust to another and from one country to another. Likewise, although claimed subject matter is not limited in scope in this respect, through a simple process of executing an adoption agreement at the onset, for example, a particular trust node of a national or regional trust network will be able to adopt a body of agreements that may be employed from that point forward to govern the relationship and activities of that trust with the remaining trusts of the network. In this manner, if desired, for example, franchises and/or licenses may be made available for cities, regions, countries and other various sub-divisions. As may be now appreciated, due to a phenomenon sometimes referred to as “network effects,” the more trusts are in operation the more beneficial the entire structure becomes. This is similar to the notion that the more phones around the world, the more beneficial or valuable each phone becomes.

Two additional aspects of this embodiment are worthy of discussion. The first is that if the trust agreements governing the trusts of the network are identical or nearly so, such as with the exception of differing laws and trustees with respect to issues of permitted activities and investments, risks associated with one trust should be nearly identical to another. Therefore the transfer of assets from one to another will not be subjected to any materially greater risk, especially if two trusts have the same trustee, though different rates of return may apply. The second is this, since anyone may be permitted to create a new trust, as an initial grantor, it stands to reason that any individual, company, entity, government of institution may form a trust at least in jurisdictions where trust laws exist and are favorable, that may be connected or otherwise associated with the I network through the use of a relatively standardized trust agreement and the adoption of other relevant agreements governing the internal and external relationships of the new trust. Again, claimed subject matter is not limited in scope to this particular embodiment; nonetheless, as described, this embodiment possesses desirable features.

In this embodiment, trust grantors do not need a banking license per say to start a trust. Of course, trusts typically are subject to special trust laws. In the same way, for example, that bank are require to have a banking license to offer banking products, institutional trustees typically also are licensed to provide trust services. Thus, for an embodiment such as this, a master trust in a particular country or region should satisfy local securities laws and other regulatory issues pertaining to the issuance of securities or loans and the acceptance of trust deposits.

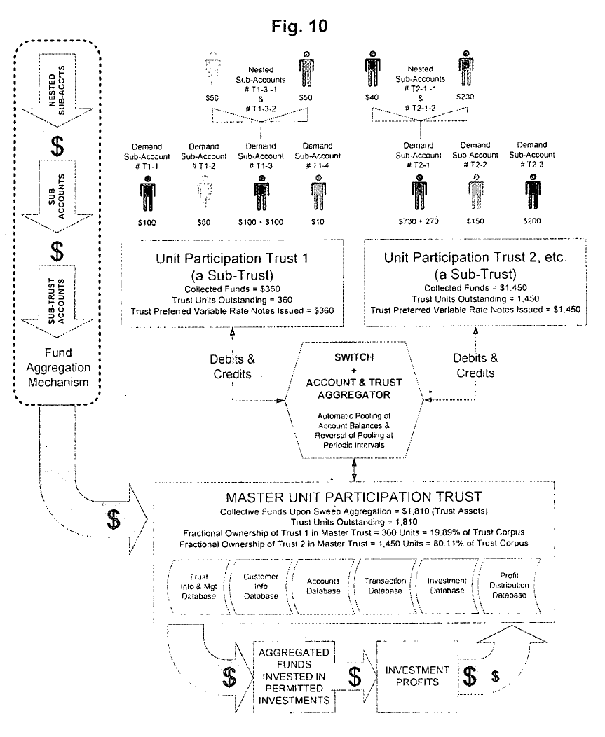

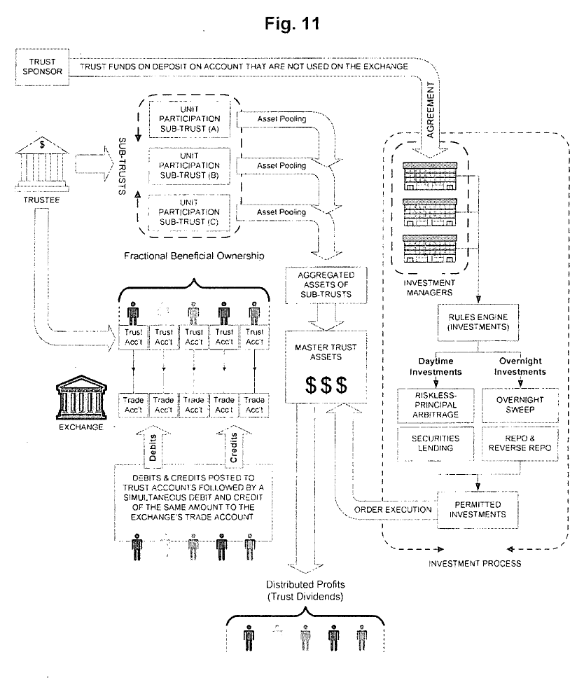

In this embodiment, units holders of a trust will have a trust account designed to have any number of nested sub-accounts that can allow funds to flow upstream from the nested account to the sub-account so that individual units holders of the trust who hold a trust account will be able to host any number of trust accounts under them [Refer to FIGS. 10 and 11]. In such an embodiment, a nested sub-account comprises a full-fledged trust account. However, in addition it is “nested” underneath a sponsor who holds a primary account. This facility permits, for such an embodiment, a system of account sponsorship to develop, thereby allowing, if desired, networks to form, (e.g. affinity groups, members of a family, members of a church, employees of the same company, etc.) within a trust and for network administrators to allocate or distribute revenue (trust dividends) between the members of a particular network by the network administrator. In another embodiment, it may be possible to have a standardized rate of return administered at the trust level for trust beneficiaries so that relatively equal distribution occurs. In this case, as one example, it is possible to use the services of a paying agent or a paymaster to receive dividends from the trust, and to distribute those funds to the participants of separate networks in accordance with written instructions of the administrator of the particular network based at least in part on an agreement for profit sharing with the members of that network.

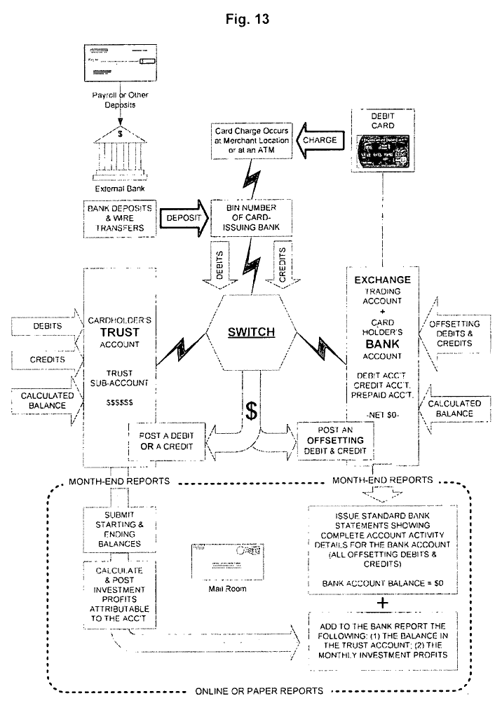

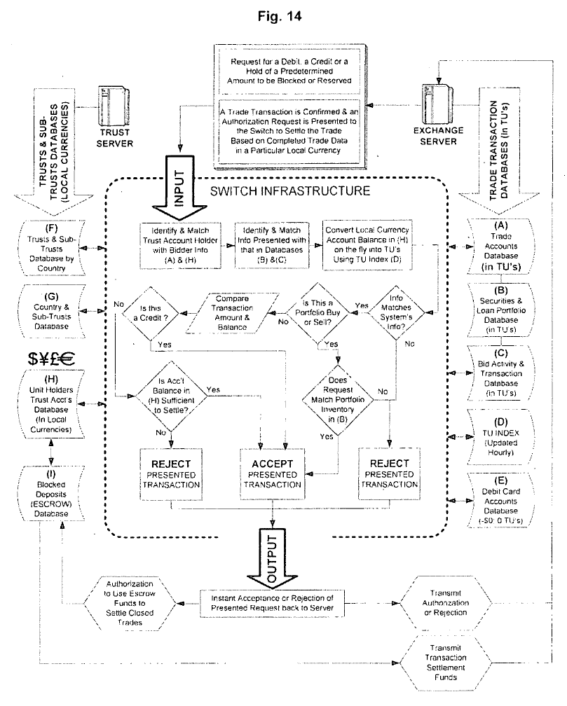

In one embodiment, to accomplish its purpose, such a system may use a trust account (or a nested trust account), an escrow account to hold funds for execution of a trade, a trading (also referred to as “trade”) account, a bank account that has a debit card [Refer to FIG. 13]. For this particular embodiment, however, the debit card may be linked to the bank account and the trading account may be in turn linked to a yield and interest rate arbitrage trading exchange that will be described further. However, the trust account may further be linked to the trading account, the escrow account and the bank account through a switch [Refer to FIG. 14], so as to pass debits and credits between the trading account, the bank account and the escrow account on the one hand and the trust account on the other hand. In this manner, any funds belonging to a trust beneficiary may be managed at the trust account level, while the trading account, the bank account and the escrow account serve on the front line to meet I regulatory banking rules and laws for the issuance of traditional demand deposit bank accounts, trading accounts and escrow accounts.

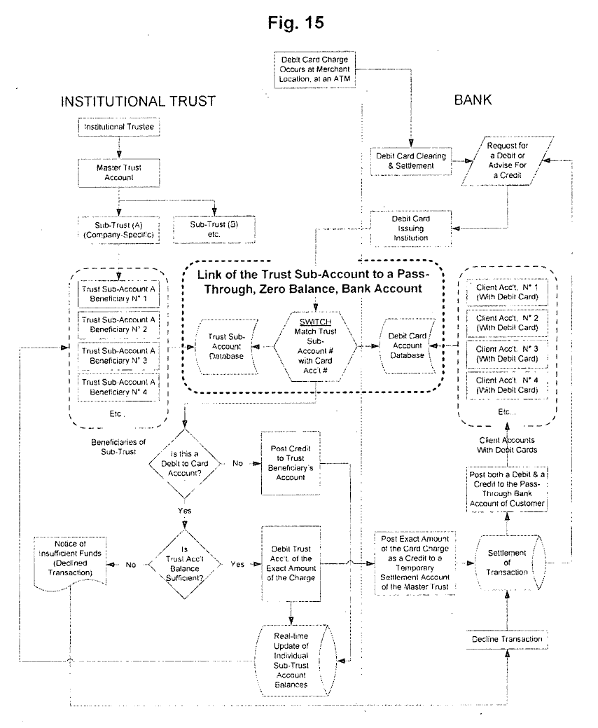

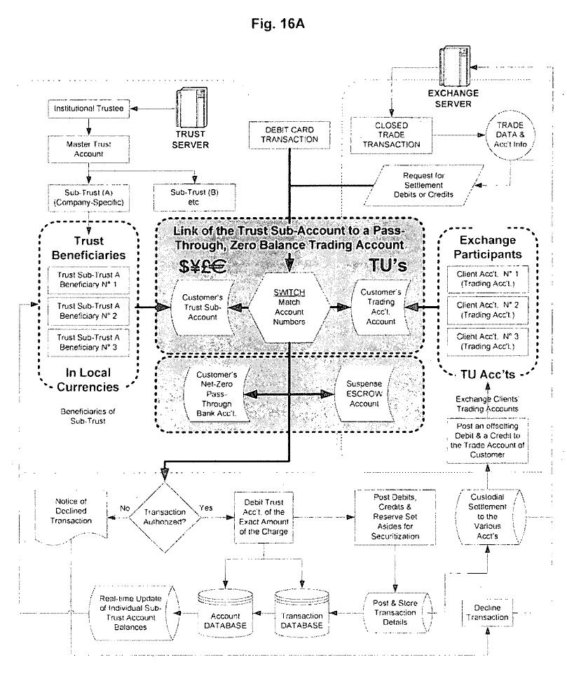

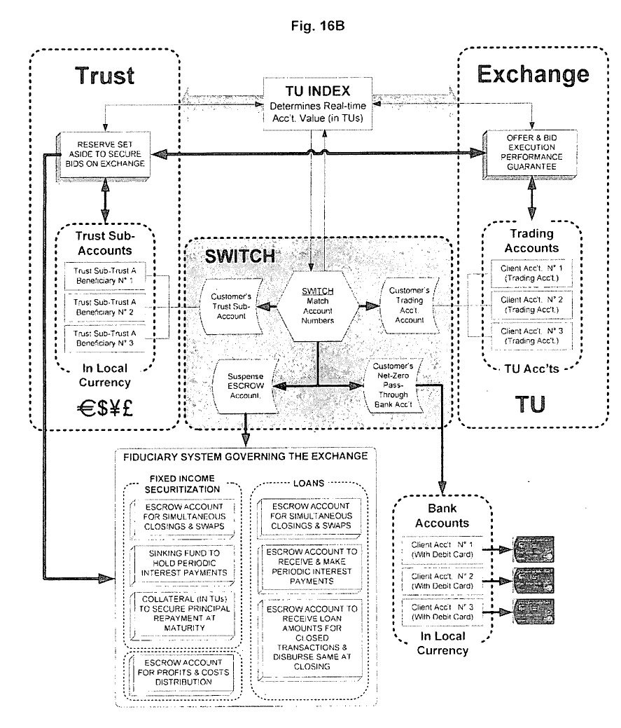

In this particular embodiment, the trust account will typically include multiple sub-trust accounts and sub-trust accounts may be set up to further include any number of nested sub-accounts. The sub-trust accounts and nested sub-accounts, likewise, are respectively linked through the switch to their: (a) corresponding bank account that offers a debit card [Refer to FIG. 15], (b) trading account linked to an exchange [Refer to FIG. 16], and (c) an escrow account that receives periodic deposits from the trust account [Refer to FIG. 14] so that performance for the bids submitted by the account holder to the trading exchange platform will take place. Furthermore, one desirable feature associated with this particular approach, the nested sub-accounts and the sub-trust accounts may be set up to be aggregated on a regular basis or at periodic intervals to earn revenue from investing the aggregate amount of funds at the trust level.

In this embodiment, a switch [Refer to FIG. 14], is employed that may be implemented in hardware, software, firmware or any combination thereof. In an embodiment that employs the switch, credits and debits directed to the trading account, the escrow account or the bank account are redirected or routed to the trust account. For example, if one were to make a purchase using a debit card, the debit would conventionally be routed to the linked bank account. In this embodiment, however, a switch reroutes the debit to the trust account and as a result the debit and credit is posted to the account holder's trust account rather than to the bank account which itself may be designed to be a zero-balance, pass-through demand deposit account, in one particular embodiment. Similarly, a trade order in which the trading account is to be debited or credited for a particular trade will pass through the switch and be redirected so that a debit or a credit is to be posted to the trust account and to substantially simultaneously post an corresponding debit or credit to the trading account after converting the local currency amount into transaction units, as described below. Of course, again, claimed subject matter is not limited in scope to this particular embodiment. For example, an alternate embodiment may not employ transaction units.

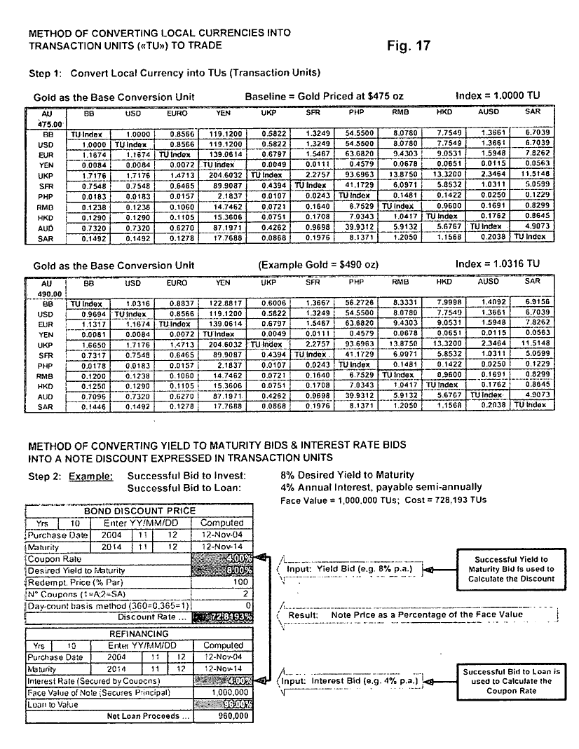

This may be accomplished, for example, by a mechanism in which, if a debit is incurred, such as via the debit card, for example, the linked accounts may be checked to see which accounts have funds available. In this embodiment, the bank account may be maintained at a zero balance and therefore the debit may be routed instead to an account with a positive balance, here the corresponding trust account. In the case of a trading account, however, the switch may be designed to route a transaction first to a trading account which may be maintained in a notional index called a transaction units (“TU/s”) in which the balance at a particular point in time represents a notional TU value that is equal or equivalent to the trust account balance at that particular moment in time multiplied by the TU index rate for that particular currency at that particular time [Refer to FIG. 17]. Therefore, as debits and credits are posted through the switch to the corresponding trust account, the balance in TUs in the trading account may be adjusted to reflect an increase or decrease of value in the trust account. Similarly, if a TU denominated settlement request is presented to the switch by the exchange, the switch may first, in this particular embodiment, convert the TU amount into the particular local currency of the sub-trust account with the result that a debit or credit may be posted in TU (at the then current exchange rate) to the trading account and substantially simultaneously in local currency to the trust sub-account.

In another embodiment, it is possible to have a system whereby the trust account may also be linked through the switch to a mutual fund account, a savings account, a regular brokerage account, or any other form of financial account or investment account.

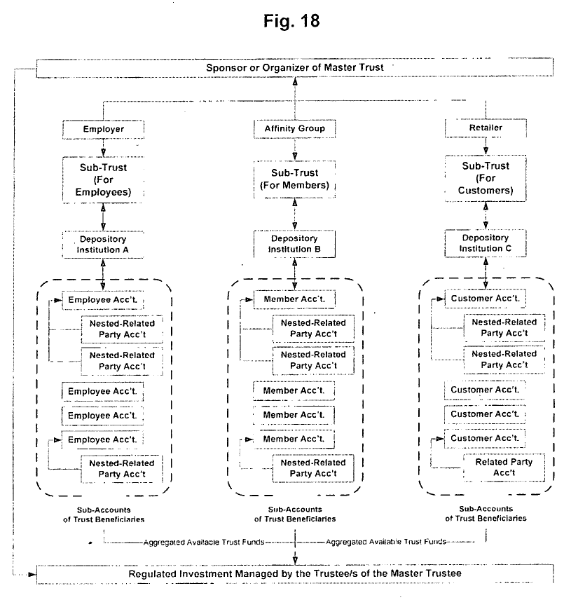

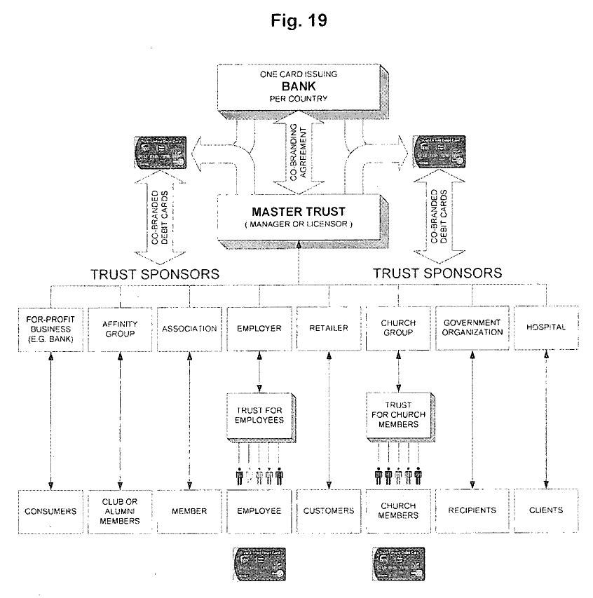

In still another embodiment, a debit card may be issued in the name of any non-banking entity. For example, the non-banking entity may comprise at least one of the following: an individual, a non-profit entity; a for-profit entity; or a government entity [Refer to FIG. 18]. For example, a for-profit entity may comprise an employer and the debit card may be issued to an employee of the employer. Likewise, the debit card may be set up to allow the employee to have a nested sub-account of the employee so that he can charge business travel expenses directly to the employer's sub-trust account. In another embodiment, a debit card may be issued in the name of any non-banking entity and co-branded with the name of the bank issuing the debit card [Refer to FIG. 19]. In this embodiment, therefore, any non-banking entity may take on aspects similar to a bank without incurring the associated regulatory overhead.

It is noted that for this particular embodiment, the trust account is set up to allow funds of the trust to be invested in “permitted investments” at least during banking hours. Permitted investments are explained in more detail elsewhere. However, the trust account is also set up to allow funds that remain in the trust account outside of normal banking hours to be swept out for short term investment and swept back to the account by the opening of the next banking day for example [Refer to FIGS. 6 and 7]. It is noted that non-banking hours include evenings, weekends and legal holidays in the particular local or jurisdiction of the trust account during which moneys belonging to the trust can earn interest and profits in the same way that banks currently profit from the use of their customers' aggregated demand deposit account balances.

For this particular embodiment to operate effectively, the trading account (TU balance), bank account (pass-through net-zero balance for this embodiment, for example) and its corresponding debit card, the escrow account and the trust account may be communicatively linked via a system infrastructure. Furthermore, although above we referred to a trust account as being linked to a plurality of accounts, as a practical matter, in actual implementation, in most cases, a user-specific nested sub-account will more likely be set up to post debits and/or credits to the user-specific account, rather than the trust account of the sponsor. More specifically, in this particular embodiment, the sub-trust account may be set up to post credits for at least one of the following: cash, cash equivalent marketable instruments, securities, non-liquid assets, or any combination thereof. Likewise, in many instances, credits of cash include regularly recurring deposits, such as payroll check deposits or social security check deposits, to provide only a few examples.

In another embodiment, it may be possible for instance for the owner of equity in a home to transfer the value of that equity to the trust and to receive in exchange a trust-preferred variable rate note of the trust, thereby effectively transferring the ownership of that home equity amount to the trust and receiving credit for it in the form of a trust note. In this particular embodiment, therefore, through aggregation upstream of non-cash account balances, as may be permitted by the trust agreement, the trust will be able to aggregate substantial holdings of illiquid assets that can be further pledged or hypothecated so as to receive a master secured loan from a third-party lender wherein the loan proceeds may be posted fractionally to sub-accounts and nested sub-accounts of the trust based on relative contributions to the total trust assets. Whereas the trust will have received a duly executed deed of trust for a variety of real estate properties, it may be possible, in such an embodiment, to further aggregate those assets between trusts through the exchange of notes between trusts and to receive a loan against those assets in which the loan proceeds may flow downward from the master trust to sub-trusts, from sub-trusts to sub-trust account holders and from primary account holders to nested sub-account holders of a network in proportion of respective contributions to the total asset pool. Likewise, in another embodiment, it is possible to create a credit derivative, such as a trust-secured mortgage backed security, with or without a credit enhanced component added to it, wherein these securities are sold into various capital markets to raise longer term liquidity at a potentially lower cost of borrowing. In another embodiment, it is possible to envision specific conditions incorporated in standardized language of a trust agreement to incorporate a put option that may give the holder of a trust-preferred variable rate note an option to sell the note back to the trust thereby placing an obligation on the trust to return the invested illiquid asset to the account holder upon a simple demand that might be made at any time, for example. In this case, the exercise of the put option by the account holder would effectively remove that particular asset from the asset pool of the trust and release the lien the trust has on that asset. In this approach, dormant asset pools may be made to profit through investment of the trusts or through the trading of the fractional loan amount on the trading exchange by the account holder. So long as the cost of borrowing is less than the returns generated from the investment, trust profits can be applied to the reduction of and acceleration of the principal repayment of a first mortgage so as to retire that mortgage earlier than originally planned, thereby potentially saving the account holder interest costs.

In this particular embodiment, in which, illiquid assets may be aggregated at the trust level, monetized by tapping into the liquidity markets and invested, such assets, depending at least in part on the particular embodiment, may comprise any number of different tangible and intangible assets that may take many forms. Examples here have included the consolidation of an aggregated pool of real estate assets (potentially all sorts, e.g. residential, commercial, industrial, etc.) in a trust, however such illiquid asset pooling can take virtually any form, including, but not limited to assets that have an intrinsic and recognized (or appraised) value, such as: intellectual property, patent portfolios, stocks and bonds, mineral deposits in the ground, airplanes, boats, cars, receivables, life insurance policies, annuities, etc.

In the embodiment described above, an advantage of a user-specific sub-trust account includes having the capability to provide for the withdrawal of cash to settle charges resulting from card purchases or for the withdrawal of TU units to settle transactions on the exchange, as was alluded above. More specifically, again, as alluded to previously, for this particular embodiment, a bank account may be set up to book a debit from the use of the debit card and to also book an offsetting credit from the corresponding sub-trust account so that the balance in the bank account shows a zero balance, for this embodiment. Of course, in an alternative embodiment, the bank account might simply maintain a consistent minimum positive balance or merely a consistent balance without loss of generality and the trading account may hold any number of local currencies, instead of transaction units. Likewise, even assuming the balance changes, offsetting adjustments may be made to correctly account for this, if desired. Another advantage of this particular embodiment is that a bank account may be further set up to report information regarding debit card usage for a debit card linked to that bank account, which may be convenient at times and provide a way for activity tracking and reporting online or via hard copy bank account statements that show offsetting debits and credits during a specified period of time. Likewise, a bank account may be further set up to report debit card transactions for a debit card linked to that bank account on a regularly recurring basis, such as weekly, monthly, or quarterly, as examples. Also, for this particular embodiment, a bank account and a trading account may be further set up to regularly report profits of the corresponding sub-trust account on a recurring basis.

Likewise, in another embodiment, this structure may be implemented through a “nesting” of sub-accounts. In other words, a particular sub-account may operate like a trust account, as just described above, with respect to a group of its own sub-accounts. In this example, the group of sub-accounts may be nested by that particular sub-account. Therefore, the nested sub-trust accounts may be set up to have their funds aggregated on a regular basis to earn revenue at the nesting sub-trust account level from investing the aggregate amount of the funds, in this example embodiment. Therefore, as an example, a debit card corresponding to a particular bank account linked to a nested sub-trust account is able to earn a return from aggregation of funds for investment at the nesting sub-trust level, a desirable feature, particular in comparison with conventional debit cards.

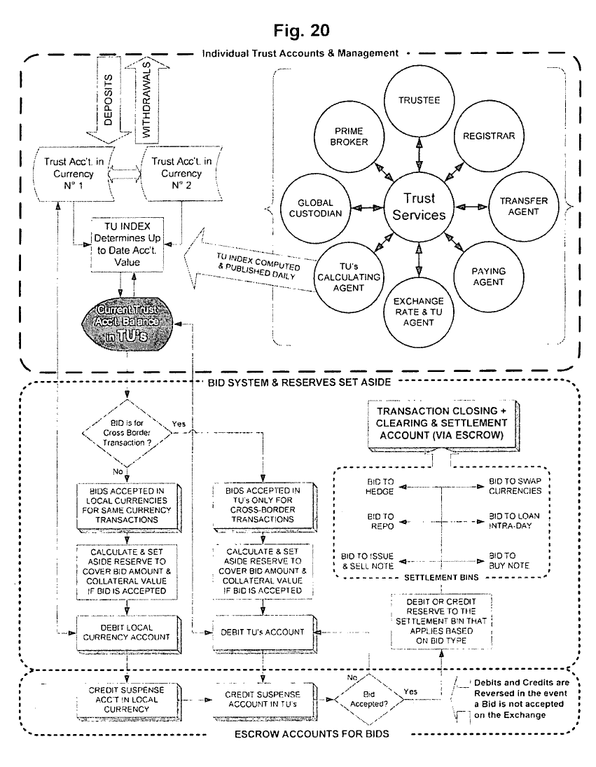

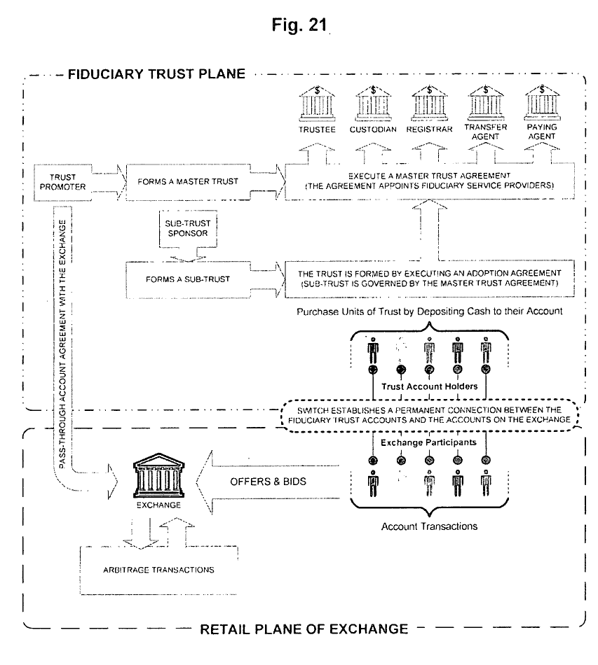

Previously, an embodiment employing a switch was discussed. Although embodiments may be implemented that do not employ a switch, in those embodiments that do, the switch may be conveniently incorporated as a component of the system infrastructure. In this embodiment, for example, for a debit card purchase transaction, the available balance of the sub-trust account linked to the bank account corresponding to the particular debit card may be accessed and the available balance may be compared with the amount of the debit card purchase transaction. Thus, authentication and acceptance may occur if the available balance is sufficient; however, denial may occur if the available balance is not sufficient in such an embodiment. As will be discussed further with respect to this particular embodiment, if a trade order is submitted to a trading exchange platform, an amount, in local currency, may be debited from the order giver's account and credited to that account holder's nested escrow account. In such an embodiment, although claimed subject matter is not limited in scope in this respect, an escrow account is set up to block potential withdrawal of funds from an account while a trade order is pending. Thus, while being held in the name of the account holder, in this particular embodiment, such escrow deposits permit execution of a trade order by providing a level of assurance of performance by the account holder in the event a trade order which is submitted to the trading exchange platform is accepted [Refer to FIG. 20]. Similarly, presentment of a debit or credit for settlement (in TUs) of a trade that has been executed for an account holder may in this embodiment be routed first to the suspense escrow account of the account holder so that amounts deposited in the suspense escrow account may be used to settle a successfully completed trade.

In this embodiment, a trust account may be linked to a remote trading account in the name of the same account holder that will reside on a trading platform (herein called the “exchange”) [Refer to FIG. 21] so that trading activities of a particular holder may be backed up by a trading account balance which, through the switch, is directly linked to the trust sub-account of the same account holder and the corresponding escrow account that holds cash deposits that back performance on the exchange in the event a posted trade on the exchange platform is accepted. This exchange account may in an embodiment be made remotely accessible to the account holder online, for example, through the Internet, such as through a connection established via phone, or through an electronic device, such as a personal data assistant (PDA) that is programmed and designed to process, transmit or receive information to and from a trading platform of the exchange via wireless connections or through connection to a regular phone line, for example.

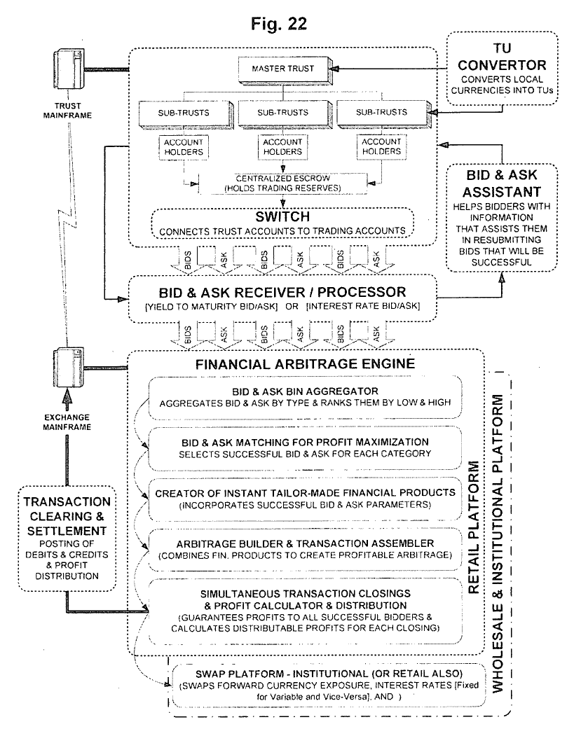

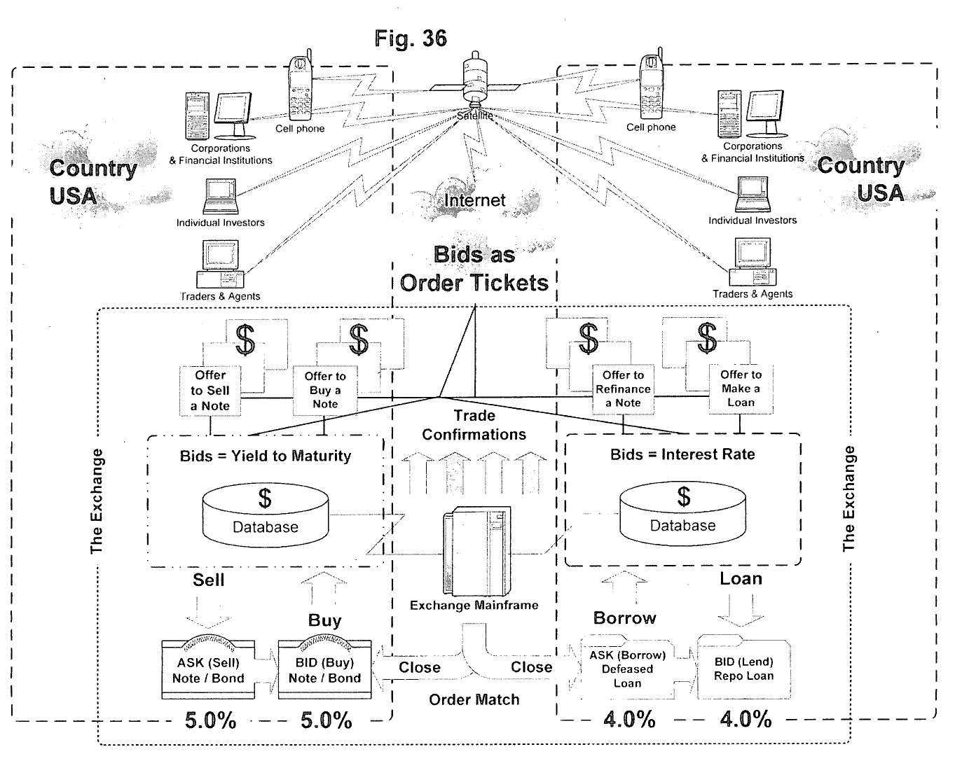

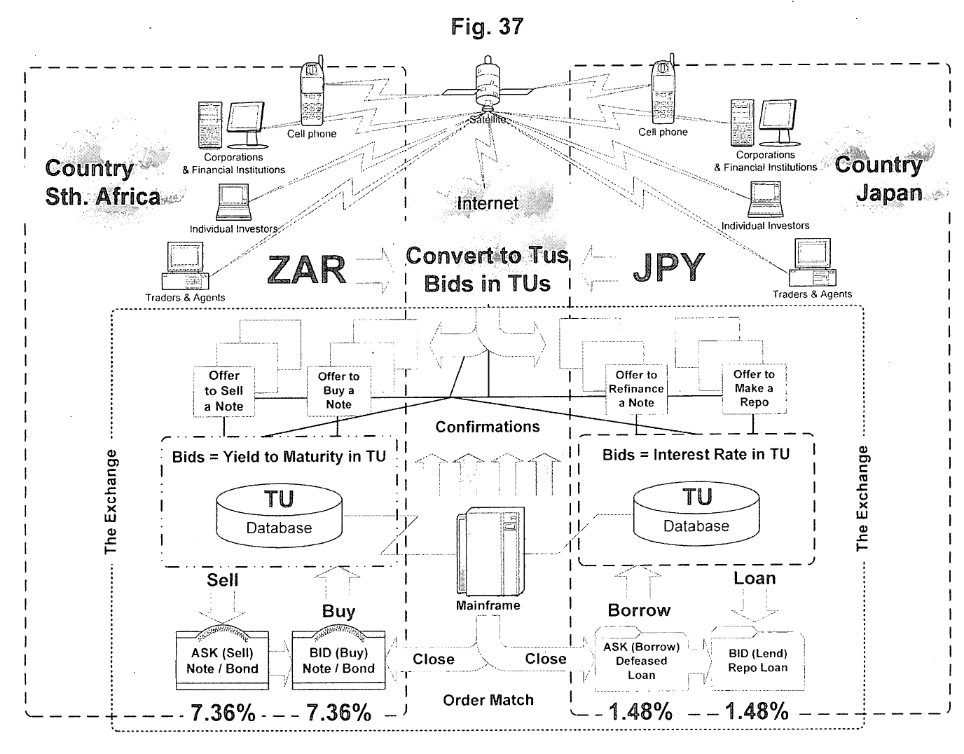

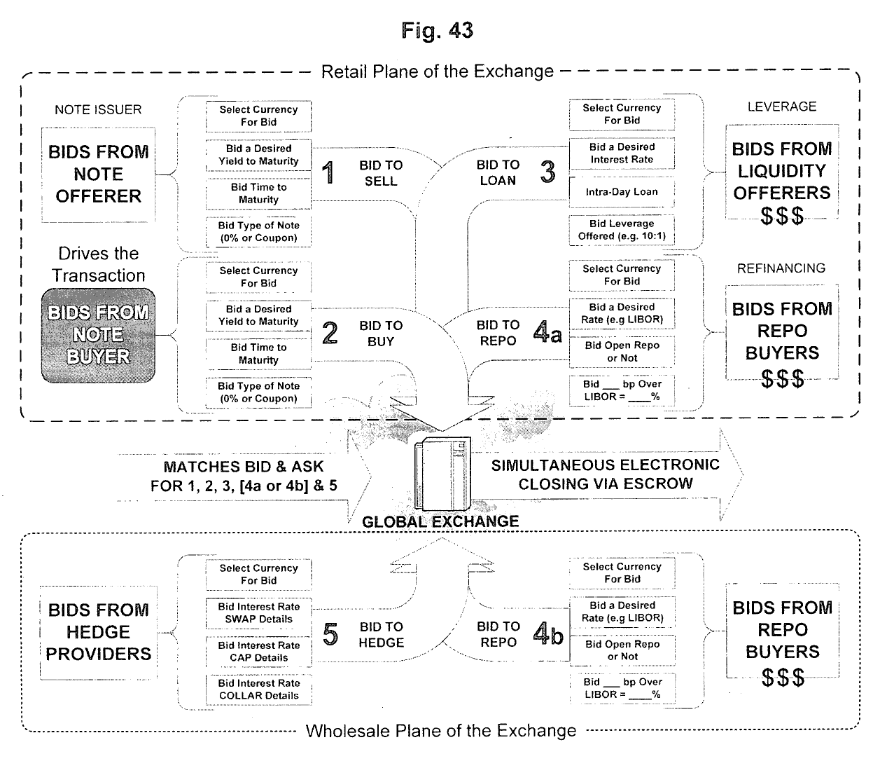

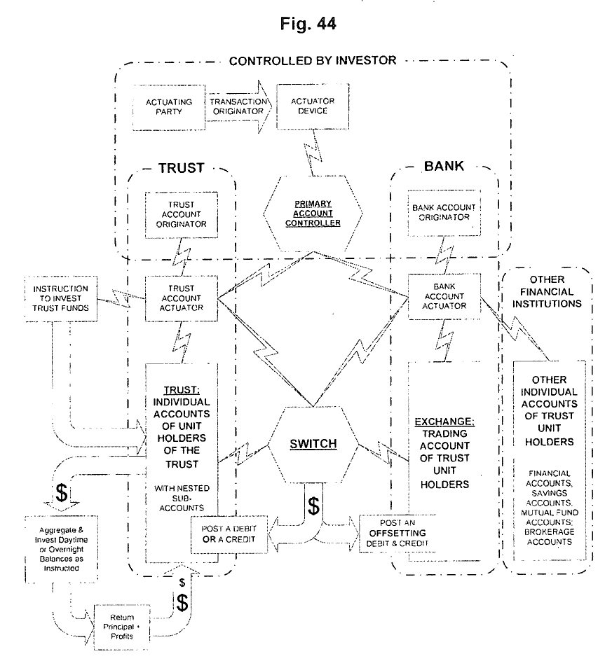

As alluded to previously, although claimed subject matter is not limited in scope in this respect, a trading platform (herein referred to as the “exchange”) may likewise be employed [Refer to FIG. 22]. For such an embodiment, trading on the exchange may encompass processing, matching, aggregating and closing bid and ask orders received from holders of trading accounts, even worldwide, for the purpose of creating and closing intra-currency [Refer to FIGS. 36 and 43] and cross-currency yield and interest rate arbitrage transactions designed to make money with little or no risk for successful bidders of components that make-up the transaction [Refer to FIGS. 37, 38 and 43]. In this embodiment, for example the exchange may be operated by a master trust. In such a structure, other trusts, such as those previously described, for example, may report to or have a relationship with [Refer to FIG. 9] the master trust. However, in another embodiment, one may, instead, construct a local infrastructure comprising a local master trust operating its an exchange for the benefit of sub-trusts so as to receive and post offers and bids in a particular local currency, in transaction units or any number other currencies. Likewise, in such an embodiment, a structure may be employed in which exchanges may be operated at various levels, such as operated at a country level or a regional level, and may be connected to a central offer and bid processing system so that offers and bids emanating from a particular country, as one example, may be processed and matched together with offers and bids originating from other exchanges. For such an embodiment, trust account holders may have the ability to post trade orders in their own local currency and in other currencies. It may be possible, therefore, for such an embodiment, to develop an interest rate and yield setting mechanism to determine yields and interest rates for a particular currency of a particular country.

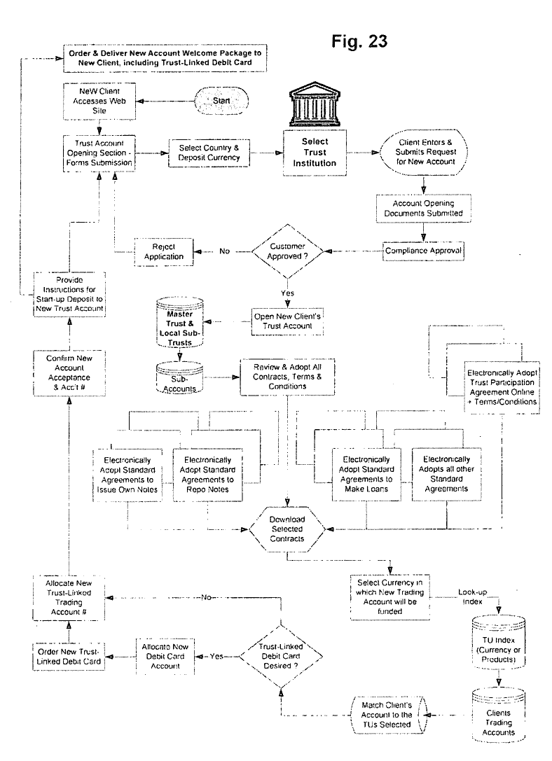

In this particular embodiment, if trading account is opened on the exchange [Refer to FIG. 23], an account holder may adopt, through execution and delivery of a duly notarized or witnessed adoption agreement or other form of signature authentication (including any form of digital signatures), a set of legal documents that will be binding upon the executor and may be employed to govern trading activities of the account holder on the exchange. Such agreements may include, for instance, a master note purchase agreement, a master loan agreement, a global master securities repurchase agreement, a master non-recourse hedge insurance agreement, a master escrow agreement, a master security, pledge and assignment agreement, a master novation agreement, an master option agreement, a master loan repurchase agreement, a master interest rate swap agreement or a master currency swap agreement, etc. wherein the adoption of these agreements by participants on the exchange may be designed to provide a standardized legal framework that not supports the trading activity taking place on the exchange and protects parties and counterparties in a particular trade or loan transaction occurring via the exchange.

Although claimed subject matter is not limited in scope in this respect, the exchange for this particular embodiment may be employed to receive process and match two forms of offers or bids: (a) a yield to maturity offer or bid for an investment in a fixed income financial product (bond-like product), or (b) an interest rate offered or bid for a particular loan. Likewise, as is known, yields and interest rates may be converted to specific net revenue numbers through present and future value calculations and/or bond calculation formulas that may be used as an alternate a method of submitting offers and bids. Likewise, although claimed subject matter is not limited in scope in this respect, such offers or bids, for this particular embodiment, may be received in a specific target currency and converted into a transaction unit value by the exchange before posting or it, alternatively, it may be received in pre-defined transaction units itself. As discussed previously, although claimed subject matter is not limited in scope in this respect, a transaction unit may be employed that is a notional currency usable on the exchange and based on a proprietary index developed to permit the exchange to function and to receive offers and bids from traders in a variety of currencies. Thus, in such an embodiment, bids may be converted from a local currency to a transaction unit or from a transaction unit into a local currency at the exchange rate of a transaction unit at a particular point in time relative to that particular local currency. The benefits of using a standardized unit of trade will become apparent in the explanations that follow.

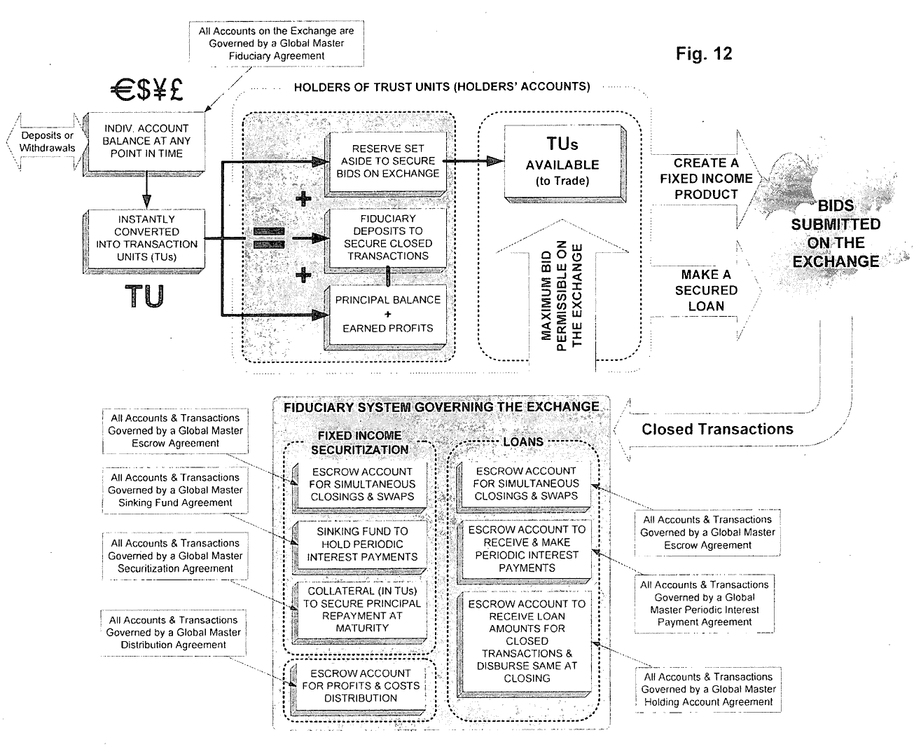

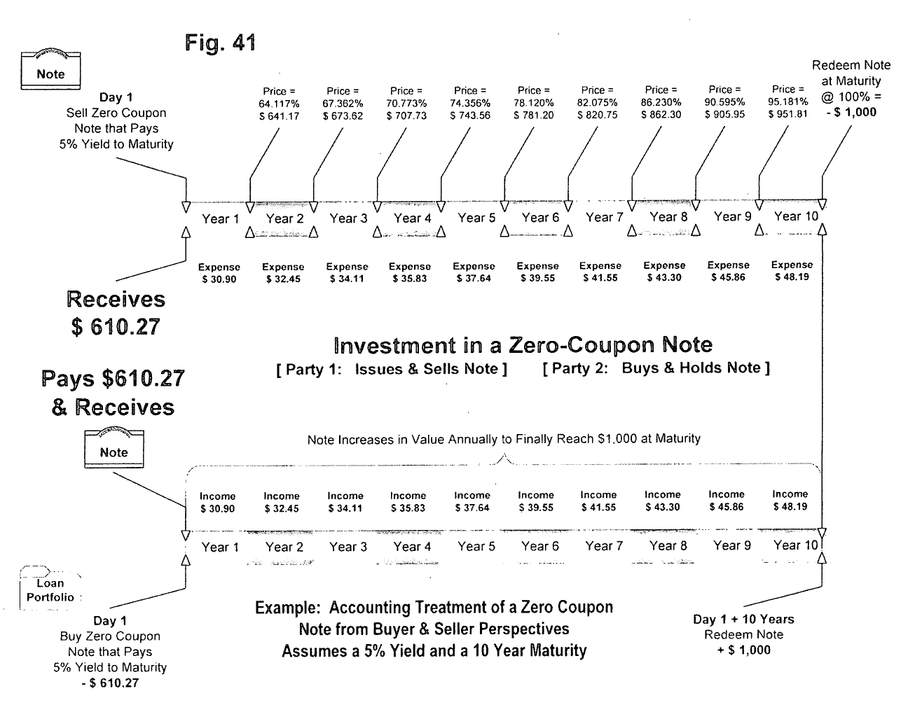

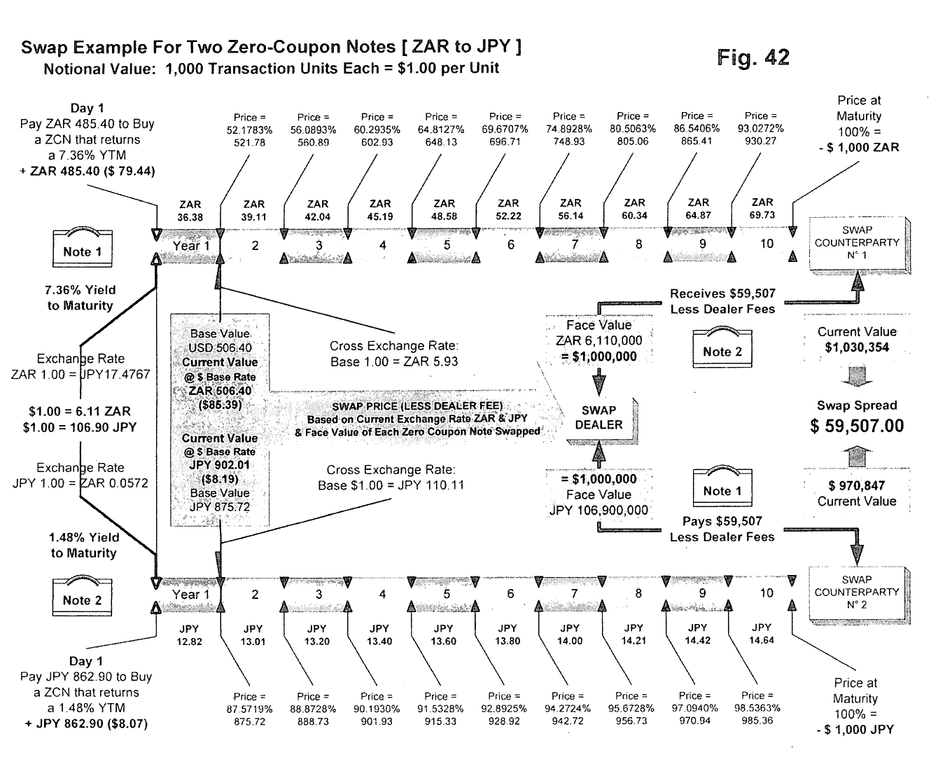

For an embodiment such as this, the financial products that will be traded on the exchange are referred to as a “trust-preferred zero coupon note” which is a fixed income investment product [Refer to FIG. 41] or a “trust-secured loan” which is a loan product. It is anticipated that all offers or bids posted on the trading platform of the exchange will be guaranteed by cash deposits (made in local currencies) held in an escrow account or in a segregated and blocked trust account that performs the same basic functions as an escrow account. In order to cause the exchange to accept an offer or a bid, it will be necessary for each participant to cause a deposit to be made in escrow through an automatic debit authorization of the bidder's trust account [Refer to FIG. 12]. When the escrow account deposit is made and confirmed by the trust, the exchange will then post the offer or the bid in the trading platform. In the event an offer or a bid is accepted for a trust note the escrow deposit will move to a securitization account so that at all times the trust note will be backed by cash in the local currency backing it. Similarly in the event an offer or a bid is accepted for a secured loan, the escrow deposit will be transferred to the borrower's account and the security pledged as collateral will immediately be transferred to the account of the lender.

In another embodiment it is possible for the trust-preferred zero coupon note to take any number of other forms, including that of a note paying a fixed rate of periodic interest (coupons) which amount can be established through the ask and bid process also, interest-only strips or principal-only strips. Instruments can also take the form of derivatives in which case the value of the primary security is supported by the value of an underlying instrument (e.g. a US Treasury-backed I/O, P/O or an interest earning US Treasury note).

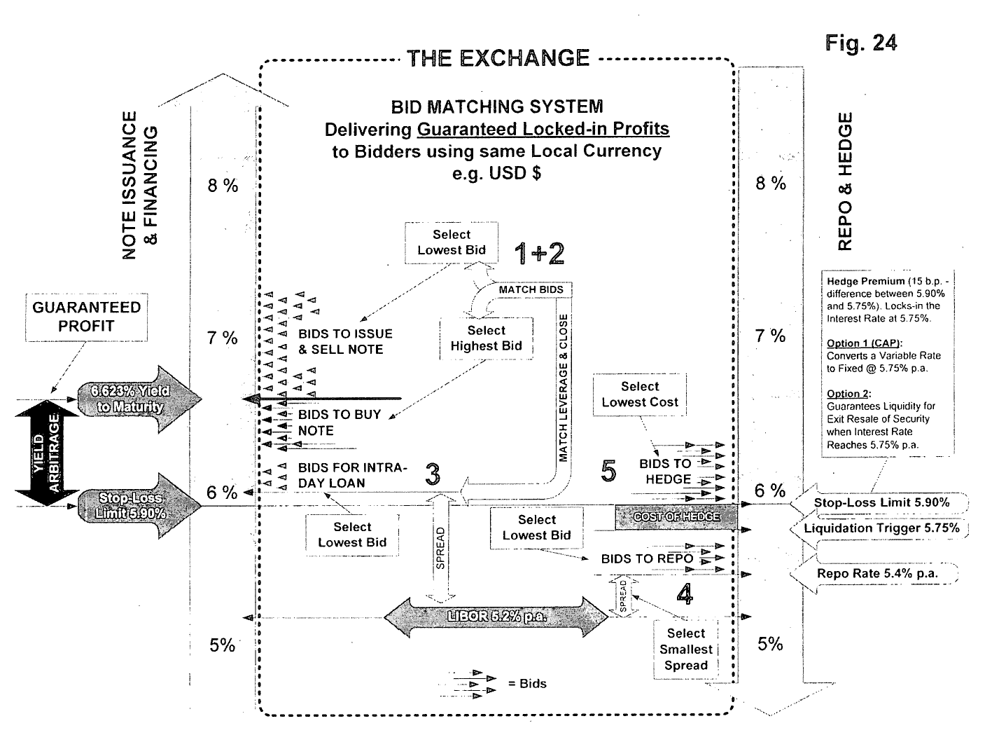

The exchange is intended in an embodiment such as this not only to instantly create and trade cash-backed fixed income instruments of the trust as well as to facilitate the making and securitizing of secured loans, but to also create opportunities for successful bidders to come together through the exchange so as to cooperatively create a series of transactions which at the tail end will result in a profit for all successful bidders through the arbitraging of interest rates and yield to maturity that exist within the offers and bids received either within a single currency or in cross-currency transactions [Refer to FIG. 24]. Trust notes issued through the exchange will be freely transferable and tradable as will the loan portfolios that participants accumulate in their respective accounts.

The adoption of a standardized set of legal agreements by all exchange participants will make it possible for the exchange to use successful offer or bid parameters of an account holder, to calculate and incorporate these parameters in the underwriting of that particular instrument and its subsequent sale via the exchange. For instance the submission of a desired yield to maturity will be converted into a discount or premium price based on the following variables, the date of settlement, the maturity date of the instrument, the coupon rate (if any) expressed in an annual percentage rate of return, the redemption percentage as a percent of the face value of the instrument, the payment dates for coupons (if any)—monthly, quarterly, semi-annually or annually, the number of days in the year. By plugging in the desired yield to maturity in the bond calculation formula, the system will automatically calculate the price of the instrument and the amount of funds that need to be escrowed to as collateral during the life of the product. In the case of a loan, the system will incorporate the parameters of a successful offer or bid interest rate into the loan interest calculation in order to calculate the amount of cash or the value of securities that need to be blocked in escrow to secure the loan. It will further calculate the future value of the interest payment cash flow during the anticipated life of the loan and convert same into a present value at the rate of the most recent yield bid received on the exchange, whereupon it will deduct and set aside a reserved amount (in the currency of the loan) from the trust account of the successful bidder and set aside a sinking funds that will be sufficient to make all interest payments over the life of the loan. It is anticipated that all loan transactions done on the exchange will be fully defeased, principal and interest (refer to the definition), wherein the risk of non-payment is entirely eliminated. Similarly, the pledge of cash to secure a future obligation of a trust note will be entirely eliminated through the process of setting aside a sufficient amount of cash held in escrow so that the trust can guarantee the obligation.

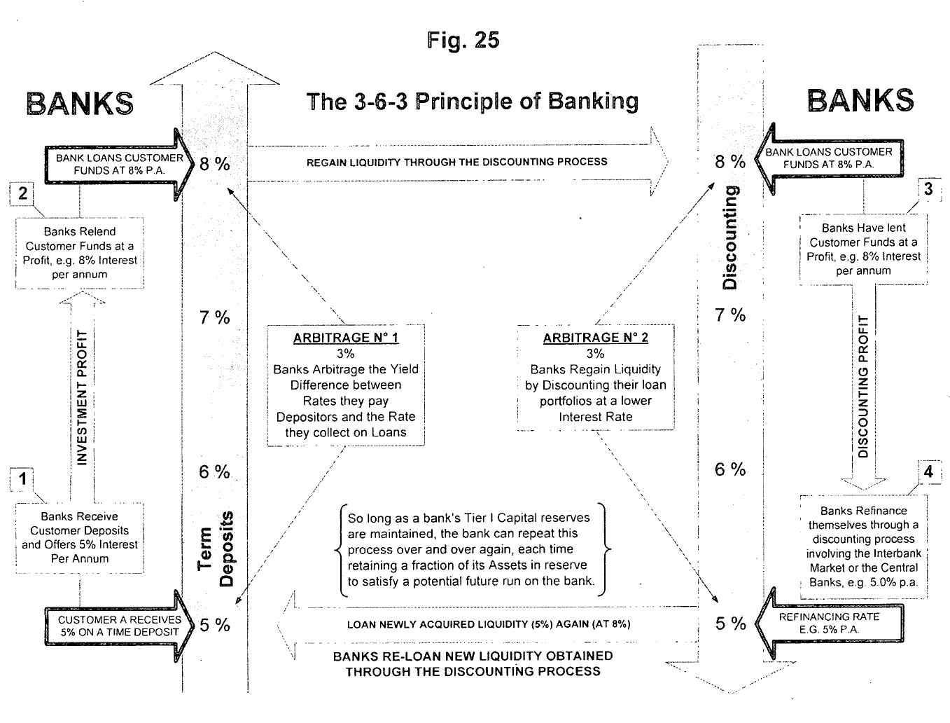

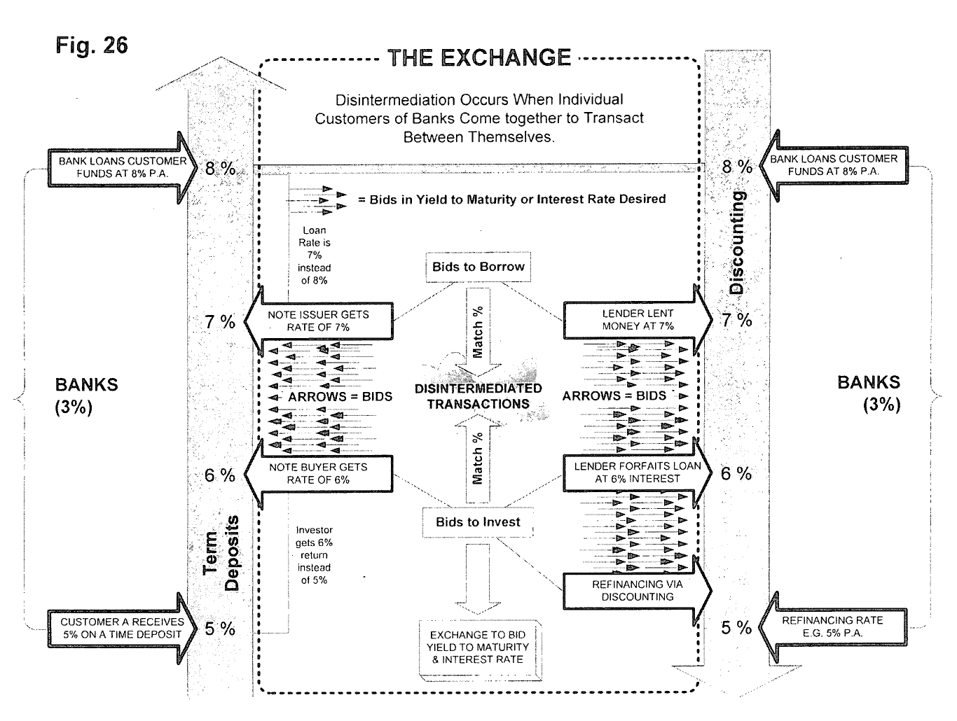

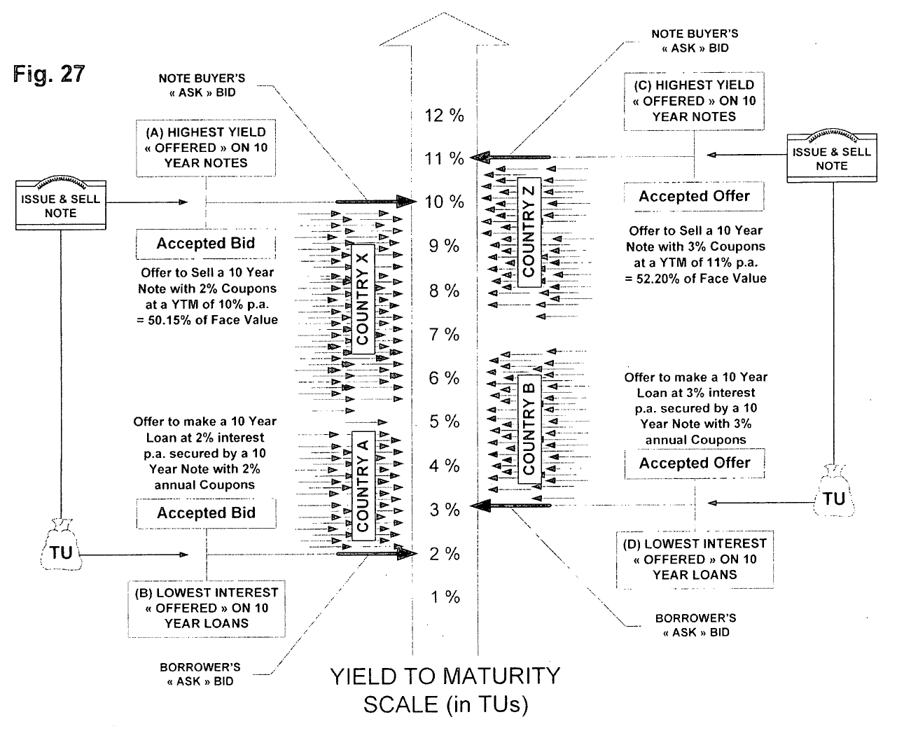

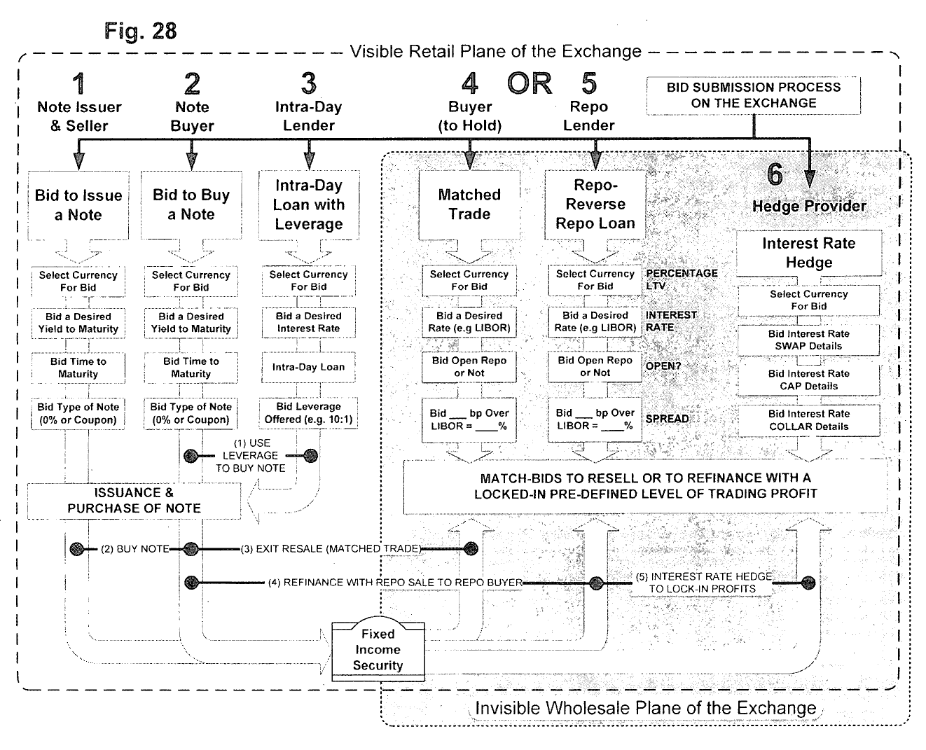

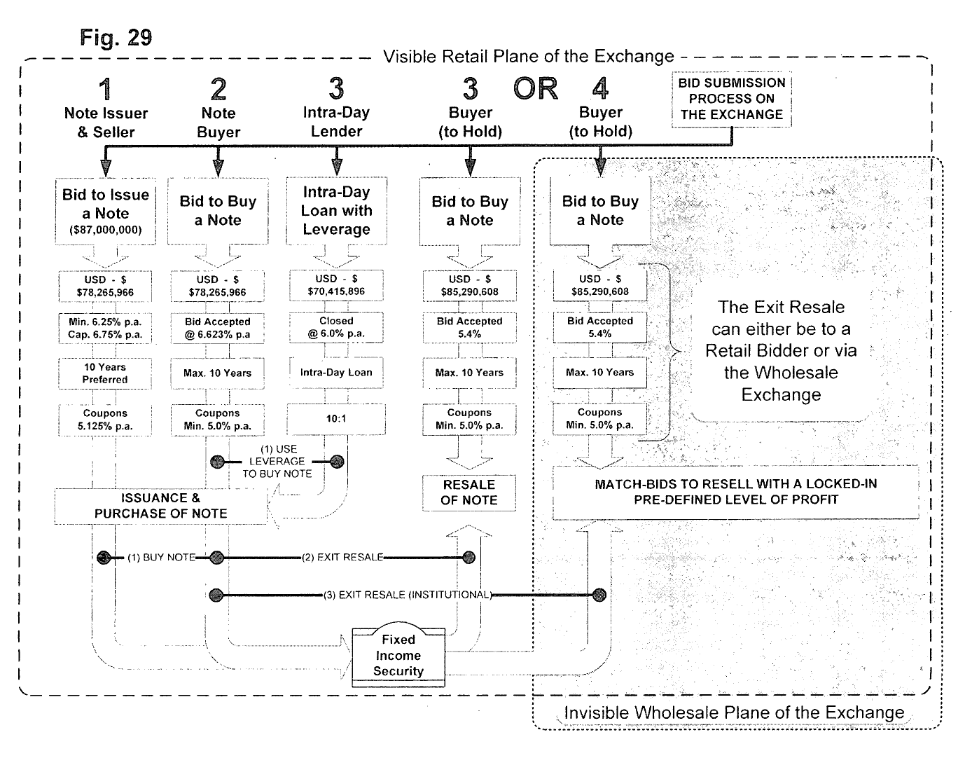

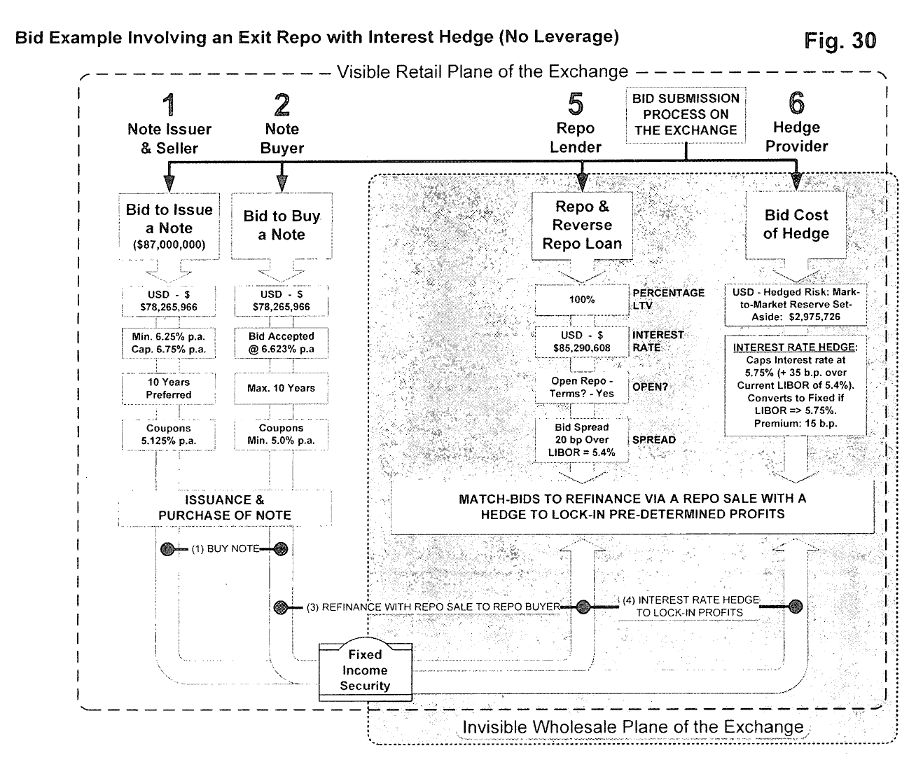

The purpose of the exchange is to facilitate the coming together of trading partners throughout the world who create, through an offer and bid process, each components of a pre-engineered set of simultaneous transactions designed to yield a profitable result achieved through the arbitrage of yield and interest rate differentials that exist around the world both within a single currency (e.g. when a borrower and a lender come together to close a loan instead of each allowing a bank to broker the interest rate between that charged the borrower and that paid the lender to the bank—[Refer to FIG. 25, 26]) and in cross-currencies or between countries [Refer to FIG. 27]. In this part of the process which, all the components of a planned arbitrage (the successful bids originating from each bin) are assembled into a single closing bin whereupon a simultaneous escrow-like closing which is designed to close each component of the transaction concurrently and in parallel to each other will be followed by a settlement process for each component of that transaction [Refer to FIGS. 28, 29 and 30]. The legal language governing such simultaneous escrow-like closing says the following: “At the closing, each party selected to close sub-part of a master arbitrage transaction closing shall cause to be delivered through the exchange the instruments the (the “Instrument/s”) produced and delivered electronically by the exchange together with the electronic certificates or powers as applicable, against receipt of payment from the counterparty's blocked escrow accounts of payment in Transaction Units (TUs) in the amount of the aggregate Price determined by the parameters of each successful bid. The delivery of each Instrument required for a sub-part of the master arbitrage transaction and payment of the agreed Price for each such Instrument and the closing of each sub-part thereof shall be simultaneous in that neither the delivery of an Instrument or payment of the agreed Price for a sub-part nor any event required by the terms of this Agreement to occur thereat shall be deemed to have occurred until such delivery and payment of each sub-part shall have occurred, and when such delivery and payment have occurred, they shall be deemed to have occurred simultaneously, whereupon the master arbitrage transaction shall de deemed to have closed successfully.” To complete a successful closing, the following steps occur: (a) the amounts deposited in the suspense escrow account of each successful bidder is automatically debited from that account and credited (in TUs) to a master transaction closing escrow account identified by the closing number assigned to that closing to cover financial obligations of each successful bidder; (b) a master transaction settlement worksheet for the transaction and a sub-worksheet for each participant is generated that includes all debits and credits to be posted to each account following the closing.

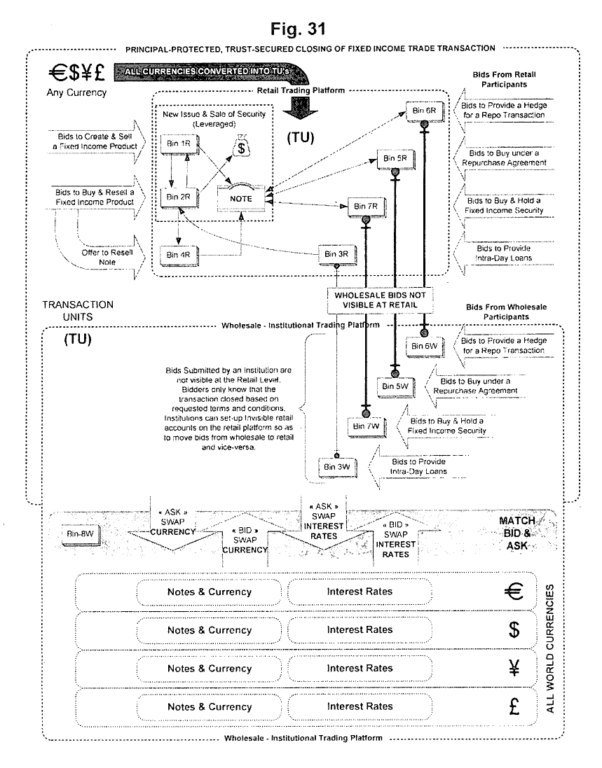

Again, claimed subject matter is not limited in scope to this particular embodiment; nonetheless, as described, this embodiment it is possible to create a connection between the existing banking system and the fiduciary system which is the subject of this embodiment so that liquidity from the existing banking system can be made to flow into the fiduciary exchange, and vice-versa, so that the fiduciary system can feet the banking system with profitable transactions that creates a symbiotic relationship. This embodiment makes provision for a dual retail and a wholesale/institutional offer and bid submission platform operating within the exchange [Refer to FIG. 31], and which are interlinked to accomplish specific objectives as described further herein. For instance in this embodiment the wholesale platform is designed to accommodate banks, insurance companies, financial institutions, broker/dealers, prime brokers, hedge fund managers, institutional asset managers and major corporations of the world (“referred to herein as “institutional bidders”) as customers who will be authorized to bid at the wholesale/institutional level of the exchange. To join the system each participant will need to be vetted for credit worthiness and will be required to post an appropriate bond to cover their trading activities on the exchange.

This embodiment makes it possible for institutional bidders to post ask and bid offers on the wholesale platform of the exchange and for such bids to interface with and intersect with the retail level of the exchange in such a way that they appear at the retail level in an anonymous manner, making it possible for institutional bidders to submit bids without their competitors being aware of what is bid or asked. This process is intended to open the door for institutional bidders to compete for the business created by the exchange and to provide liquidity to the retail platform. Wholesale bids will be received and processed in four specific bin categories 3W, 4W, 5W and 6W, each of these correspond to the retail bin numbering system with the exception that the number is followed by a W instead of a R. By virtue of the fact that banks and financial institutions are connected to the monetary system, they can bring much of the needed liquidity to the exchange, thereby profiting also in the process.

In another embodiment, it is possible to envision the wholesale and retail platforms being integrated into a single platform where retail and institutional bids compete with each other on the same platform.

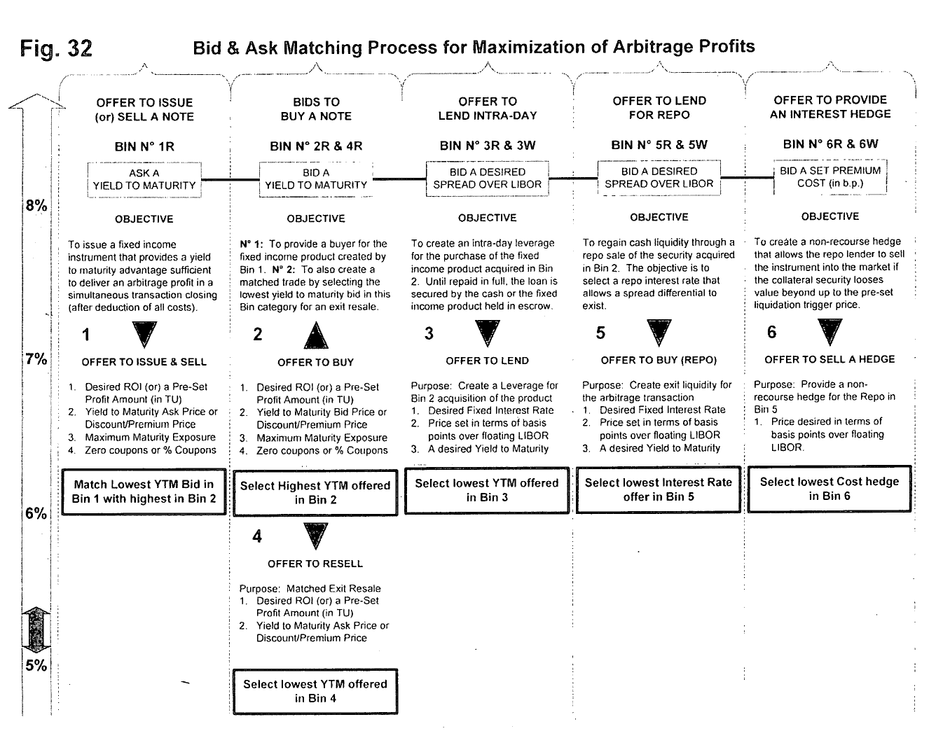

With respect of the operation of the exchange itself, this embodiment envisions that each bid and ask submitted at the retail level (“R”) of the exchange will be sorted, prioritized, time-stamped and ultimately aggregated into individual bins in which all similar bids will be analyzed, calculated and matched in order of priority in the specific order designed for each bin [Refer to FIGS. 32, 33 and 34], as follow:

Bin 1R: ▾ ASK A YIELD TO MATURITY—Bin 1 [Refer to FIGS. 31, 32 & 33] is an aggregator for all cash-backed OFFERS (like a holding tank) that are submitted to the exchange in the form of a desired yield to maturity expressed as an annual percentage rate of return or a premium or discount rate one is willing to cause the issuance and sale of a trust note on the exchange. This bin contains all trade orders received from those desiring to issue and sell a trust-preferred zero coupon note [Refer to FIG. 41] to the successful bidder in bin 2. The successful bidder from bin 1 (for an arbitrage transaction closing) will be the party submitting the earliest and lowest yield to maturity offered at any moment in time.

Trade orders submitted to Bin 1 may be posted on the exchange with an automatic revolving feature attached to the order, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid low. Revolving bids expire when cancelled or modified by the account holder or the exchange upon the occurrence of certain events, including an insufficient trust sub-account balance.

Bin 2R: ▴ BID A YIELD TO MATURITY—Bin 2 [Refer to FIGS. 31, 32 & 33] is an aggregator for all cash-backed BIDS that are submitted to the exchange in the form of a desired yield to maturity expressed as an annual percentage rate of return or a premium or discount rate one is willing to receive for the purchase of a trust-preferred zero coupon note. This bin contains all trade orders received from those desiring to issue and sell a zero coupon trust note to other exchange participants. The successful bidder from this bin (for an arbitrage transaction closing) will be the party who submitted the earliest offer that is also the highest yield to maturity offered at any moment in time in bin 2. In this embodiment it is envisioned that any bidder will be able to leverage for his offer of an investment by potentially selecting borrow from a successful bidder in bin 3. In the event the trade is leveraged, it is anticipated that the successful bidder will be instantly refunded his loan (with one day of interest deducted from the transaction profits achieved by the successful bidder in bin 2). If leverage is required by a bidder in Bin 2, the system is designed to automatically match the loan from bin 3 with the bid in bin 2. It is envisioned that the combination, in the escrow suspense account, of the amounts collected from successful bidders in bin 2 and 3 will be sufficient to allow the transaction to close without a risk of a default by one of the transaction parties.

In this present embodiment it is envisioned that all bidders in bin 2 will have the option of selecting to simultaneously post an offer to immediately resell the note to another bin 2 bidder at the lower yield to maturity bid selected by the exchange.

Trade orders submitted to Bin 2 may be posted on the exchange with an automatic revolving feature attached to the bid, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid high so that the bid will be selected. Revolving bids expire when cancelled or modified by the account holder or the exchange upon the occurrence of certain events, including an insufficient trust sub-account balance.

Bin 3R: ▴ OFFER A FIXED INTRA-DAY INTEREST RATE—Bin 3 [Refer to FIGS. 31, 32 & 33] is an aggregator for all offers to lend intra-day to the exchange bidders in bin 2. Such offers are submitted and received in the form of a desired fixed annualized interest rate or a set fee for a one day loan. This bin contains all trade orders received from those desiring to offer leverage to exchange participants without any longer term commitment. The successful bidder from this bin (for an arbitrage transaction closing) will be the party who submitted the earliest offer that is also the highest yield to maturity offered at any moment in time in this bin. In this embodiment it is envisioned that any bidder will be able to leverage for his offer of an investment by potentially selecting borrow from a successful bidder in bin 3. In the event the trade is leveraged, it is anticipated that the successful bidder will be instantly refunded his loan (with one day of interest deducted from the transaction profits achieved by the successful bidder in bin 2).

Trade orders submitted to Bin 3 may be posted on the exchange with an automatic revolving feature attached to the bid, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid high so that the bid will be selected. Revolving bids expire when cancelled or modified by the account holder or the exchange upon the occurrence of certain events, including an insufficient trust sub-account balance.

Bin 4R: ▾ BID A YIELD TO MATURITY—Bin 4 [Refer to FIGS. 31, 32 & 33] is an aggregator for all offers emanating from those desiring to buy a note on the exchange not necessarily for the purpose of immediately reselling the note, but more for the purpose of holding the note as an investment via the deposit of a note in the trading account. Since the notes are freely tradable and may be resold at any point in time at the prevailing rates established by the bidding process, the holder of such a note can regain liquidity at any time by offering to sell his note as in the case of a bin 1 offer to sell. Bin 4 bids are submitted and received in the form of a desired yield to maturity. This bin contains all trade orders received from those desiring to invest with a longer term view than just participating in an arbitrage transaction closing. The successful bidder from this bin (for an arbitrage transaction closing) will be the party who submitted the earliest offer that is also the lowest yield to maturity offered at any moment in time in this bin.

Trade orders submitted to Bin 4 may be posted on the exchange with an automatic revolving feature attached to the bid, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid high so that the bid will be selected. Revolving bids expire when cancelled or modified by the account holder or the exchange upon the occurrence of certain events, including an insufficient trust sub-account balance.

Bin 5R: ▾ OFFER A VARIABLE INTEREST RATE BASED ON A FLOATING LIBOR BASE RATE—Bin 5 [Refer to FIGS. 31, 32 & 33] is an aggregator for all offers emanating from those desiring to provide liquidity to the arbitrage transaction closing through the acquisition of the trust note issued in bin 1 and bought by the bidder of bin 2 (if not previously resold in priority to a successful bidder in bin 4). Prior to accepting a bin-5 offer however, the system will perform a series of calculation to pre-determine exactly what arbitrage profits are available in the total transaction based on the final liquidity deliver the closing by the final repo buyer. All successful bin 5 offer parameters will be used to convert the interest rate into a discount or premium price off the face value of the trust note in what will be a fully defeased funding assuming the floating interest rate charged remains static. This present embodiment assumes that in the event there is no successful bidder in bin 4 to immediately provide transaction liquidity in the case of a matched trade exit, the liquidity offered by the successful bin 5 offerer must be sufficient to cover all three of the following conditions, or the arbitrage closing will not occur and the system will wait for a lower bin 5 offer to come in until all of the following conditions exist: (a) a mark-to-market reserve set aside designed to cover a potential loss of value of a security up to the stop-loss limit established by the system; (b) the cost of the premium to be paid the successful bidder in bin 6 to secure a non-recourse liquidation of the security in the event interest rates rise; (c) a locked-in arbitrage profit resulting in the difference between the liquidity gained in bin 5 less all other transactional costs required to close the arbitrage transaction.

In this embodiment, the maker of an offer in bin 5 agrees to purchase the trust-preferred zero coupon note from the successful bidder in bin 2 under a master open repurchase agreement, wherein the seller (bidder in bid 2) is obligated to buy back the instrument at a future date and the buyer is obligated to return the instrument to the seller via the exchange, upon simple demand. Even though the transaction is closed as a sale/purchase of a note, it is, for all practical purposes, a loan secured by the trust note. Since interest rate charged by the repo buyer will float based on a pre-established benchmark (e.g. the LIBOR rate—London Inter-Bank Offer Rate), the hedging of the downside risk (in case interest rates rise beyond a pre-determined level) it critically important if one is to guarantee an immediately distributable arbitrage profit to all successful bidders in a yield and interest rate arbitrage transaction closing. For this reason, this present embodiment envisions a reserve set-aside mechanism that will require a pre-set amount of profits earned from the arbitrage transaction to be set aside in order to provide a trust-secured mark-to-market reserve that will be available at all times to the repo buyer to satisfy a decrease in value of the collateral (the trust note) resulting from an increase in interest rate of the loan. The successful bidder from this bin (for an arbitrage transaction closing) will be the party who submitted the earliest offer that is also the lowest interest cost (thus the highest amount of liquidity refinancing to the closing) offered at any moment in time in this bin.

Trade orders submitted to Bin 5 may be posted on the exchange with an automatic revolving feature attached to the bid, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid high so that the bid will be selected. Revolving bids expire when cancelled or modified by the account holder or the exchange upon the occurrence of certain events, including an insufficient trust sub-account balance.

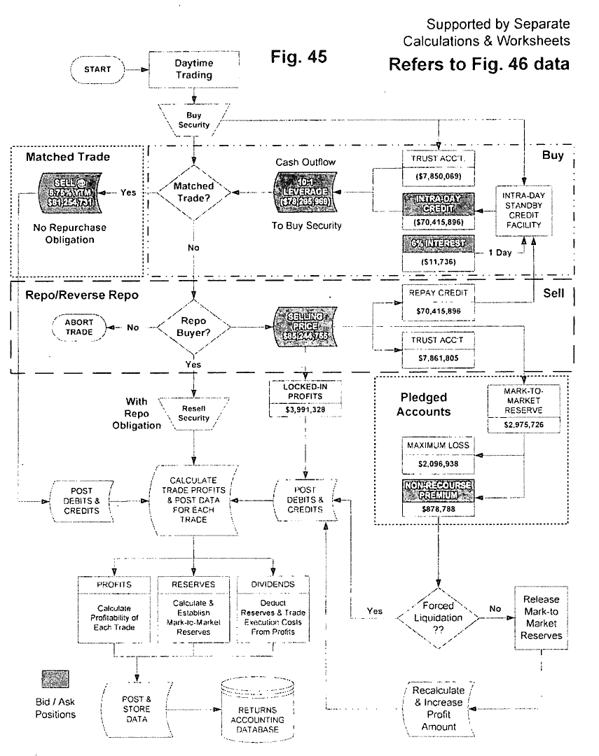

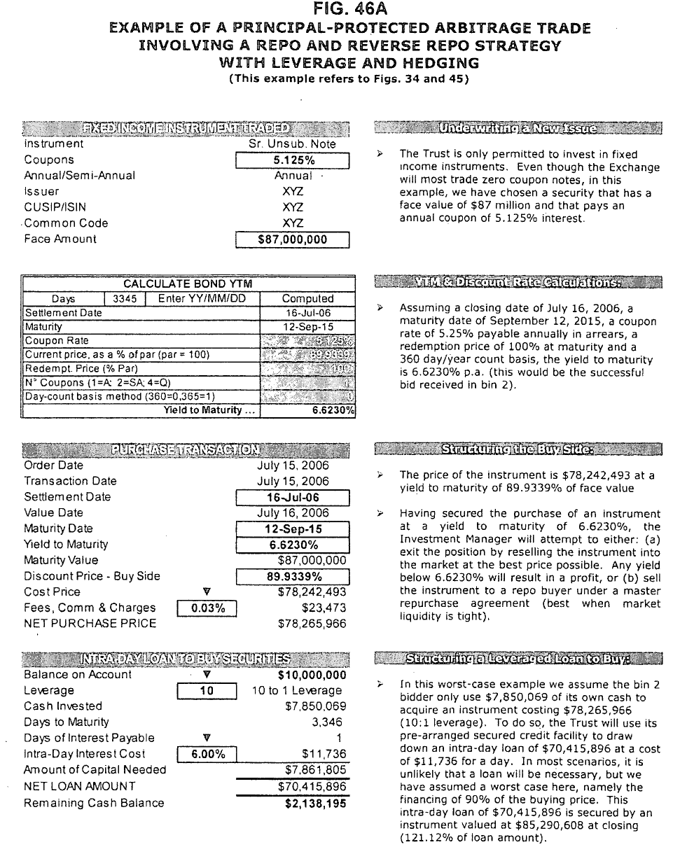

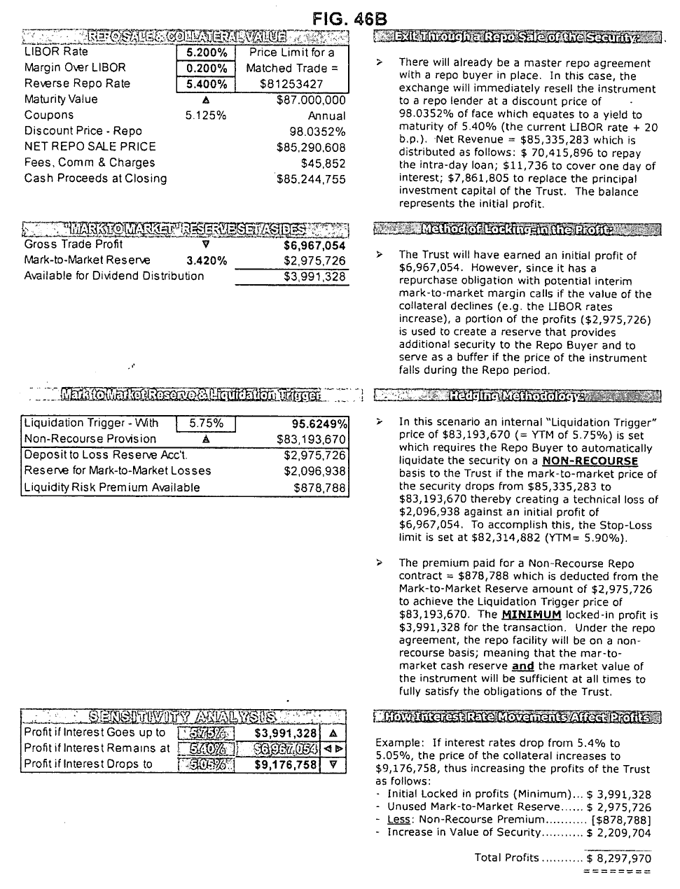

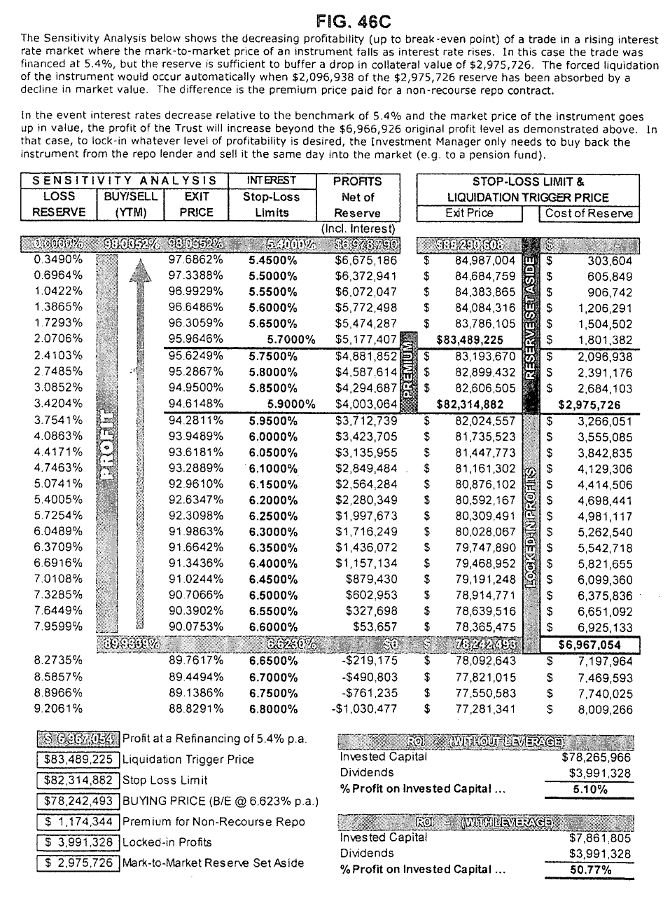

Bin 6: ▾ OFFER TO SELL A NON-RECOURSE, INTEREST RATE CAP PROTECTION WITH NO FLOOR—Bin 6 [Refer to FIGS. 31, 32 & 33] is an aggregator for all offers emanating from those desiring to sell a hedge product consisting of an interest rate increase cap to the transaction participants as a group. In this case the cost of the premium will be deducted from the total arbitrage profits achieved by the transaction. It is envisioned that bids for bin 6 offers will be transmitted and posted on the exchange in either one of two ways: (a) as a set cost expressed in local currency or in transaction units, or (b) as a set interest rate spread expressed in basis points over the stop loss limit established by the transaction processor of the exchange. [Refer to the attached example—FIG. 45 and Computation worksheet FIG. 46 attached separately] For instance, let's assume that the successful offer in bin 5 provided liquidity to the transaction closing (an exit refinancing) that converted to a 6.623% yield to maturity. Assuming further that the system calculated and established the optimum stop loss limit at an interest rate of 5.9% (floating LIBOR rate) and that the successful offer in bin 6 closed at 15 basis points, this means that there is parameters of the final closing will be calculated as follow:
1. Repo Refinancing: 5.4%—yield to maturity
2. Cost of the product: 6.623% yield to maturity
3. Stop-Loss Limit: 5.9%
4. Cost of the Interest Rate Cap (hedge): 15 basis points (bp) above the stop-loss limit.
5. Liquidation trigger: 5.75% (5.9% less 15 bp)
6. Locked-in arbitrage profits: the discount (or premium) price of the security at a yield to maturity of 6.623% and that of the stop-loss limit of 5.9%. In the example provided as an attachment, this profit amounts to $3,991,328 even if interest rate rises from 5.4% to 5.75%. In the event however that interest rate drops, say to 5.05%, the profitability of the portfolio will increase to $9,176,758.

In the above example, the hedge provider will cause the exchange to liquidate the trust note if the floating LIBOR interest rate increases from 5.4% to 5.75% (5.9% less 0.15%=5.75%). Having collected a premium of 15 bp worth of interest cost, the hedge provider will make a profit if he is able to immediately resell the security through the exchange at 5.75% if and when LIBOR reaches 5.75% or if interest rates continue to fall instead of rising. In the event of a rising interest rate market, the hedge provider will be forced to liquidate the security through the exchange and assumes the risk that a buyer may not be found at the liquidation price. If that happens, the hedge provider will start incurring a loss if interest rate increase above 5.9% and he is still unable to liquidate the security into the market at a price of between 5.75% and 5.9%.

The successful bin 6 offer parameters will be used in bin 5 to calculate the profitability of the overall contemplated arbitrage closing. This present embodiment assumes that in the event there is no successful bidder in bin 4 and there is no successful bidder in bin 6, that the transaction will not close. However, it is possible in another embodiment to envision such non-recourse interest rate hedge to be made available to a transaction closing in the form of an insurance guarantee, a bank guarantee, a standby letter of credit, or any other form of pledged security that guarantees liquidity in the event interest rates rise beyond the liquidation trigger price established by the non-recourse interest rate cap. In this embodiment it is further assumed that the provider of the hedge will be required to leave on deposit in his account the amount of the premium charged for the hedge, however in a different embodiment it may be envisioned that such bidder will be a major financial institution whose balance sheet strength will not necessitate such escrow deposits. In this present embodiment it is envisioned that a permanent offer will be automatically, and without further action by the transaction parties, in the event any bid posted in bin 4 yield achieves a yield to maturity of 5.75%. The moment that such a bid is obtained through the exchange, the exchange will automatically liquidate the repo by creating a reversal of the original repo, wherein the exchange will close a new transaction (herein referred to as a “Repo Reversal”) comprising the repurchase of the original security from the repo buyer followed by a simultaneous resale of that same security to the successful bidder in bin 4, and the release of the 15 bp escrow reserve charged for the premium by the successful bidder of bin 6.

Trade orders submitted to Bin 6 may be posted on the exchange with an automatic revolving feature attached to the bid, meaning that after a particular closing has settled, and assuming that the trust sub-account of the bidder is sufficient to guarantee the next trade, the same offer will be posted again by the exchange without any intervention by the account holder after each successful closing, thereby allowing the participant to maximize his earnings by fine-tuning his bid so that there will be an incentive to bid high so that the bid will be selected. Revolving bids expire when cancelled or modified by the account holder or the exchange upon the occurrence of certain events, including an insufficient trust sub-account balance.

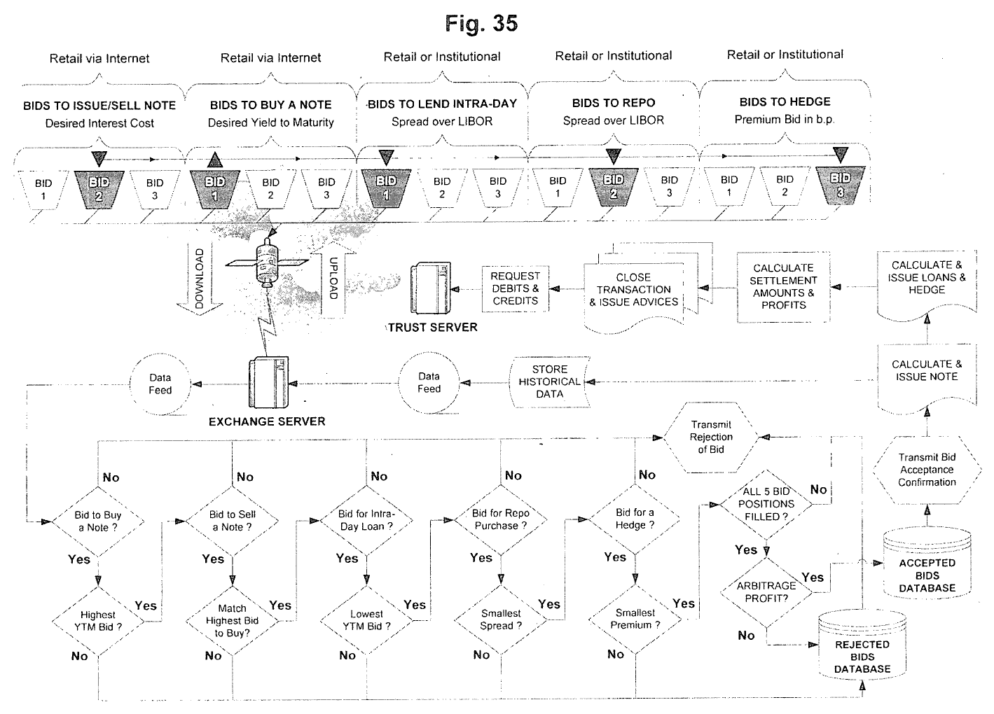

In this embodiment it is anticipated that all transaction will close in such a way as to guarantee an arbitrage profit to all participants [Refer to FIG. 35]. However, in a different embodiment it may be possible to create arbitrage transaction closings that are secured by appropriate collateral or by the strength of the balance sheet of the transaction participants. It yet another embodiment it may be envisioned that the hedge provided in bin 6 consists of an interest rate collar that places both a floor and a cap on the interest hedge, thereby giving a significant upside benefit to a hedge provider in the event interest rates fall instead of rising, with or without a pre-set period of time. In this same embodiment it may be envisioned that the interest charged for the repo refinancing is a fixed rate of interest instead of a floating rate where the profitably of an arbitrage transaction can immediately be assured. It can be envisioned that the exchange can offer both options to liquidity providers and it is possible that the exchange may build such an option into its bidding process, thereby allowing fixed or floating interest rate offers to be posted in bin 5. In such an event, having access to a fixed rate repo will effectively eliminate the need for a non-recourse interest rate increase hedge and thus no bin 6 bidder will be required. This in turn will increase the arbitrage profits to the participants.

Bin 7R: In this embodiment Bin 7R [Refer to FIG. 31] is a bin that will allow retail bidders to post bids to buy portfolios of fixed income products issued at the retail level to hold as an investment portfolio.

Bin 5W: In this embodiment Bin 5W [Refer to FIGS. 31 & 32] is designed to provide institutional bidders the ability to offer repo loans to the retail part of the exchange by offering to repurchase a TU denominated Trust-Preferred Note (with or without coupons) secured by a cash deposit in trust expressed either as a set number of basis points desired over a fixed or floating LIBOR rate set by the market on the day the loan is made or as a fixed annual interest rate. In this bin, a successful bid at the wholesale level will be automatically accepted at the retail level of the exchange if it is better than the best retail rate. In this or other embodiments, it will be possible to add other desired terms and features wherein the offer, may include the maximum term of the repo (or an open repo); put and call options, the handling of periodic interest payments (applied to the interest due or collected and passed through to the original seller of the security); the right of offset (offset of assets and liabilities), the right to lend the security; the right of substitution of the security by another like-kind instrument; an upper and lower limit for the Bid that allows the exchange to adjust the Bid to that of an Ask so long as the strike price is between the lower and the upper limit of the order; a bid to provide a non-recourse hedge (see below) for a fee, wherein the repo buyer will be free to liquidate an instrument in a rising interest rate market when a pre-agreed liquidation trigger price is achieved.

Bin 6W: In this embodiment Bin 6W [Refer to FIGS. 31 & 32] is designed to provide institutional bidders the ability to sell interest rate cap products to the retail part of the exchange. In this case an offer to sell a hedge product will be at a pre-set rate expressed as a number of basis points relative to the face value of the instrument or as a pre-set desired profit amount in TUs, wherein the hedge represents a fixed premium amount charged by the repo buyer to the repo seller in advance as full and final payment for a non-recourse liquidation of the Trust-Preferred Note in the event the decrease in value of the Note (caused by an increase in interest rate of the underlying currency) causes the loss of market value of the instrument to exceed the pre-set mark-to-market reserve set aside representing the stop loss limit. The bid may be attached to a repo bid if desired or may be submitted by an independent unrelated party.

Bin 7W: In this embodiment Bin 7W [Refer to FIG. 31] is a bin that will allow institutional bidders to post bids to buy portfolios of fixed income products issued at the retail level to hold as an investment portfolio.

Bin 8W: For this embodiment, it is envisioned that an 8^{th} bin (8W) [Refer to FIGS. 31 & 39] is added to the wholesale platform only, but can be duplicated for the retail platform also in a different embodiment wherein the 8^{th} bin would also be made available for both retail and wholesale bidding. This bin is intended to process offers and bids for swaps and swaptions in interest rates (variable for fixed or fixed for variable in a variety of currencies) and future deliveries of currencies (one currency for another at a pre-determined future date). This 8^{th} wholesale bin provides an important risk elimination process in the arbitrage transaction. This embodiment makes provision for an unwinding mechanism at the tail end of a transaction that allows holders of one currency to sell (directly or via an option) that currency to another party who desires to take delivery of that currency at a future date. In this process the risk of having to hedge one currency against another for possible long-term currency devaluation risk is eliminated through the swap of future exposures.

In this embodiment Bin 8W is designed to provide institutional bidders with the ability to place offers and bids at the wholesale of the exchange only. In this embodiment it is not envisioned that offers and bids in bin 8W will be reflected at the retail level, but it a different embodiment, the creation of a new bin N° 8 at the retail level can be envisioned wherein the successful bids posted in 8W would automatically be made available to the retail plane of the exchange in order to provide a full-cycle process for a fully hedged and risk-free arbitrage transaction. In this embodiment, bin 8W is designed to receive offers and bids to swap a TU denominated Trust-Preferred Note (secured by an underlying cash deposit in a particular currency) with another similar instrument (secured by an underlying cash deposit in a different currency), thereby effectively doing a currency swap through the swap of cash-backed Trust-Preferred Notes, wherein the two notes carry different yields to maturity.

Additionally this embodiment also makes provision for institutional bidders to submit offers to swap a cash flow stream consisting of a series of future variable interest rate payments due on a TU-denominated Trust-Secured Loan (secured by trust deposits in a particular currency) for a cash flow stream consisting of a series of future fixed interest rate earned periodically on a cash-secured TU-denominated Trust-Preferred Note (securitized by cash deposits in the same currency), wherein the Loan and the Note have the same periodic interest payment dates and ending maturities.

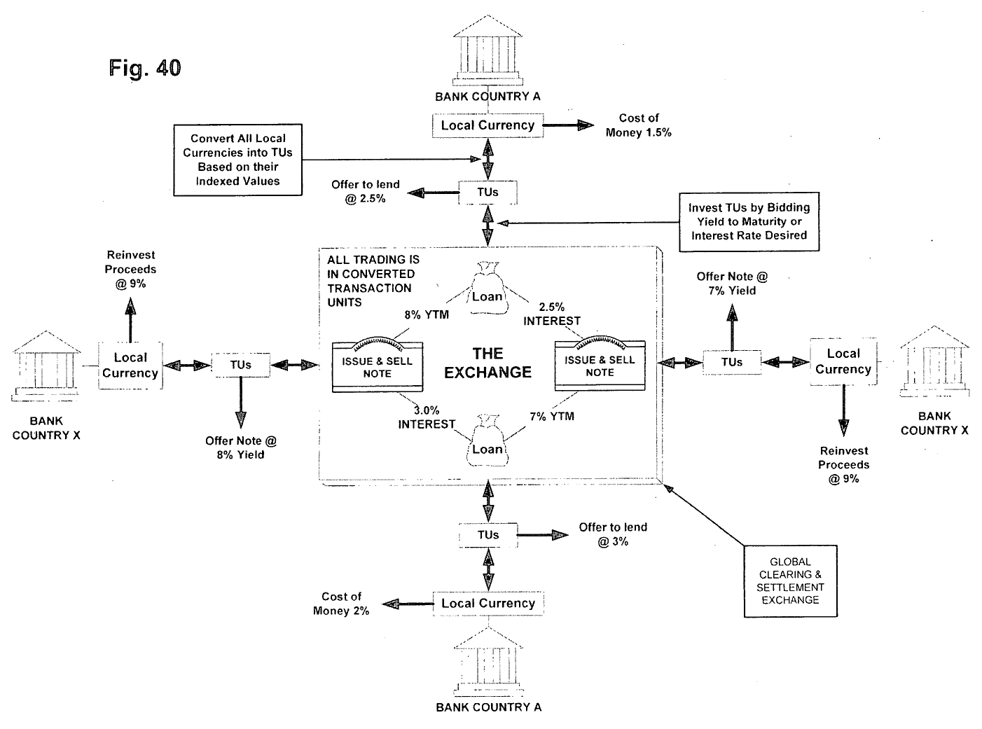

The importance of bids submitted in bin 8W is illustrated below by way of this example [Refer to FIG. 40]. An exchange participant residing in Japan has a cost of money would of say 2% and places a successful bid on the exchange at say a 3% interest rate. Simultaneously a successful bidder in South Africa posts posted an offer to sell a trust preferred zero coupon note on the exchange a yield to maturity of 7% p.a. Assuming that the arbitrage is between the underlying Japanese and South African currencies, technically, the note issuer would be taking a significant currency fluctuation risk if the positions are maintained to their respective terms without some form of a hedge. In the normal world, most people would hedge this position by buying a forward contract or by swapping future deliveries of one currency for another [Refer to FIG. 1]. This is precisely what is envisioned here to occur in bin 8W (or at the retail level of the exchange also in the case of another embodiment that involves a new bin 8R). In this example, through the swap mechanism a third-party may directly purchase the benefit of receiving Japanese yens at a future date or purchase he may purchase an option to swap (a swaption) to buy yens at a future date (e.g. in the case of a trader who will need Yens say in 12 months to settle a yen-denominated liability). In this example Japanese Yen were technically converted on the closing date into South African Rands through the TU index rate and there is liability to return yens at maturity and to meet the debt service in yens in the interim. However, if a third-party offers to acquire yens at the same future delivery date from the exchange or directly from the institutional bidder, the currency fluctuation risk will be eliminated entirely and the arbitrage of the two currencies will stand on its own two feet.

In a different embodiment, it may be envisioned that a new bin (8R) operating at the retail level will be able to deliver a mechanism that also allows retail bidders to submit offers to buy specific currencies from the exchange at a pre-determined future date and yield to maturity. This mechanism can be used by a Japanese Yen account holder on the exchange to offer to issue and sell a zero coupon note that will guarantee delivery of yens through the exchange at precisely the moment yens will be required to settle the previous yen loan component of the first arbitrage transaction. In this later hypothesis, if the zero coupon note uses is at a 3% yield to maturity and is used as a stand-alone exit strategy, the first arbitrage closing will benefit from the full spread between the 3% and 7% (since the maturities of the yen loan and the note match and are at the same rate), thus providing a powerful cross-currency arbitrage opportunity to exchange participants.

Turning our attention now to the exchange itself, in this embodiment, it is envisioned that the backbone (the hardware, software, communication system, firmware or any combination thereof) of the exchange will be divided of sub-sections required distributed processing [Refer to FIG. 22], namely:

1. A transaction unit (TU) index administrator and a foreign currency and interest rate management system [Refer to FIG. 17] that calculates at periodic intervals the values of each currency around the world relative to each other and that converts same to a TU value, wherein the latest rates will drive all exchange rated conversions;

2. A bid and ask assistant designed to communicate information between account holders and the exchange and vice-versa [Refer to FIG. 45]. In this embodiment it is envisioned that the communication device can consist of a cell phone, a computer, a PDA or any other form of communication device that links the account holder to the information provided by the exchange. In the present embodiment it is envisioned that the bid and ask assistant will be designed to provide a software-driven interface and link via the internet to the exchange wherein offers and bids can flow easily from the exchange to the communicate information at regular intervals to enable exchange participants to adjust their bids relative to the latest transaction closing information. For instance if a person has placed a bid to issue and sell a trust note at a yield to maturity of 6.75% p.a. while hundreds of bids are ahead within a delta of between 5.5% and 5.9%, by providing information to the bidder, it may be possible to help the bidder adjust his bid so that it will ultimately get picked by the system. In another embodiment, it may be possible to communicate information regarding the spread between the lowest and highest bid in any currency in selected bins or cross currency bids and asks parameters to enable a bidder to place a bid in a different currency. The Offer/Bid Assistant can be programmed with bidder-preference settings that allow the bidder to calculate and prepare bids based on his preferences, to calculate yield to maturities for instruments that have a discount or premium price (and vice versa), to select target currencies that are of interest, or to cause repetitive bids to be posted with minimal operator intervention each time a new bid is transmitted.

3. A Switch Mechanism that connects the various accounts as previously described herein [Refer to FIG. 14].

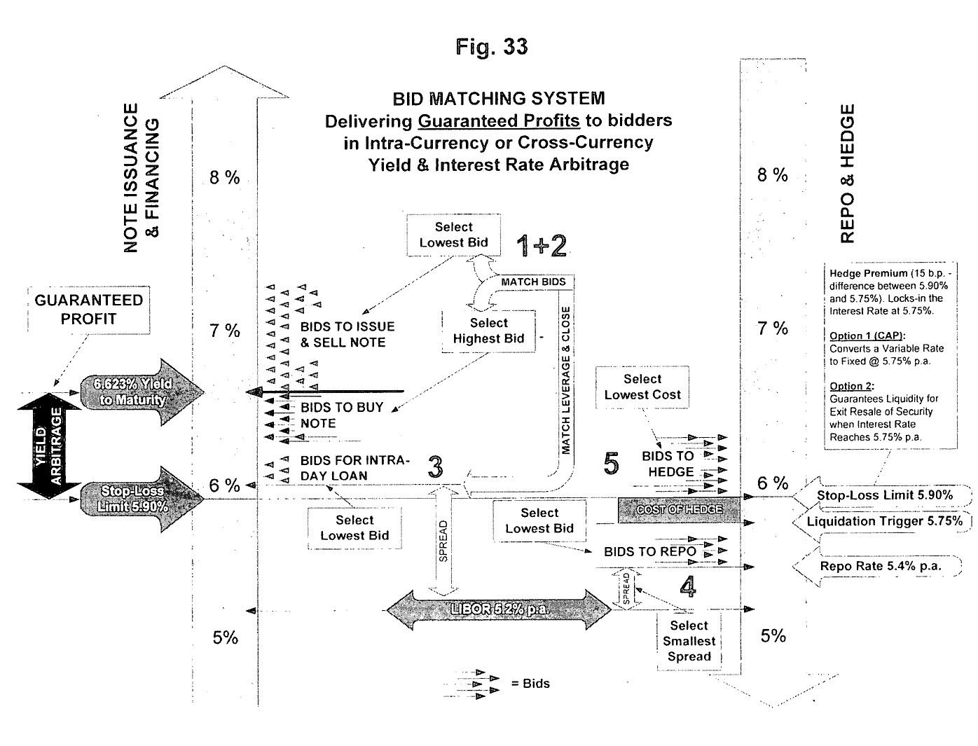

4. A Bid/Offer Receiver/Processor that receives each bid and processes the bid based on set parameters for the purpose of validating each bid, calculating missing parameters based on submitted variables sorting it and placing it in specific bins with a time stamp [Refer to FIG. 33].

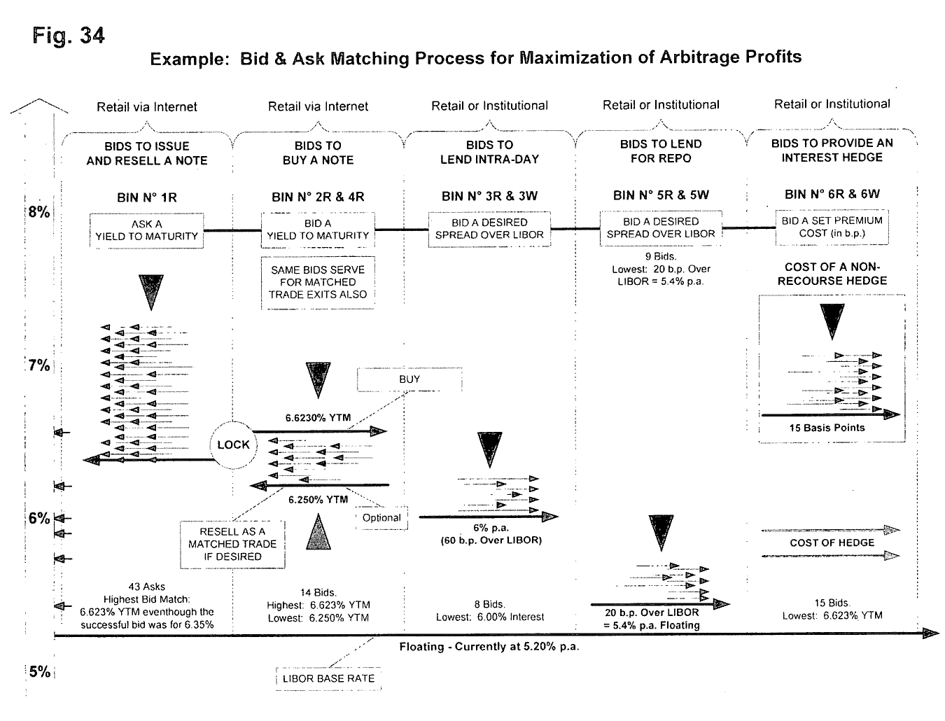

5. A Bid/Offer Aggregator that contains the specific bins. The aggregator receives the bids and distributes them inside each bin in order of the most beneficial bid or offer in terms of arbitrage spread maximization [Refer to FIG. 34].

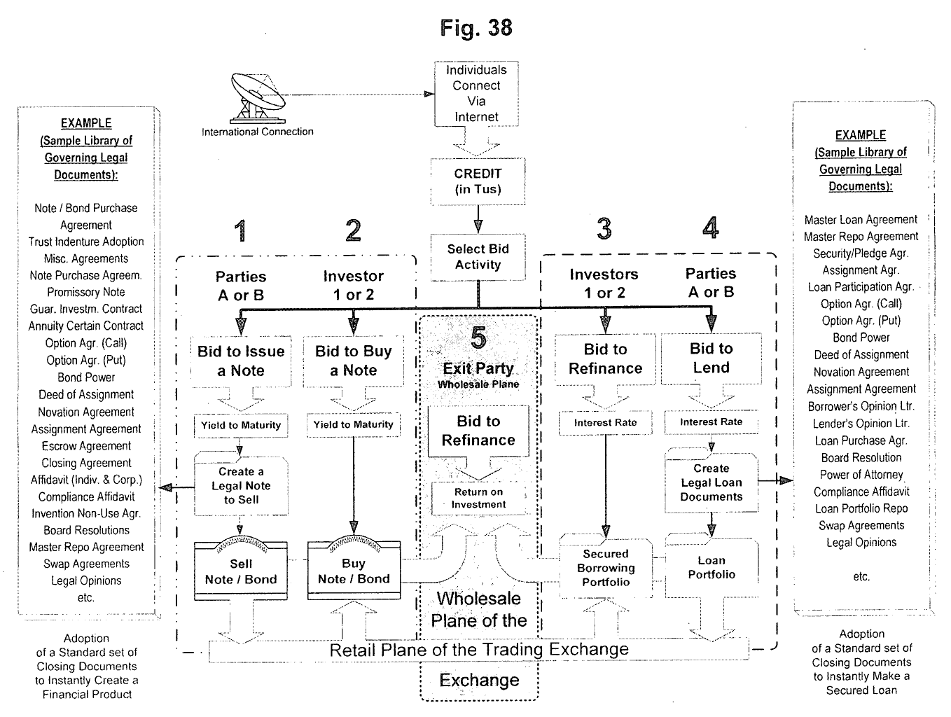

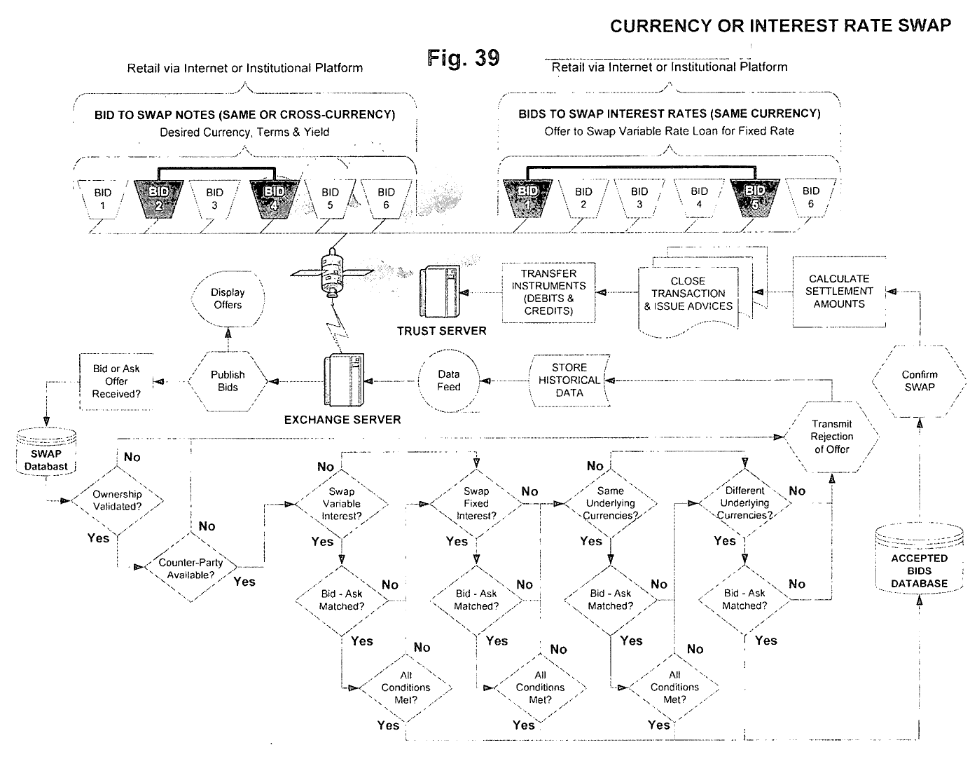

6. A Financial Product Creator engine that receives successful bid parameters from each of the six bins and converts them into financial products that meet the exact specifications of the arbitrage transaction exchange so that such financial products can be bought, sold and transferred via the exchange [Refer to FIG. 38].

7. A Transaction Builder/Assembler engine that selects the most advantageous bids from each bin in order to create an arbitrage transaction closing that will result in the maximum profit possible for the arbitrage transaction. In this process the bids are converted to specific dollar revenues and costs and organized in order of benefits delivered to the exchange. In this process specific offers and bids are selected from each bin and sent to a special closing bin that is created specifically for each closing and is identified by a transaction closing reference number that becomes attached to each component of the closing [Refer to FIGS. 34 & 35].

8. A Profit Calculator & Simultaneous Transaction Closing process that calculates the final profit to be generated from the arbitrage transaction closing and prepares a master settlement worksheet for the closing (for accounting and tax purposes) and simultaneously closes all components of the arbitrage transaction, whereupon the transaction itself will be deemed to have closed. If for whatever reason any of the components envisioned in this embodiment do not close, the closing will be aborted and the components returned to their respective bins, however it is possible to envision another embodiment where the transaction will still close and the transactional risks which are eliminated within the context of this embodiment are actually hedged through some other process or where the longer term exposure is carried forward by the successful bidders in an arbitrage closing.

9. A Clearing & Settlement Process where all the debits and credits that are required to close each component of an arbitrage transaction are effectively posted to all the target accounts and the profits are distributed in the manner envisioned by the rules of the exchange and/or the master trust agreement governing the operations of the trust that operates the exchange [Refer to FIG. 22].

In another embodiment, it is possible to envision a system whereby the central exchange operates a country-specific node [Refer to FIG. 36] whereby each country provides a complete platform to its own retail customers and institutional bidders in a single currency and each local platform in turn sends its most advantageous bids in each retail bin to a global arbitrage processor engine that calculates and captures the most beneficial cross-currency arbitrage opportunities around the world. In this system the local arbitrage potentially occurs through the process of localized disintermediation of the banks as the middleman that borrows from the left and lends to the right at a profit. By creating such an efficient intra-currency arbitrage platform that connects with other similar arbitrage platforms around the world, each platform will perform the task of submitting the most efficient bids from their local economies to the global exchange platform where more profitable transactions can be engineered and closed. In yet another embodiment it is possible to envision the global exchange platform used strictly to drive a purely institutional and bank-connected arbitrage exchange rather than allowing the citizens of one country to participate in cross-currency transactions through the retail level of the platform. This may have particular advantages in countries where exchange control regulations or local laws may prevent the citizens of a country from participating in foreign currency dealings without central bank approval. This may also offer tax advantages and benefits that are unforeseen in this present embodiment due to the vast body of tax laws on a worldwide.

It may be envisioned also that a node of the exchange can consist of a particular network operated by a group of people (e.g. of employees of the same company or affinity group) and that those nodes are in turn connected to a national node.

It is to be noted that in this present embodiment the process of scanning, calculating and selecting bids for closing from each bin is a constant and ongoing process whereby at pre-set periodic intervals (e.g. every two seconds), the system will decide if the assembly of the best offers and bids of each bin will produce either an intra-currency or a cross-currency arbitrage advantage [Refer to FIG. 34]. When the system determines that it does, it will automatically select and remove those offers or bids from the queue and submit them automatically for a closing that will occur immediately. This potentially means that when a revolving offer or bid process is selected as a preference by a bidder on the exchange it is possible that one picked in a previous arbitrage will get picked again if the conditions are met, including that there is sufficient cash in the account each time to support the bid or the offer. It also means that transactions will close at rapid intervals, thereby establishing a dynamic market that can provide constant feedback to the market (the offer/bid assistant device or system described above) relative to current market conditions.

This process of selecting offers and bids and sending them for closing is expected to create a constant flow of closed full-cycle arbitrage transactions that are expected to ultimately produce a market-driven interest rate and yield curve economy that can then be used to drive other sectors of the economy, if need be. In this rate-setting process the arbitrage potential will continue to be reduced until such time that the system can no longer create a profitable arbitrage, whereupon the system will be deemed to have optimized its rate-setting function by becoming optimally efficient. Until that efficiency factor is achieved, significant opportunities exist on a global basis for intra-currency or cross-currency arbitrage of yields and interest rates. In another embodiment of this invention it can be envisioned that the offers and bids and the bin sorting process would all be in local currencies or specific currencies thereby allowing trading of actual currencies to take place without going through the transaction unit (TU) conversion process.

Because it is difficult for most people to understand how banks make money, one particular embodiment of this invention is provided herein as a way of executing, through a board game, real-life financial transactions that are designed to create profits for all participants. In the process of demonstrating that it is possible to engineer structures and methods that deliver a profit at the tail end, we also demonstrate the process of how easy it is for central banks that can in effect print money or banks that have access to liquidity can use pre-engineered financial methods in order to create a profit for themselves and for those they wish to favor. In this embodiment the financial processes designed to produce a profit for all participants is best illustrated in the form of a board game, but in other embodiments of the same invention the same financial processes and methods can be implemented in real life for profit.

Embodiments of this invention offer benefits and advantages that can have a profound impact on both the protection of and enhancement of individual and corporate wealth, by providing the tools necessary to address inequities inherent to the current global monetary system. The implementation of such embodiments has the potential of impacting the world of finance as follows, although claimed subject matter is not limited to a particular embodiment or to these advantages:

a. It offers an alternative international fiduciary financial system, in affect, a new global exchange, that uses trust laws to create fiduciary accountability for those who have access to, and control over the wealth of a nation.

b. It offers a new global financial system that allows an international fiduciary-based banking system to operate in parallel with the existing global banking infrastructure, in which the global monetary system is made subservient to a fiduciary one, not the reverse.

c. It offers a method for any party (individual, group, business, etc) to enter the banking business and provide fiduciary-based banking services (through the appointment of a trustee and the creation and management of a trust), thus competing directly with banks through the issuance and sale of fully-secured, Trust Preferred Notes (promissory notes or debt instruments), Trust-Secured Loans and Trust-Connected Debit Cards, all of which become monetary instruments that replace bank CDs and bank loans and can be freely traded on a financial exchange for the specific purpose of creating arbitrage opportunities for participants.

d. Through the operation of a global rate-setting exchange (for worldwide interest rates and investment yields), it describes how those outside the global monetary system can create fully defeased, profitable arbitrage transactions, without risk of loss of principal, that can compete directly with the existing global monetary system.

e. Through a process of linking a visible retail bidding platform of this new global exchange, with an invisible wholesale/institutional one, it allows banks to provide liquidity to the retail platform through a repo/reverse repo mechanism operated through the exchange, and to participate, for profit, as market makers on the exchange, thus providing services to retail customers through the exchange, and receiving a reasonable compensation for such services.

f. Through the use of a global interest rate and investment yield-setting system, implemented through the exchange via a bid and ask process, particular embodiments demonstrate the ability to create a regular and constant flow of financial arbitrage opportunities where the cooperative mining of such opportunities can result in substantial profits for market makers and market participants in what may be termed genuine “riskless-principal” (or principal protected) transactions. Thus the adage, high risk=high returns is disproved by this invention.

g. Particular embodiments demonstrate how banks can be disintermediated from the process of borrowing and lending, and how in this process the exchange participant (both lenders and borrowers) can increase their investment returns or lower their borrowing costs.

h. Through the interest rate and yield-to-maturity rate setting mechanisms of the exchange, the invention demonstrates how current market inefficiencies, heretofore only a source of substantial profit opportunities for banks, can be made available to those outside the global monetary system. Through the management of an “ask” and “bid” process described in this invention, consumers, not the central banks, will determine what interest rates and currency exchange rates should prevail worldwide. Particular embodiments may give every country's citizens the ability to control and manage their wealth.

### “System & Method for Yield & Interest Rate Arbitrage”

### (A Board Game One can Create and Play to Understand What is Illustrated Herein)

1. In this process two bank customers, Customer 1 and Customer 2 (unrelated parties), are connected through a third party (named here the “Option Holder”) who remains “out of the picture” in the process until the last moment. In this process, the 3^{rd} party has an option to call (option to buy) the financial portfolios (assets and liabilities) accumulated by the two bank customers in the transactions (described later) at a pre-agreed option strike price of $2,000,000 each, payable at closing. This simply means that at the end of the process, all the “game simulated” transactions will have been completed and the results will accrue to the 3^{rd} party, the Option Holder, after payments totaling $4,000,000. When this happens, both customer 1 and 2 will have earned $342,736 as will be demonstrated in this example of the money creation process.

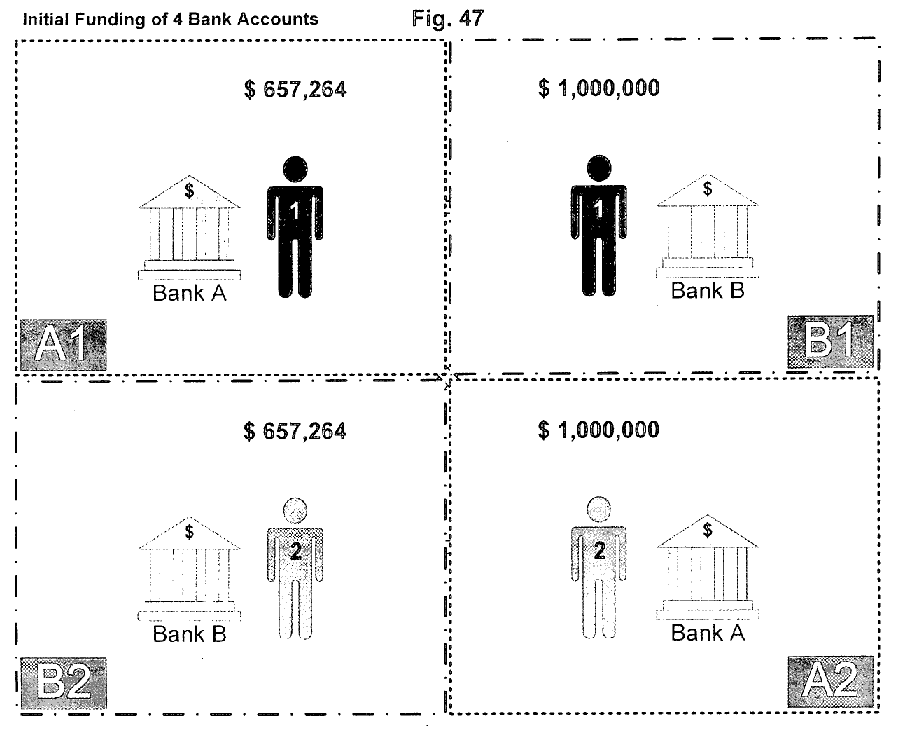

2. To begin the process: (a) customer number 1 opens: (i) a regular demand deposit account at Bank A in which he deposits $657,264, and (ii) a regular demand deposit account at Bank B in which he deposits $1,000,000; (a) customer number 2 opens: (i) a regular demand deposit account at Bank A in which he deposits $657,264, and (ii) a regular demand deposit account at Bank B in which he deposits $1,000,000. Each bank customer is required to deposit a total of $1,657,264 to start the process. The process is best described in the board game [Refer to FIG. 47] one can duplicate in a larger format to play the game:

### Preparation of the Board Game Pieces:

1. The board game below illustrates how the bank accounts must be set-up to start with. The game pieces that follow provide a total of 15 game pieces for Customer 1 and 15 game pieces for customer 2 for a total of three full investment and loan cycles only (more can be done, one has to print more pieces than is provided herein).

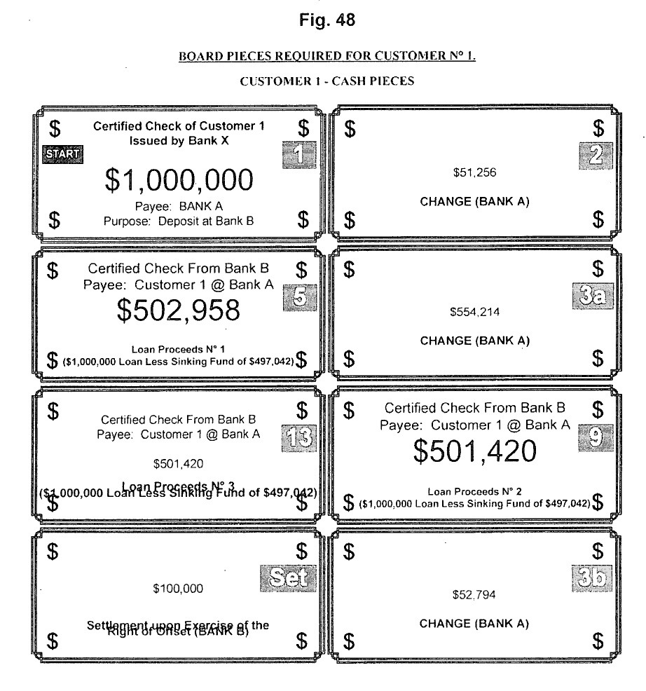

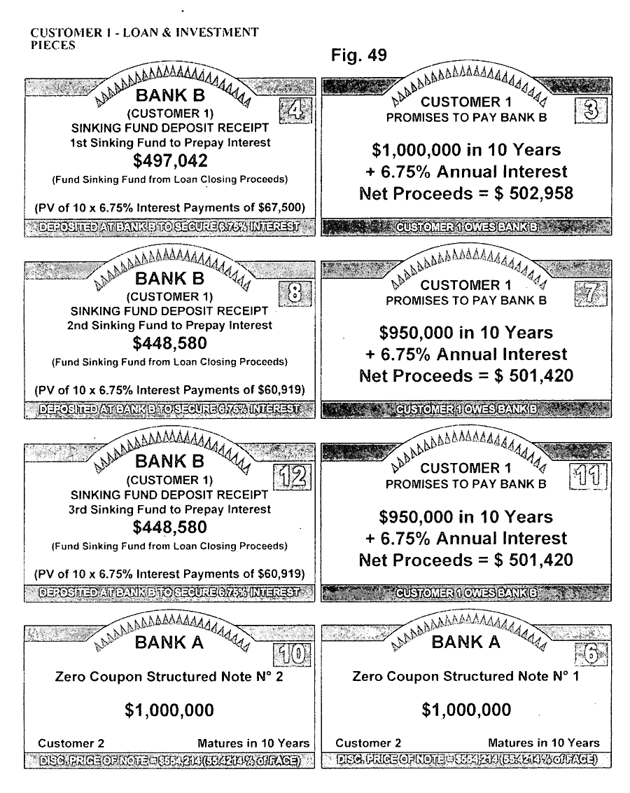

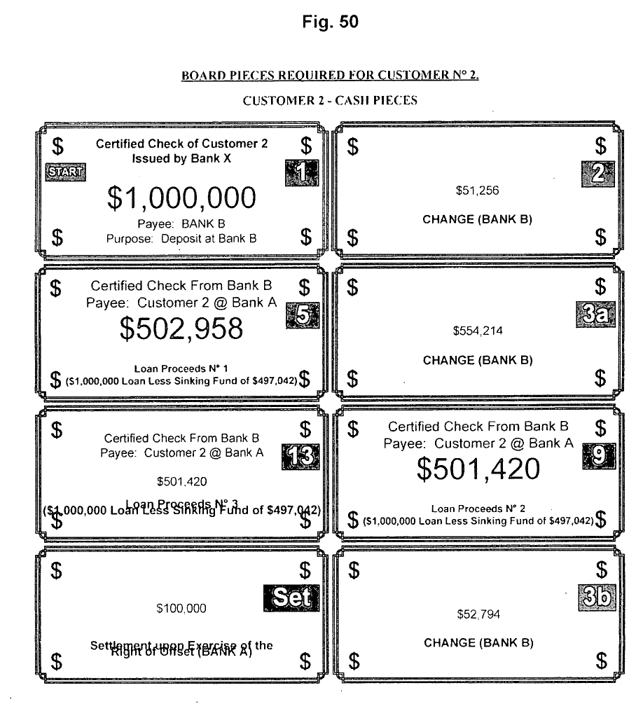

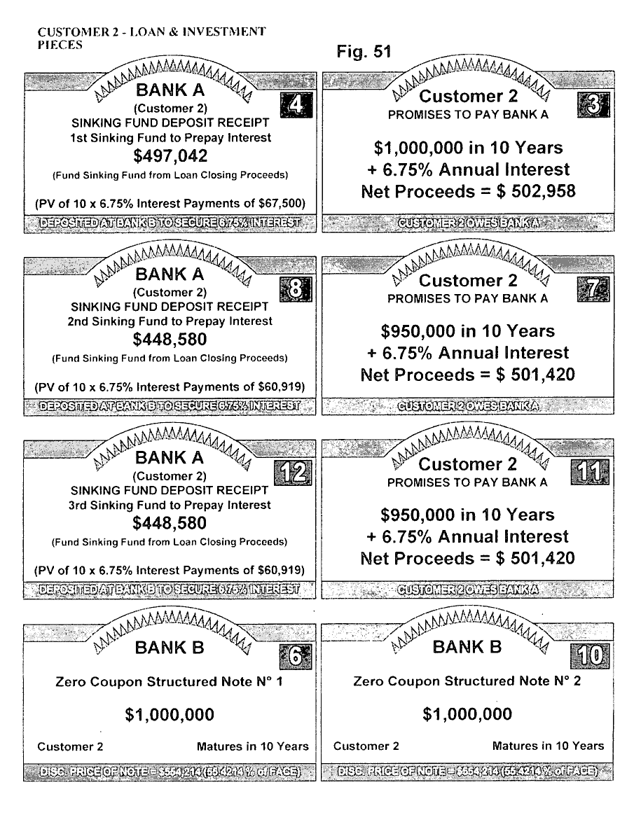

2. Game pieces for customer 1 have a grey numbering system [Refer to FIGS. 48 & 49] while those of customer 2 have a black one [Refer to FIGS. 50 & 51]. This will prevent the commingling of pieces as they must remain separate throughout the entire process.

3. Cut the pieces numbered 1 through 13 for each of the customers.

4. Separate the pieces into the blacks and the grays and keep them separate for the game.

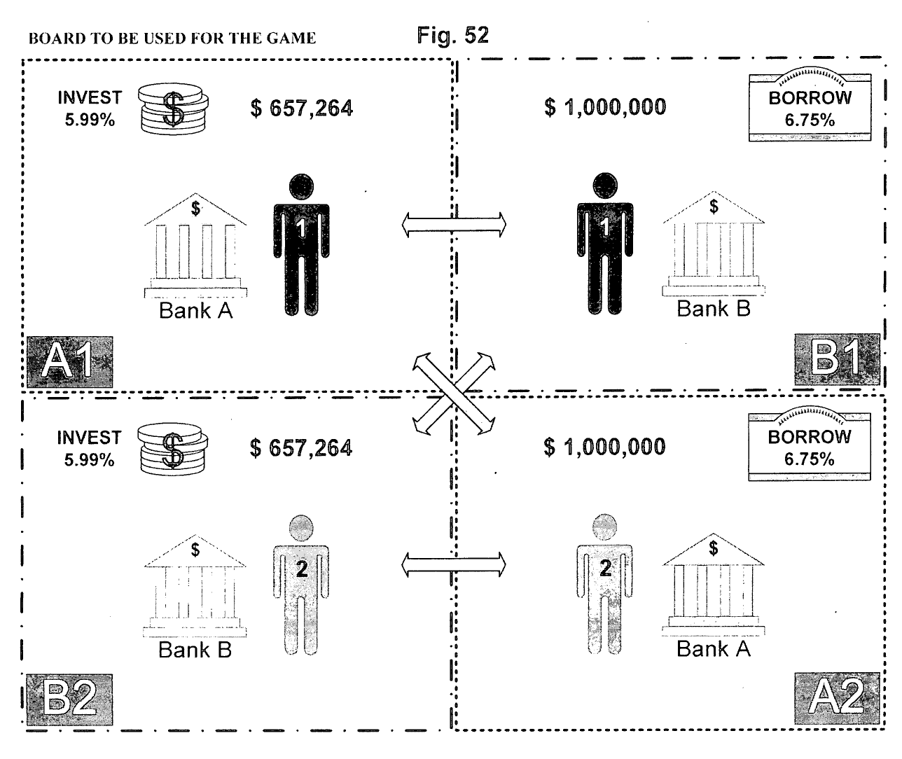

5. Print and place on a work surface the board game diagram [Refer to FIG. 52]. The movement of each piece is accomplished in blocks A1, B1, B2 and A2. On the map one deposits the grey and black pieces (from above). Execution of a series of transactions is as follows:
In A1 and B2 are investments (yield to maturity offered by the bank: 5.99%)>
In B1 and A2 are borrowing (interest rate charged by the bank: 6.75%)

Though it appears that this series of investments and borrowings result in a loss, in that one will be borrowing from one bank at 6.75% interest and lending to another bank at 5.99% it is best to reserve judgment until the end of the process.

6. Separate the pieces between Customer 1 and Customer 2 and sort them in sequential order from the smallest to the largest number (Grey for Customer 1, black for Customer 2). There will be two piles, identified as grey and the black piles.

7. The pieces with the grey numbers should be used for squares A1 and B1 only and those with the black numbers should only be used in squares B2 and A2.

8. Start with the Grey Pieces (Customer 1) and complete all the transactions indicated below. Here are some other suggestions:
When beginning, place the pieces numbered [1 Grey] in the top right box and [4 grey] in the top left box. This is the start-up capital invested by customer 1. Place the pieces numbered [1 black] in the top right box and [4 black] in the top left box. This is the start-up capital invested by customer 2.
When money is paid to the bank to acquire a financial instrument, place the piece under the page since it is not the customer's account.
When money is received by the customer, place it on top of the page in the appropriate square A1 for customer 1 and B1 for customer 2.
When money is pledged as collateral against a loan or a loan is secured by a particular security, turn the piece over so that you will see the white side of the paper. This means that there is a lien against that particular security or cash and it is not directly available to the customer.
Deposit all loan proceeds in the left boxes (A1 and B1)

### MOVES FOR CUSTOMER 1 (Grey Pieces)

### BORROWS & REINVESTS THE PROCEEDS:

| | | | |
|---|---|---|---|
| Pre-Cycle | 1 | Deposit $1,000,000 in Bank B (box A2) | Place Grey card #1 |
| | | | face up in Box B1. |
| | 2 | Deposit 3 checks totaling $657,264 in Bank A (box | Place Grey pieces #2, |
| | | A1). | #3A, and #3b face up |
| | | | in box A1. |
| Cycle 1 | 3 | Customer 1 borrows $1,000,000 from Bank B for | 1. Deposit Promissory |
| | | 10 years at an interest rate of 6.75% per annum: | Note #3 in box B1 (face |
| | | Take from the pile of cards, cards 4 and 5 | up). |
| | | representing cash amounts of $502,958 | 2. Collect Grey card #4 |
| | | and $497,042 that total $1,000,000. | face from the pile of |
| | | In this transaction, the loan from Bank B is | cards and place it face |
| | | fully secured both by a cash deposit of | down on the right of the |
| | | $1,000,000 (now blocked in the account by | board game (since it is |
| | | Bank B) and by a new sinking fund account | not immediately |
| | | created (card #4) by depositing in the | available to you.) |
| | | present value of all future interest | 3. Collect Grey card #5 |
| | | payments discounted at a yield of 5.99% | ($502,958) from the |
| | | p.a. This means that the deposit today of | pile of cards and place |
| | | $497,042 that earns interest of 5.99% per | it in box A1 - face up. |
| | | annum will be sufficient to make all ten | |
| | | interest payment of $65,000 when due over | |
| | | the next 10 years. | |
| | | IMPORTANT NOTE: It is assumed in this | |
| | | demonstration that in all loan agreements between | |
| | | the bank and its borrowing customer, there is a | |
| | | clause that permits: (a) the early repayment of | |
| | | loans without penalty, and (b) there is a right of | |
| | | offset, which means that both the bank and its | |
| | | customer can write off matching assets and | |
| | | liabilities (e.g. the bank can apply cash in the | |
| | | customer's account to the payment of debts to the | |
| | | bank). | |
| | 4 | Customer 1 lends $554,214 to Bank A for ten | 1. Remove piece #3A |
| | | years by purchasing a zero coupon “Note” (or | from box A1 and place |
| | | certificate of deposit) issued by Bank A.. Assuming | it face down on the left |
| | | the bank agrees to pay a 5.99% yield to maturity, | side of the board game |
| | | the amount tendered on day 1 = $554,214, | (this money now |
| | | wherein the bank agrees to pay $1,000,000 (the | belongs to Bank A |
| | | face value of the note) at maturity (cost: 55.4214% | since they gave you a |
| | | of face). | “Promissory Note”. |
| | | | 2. Collect Grey card #6 |
| | | | from the pile of cards |
| | | | and deposit it in box |
| | | | B1. |
| Cycle 2 | 5 | Customer 1 borrows $1,000,000 from Bank B for | 1. Deposit Promissory |
| | | 10 years at an interest rate of 6.75% per annum. | Note #7 in box B1 (face |
| | | This time however, Customer wishes to pledge a | up). |
| | | ten year Note of Bank A as collateral for the loan | 2. Collect Grey card #8 |
| | | instead of the original $1,000,000 the first time | face from the pile of |
| | | around. This time however, the bank agrees to a | cards and place it face |
| | | 95% loan to value, wherein the loan amount is only | down on the right of the |
| | | $950,000 and the collateral offered the bank is | board game (since it is |
| | | $1,000,000 payable in ten years. | not immediately |
| | | Take from the pile of cards, grey cards 8 | available) |
| | | and 9 representing cash amounts of | 3. Collect Grey card #9 |
| | | $501,420 and $448,580 that total | ($501,420) from the |
| | | $950,000. | pile of cards and place |
| | | In this transaction, the loan from Bank B is | it in box A1 - face up. |
| | | fully secured both by a promissory note of | |
| | | bank A (now pledged as security) and by a | |
| | | sinking fund deposit (card #8) by depositing | |
| | | in the account the present value of all | |
| | | future interest payments discounted at a | |
| | | yield of 5.99% p.a. This means that the | |
| | | deposit today of $448,580 earning interest | |
| | | of 5.99% per annum will be sufficient to | |
| | | make all ten interest payment of $65,000, | |
| | | when due, over the next 10 years. | |
| | 4 | Customer 1 lends $554,214 to Bank A for ten | 1. Remove Grey cards |
| | | years by purchasing a zero coupon “Note” (or | #9 + #3B (=$554,214) |
| | | certificate of deposit) issued by Bank A.. Assuming | from box A1 and place |
| | | the bank agrees to pay a 5.99% yield to maturity, | them face down on the |
| | | the amount tendered on day 1 = $554,214, | left side of the board |
| | | wherein the bank agrees to pay $1,000,000 (the | game (this money now |
| | | face value of the note) at maturity (cost: 55.4214% | belongs to Bank A |
| | | of face). | since it issued a |
| | | | “Promissory Note”). |
| | | | 2. Collect Grey card |
| | | | #10 from the pile of |
| | | | cards and deposit it in |
| | | | box B1. |
| Cycle 3 | 5 | Customer 1 borrows $1,000,000 from Bank B for | 1. Deposit Promissory |
| (Partial) | | 10 years at an interest rate of 6.75% per annum. | Note #11 in box B1 |
| | | This bank agrees to a 95% loan to value, wherein | (face up). |
| | | the loan amount is only $950,000 and the | 2. Collect Grey card |
| | | collateral offered the bank is $1,000,000 payable | #12 ($448,580) face |
| | | in ten years. | from the pile of cards |
| | | In this transaction, the loan is fully secured | and place it face down |
| | | both by a promissory note of bank A (now | on the right of the |
| | | pledged as security) and by a sinking fund | board game (since it is |
| | | deposit (card #8) by depositing in the | not immediately |
| | | account the present value of all future | available.) |
| | | interest payments discounted at a yield of | 3. Collect Grey card |
| | | 5.99% p.a. This means that the deposit | #13 ($501,420) from |
| | | today of $448,580 earning interest of | the pile of cards and |
| | | 5.99% per annum will be sufficient to make | place it in box A1 - |
| | | all ten interest payment of $65,000, when | face up. |
| | | due, over the next 10 years. | |

### MOVES FOR CUSTOMER 2 (Black Pieces)

### BORROWS & REINVESTS THE PROCEEDS:

| | | | |
|---|---|---|---|
| Pre-Cycle | 1 | Deposit $1,000,000 in Bank A (box A2) | Place Black card #1 |
| | | | face up in Box B1. |
| | 2 | Deposit 3 checks totaling $657,264 in Bank B (box | Place Black pieces #2, |
| | | A1). | #3A, and #3b face up |
| | | | in box A1. |
| Cycle 1 | 3 | Customer 1 borrows $1,000,000 from Bank A for | 1. Deposit Promissory |
| | | 10 years at an interest rate of 6.75% per annum: | Note #3 in box B1 (face |
| | | Take from the pile of cards, cards 4 and 5 | up). |
| | | representing cash amounts of $502,958 | 2. Collect Black card |
| | | and $497,042 that total $1,000,000. | #4 face from the pile of |
| | | In this transaction, the loan from Bank A is | cards and place it face |
| | | fully secured both by a cash deposit of | down on the right of the |
| | | $1,000,000 (now blocked in the account by | board game (since it is |
| | | Bank A) and by a new sinking fund account | not immediately |
| | | created (card #4) by depositing in the | available) |
| | | account the present value of all future | 3. Collect Black card |
| | | interest payments discounted at a yield of | #5 ($502,958) from the |
| | | 5.99% p.a. This means that the deposit | pile of cards and place |
| | | today of $497,042 that earns interest of | it in box A1 - face up. |
| | | 5.99% per annum will be sufficient to make | |
| | | all ten interest payment of $65,000 when | |
| | | due over the next 10 years. | |
| | | IMPORTANT NOTE: It is assumed in this | |
| | | demonstration that in all loan agreements between | |
| | | the bank and its borrowing customer, there is a | |
| | | clause that permits: (a) the early repayment of | |
| | | loans without penalty, and (b) there is a right of | |
| | | offset, which means that both the bank and its | |
| | | customer can write off matching assets and | |
| | | liabilities (e.g. the bank can apply cash in the | |
| | | customer's account to the payment of debts to the | |
| | | bank). | |
| | 4 | Customer 1 lends $554,214 to Bank B for ten | 1. Remove piece #3A |
| | | years by purchasing a zero coupon “Note” (or | from box A1 and place |
| | | certificate of deposit) issued by Bank B.. Assuming | it face down on the left |
| | | the Bank B agrees to pay a 5.99% yield to | side of the board game |
| | | maturity, the amount tendered on day 1 = | (this money now |
| | | $554,214, wherein the Bank B agrees to pay | belongs to Bank B |
| | | $1,000,000 (the face value of the note) at maturity | since they gave you a |
| | | (cost: 55.4214% of face). | “Promissory Note”. |
| | | | 2. Collect Black card |
| | | | #6 from the pile of |
| | | | cards and deposit it in |
| | | | box B1. |
| Cycle 2 | 5 | Customer 1 borrows $1,000,000 from Bank A for | 1. Deposit Promissory |
| | | 10 years at an interest rate of 6.75% per annum. | Note #7 in box B1 (face |
| | | This time however, Customer wishes to pledge a | up). |
| | | ten year Note of Bank B as collateral for the loan | 2. Collect Black card |
| | | instead of the original $1,000,000 the first time | #8 face from the pile of |
| | | around. This time however, the Bank B agrees to | cards and place it face |
| | | a 95% loan to value, wherein the loan amount is | down on the right of the |
| | | only $950,000 and the collateral offered the bank | board game (since it is |
| | | is $1,000,000 payable in ten years. | not immediately |
| | | Take from the pile of cards, Black cards 8 | available.) |
| | | and 9 representing cash amounts of | 3. Collect Black card |
| | | $501,420 and $448,580 that total | #9 ($501,420) from the |
| | | $950,000. | pile of cards and place |
| | | In this transaction, the loan from Bank A is | it in box A1 - face up. |
| | | fully secured both by a promissory note of | |
| | | Bank B (now pledged as security) and by a | |
| | | sinking fund deposit (card #8) by depositing | |
| | | in the account the present value of all | |
| | | future interest payments discounted at a | |
| | | yield of 5.99% p.a. This means that the | |
| | | deposit today of $448,580 earning interest | |
| | | of 5.99% per annum will be sufficient to | |
| | | make all ten interest payment of $65,000, | |
| | | when due, over the next 10 years. | |
| | 6 | Customer 1 lends $554,214 to Bank B for ten | 1. Remove Black cards |
| | | years by purchasing a zero coupon “Note” (or | #9 + #3B (=$554,214) |
| | | certificate of deposit) issued by Bank B.. Assuming | from box A1 and place |
| | | the Bank B agrees to pay a 5.99% yield to | them face down on the |
| | | maturity, the amount tendered on day 1 = | left side of the board |
| | | $554,214, wherein the Bank B agrees to pay | game (this money now |
| | | $1,000,000 (the face value of the note) at maturity | belongs to Bank B |
| | | (cost: 55.4214% of face). | since they issued a |
| | | | “Promissory Note”). |
| | | | 2. Collect Black card |
| | | | #10 from the pile of |
| | | | cards and deposit it in |
| | | | box B1. |
| Cycle 3 | 7 | Customer 1 borrows $1,000,000 from Bank A for | 1. Deposit Promissory |
| (Partial) | | 10 years at an interest rate of 6.75% per annum. | Note #11 in box B1 |
| | | This Bank B agrees to a 95% loan to value, | (face up). |
| | | wherein the loan amount is only $950,000 and the | 2. Collect Black card |
| | | collateral offered the bank is $1,000,000 payable | #12 ($448,580) face |
| | | in ten years. | from the pile of cards |
| | | In this transaction, the loan is fully secured | and place it face down |
| | | both by a promissory note of Bank B (now | on the right of the |
| | | pledged as security) and by a sinking fund | board game (since it is |
| | | deposit (card #8) by depositing in the | not immediately |
| | | account the present value of all future | available.) |
| | | interest payments discounted at a yield of | 3. Collect Black card |
| | | 5.99% p.a. This means that the deposit | #13 ($501,420) from |
| | | today of $448,580 earning interest of | the pile of cards and |
| | | 5.99% per annum will be sufficient to make | place it in box A1 - |
| | | all ten interest payment of $65,000, when | face up. |
| | | due, over the next 10 years. | |

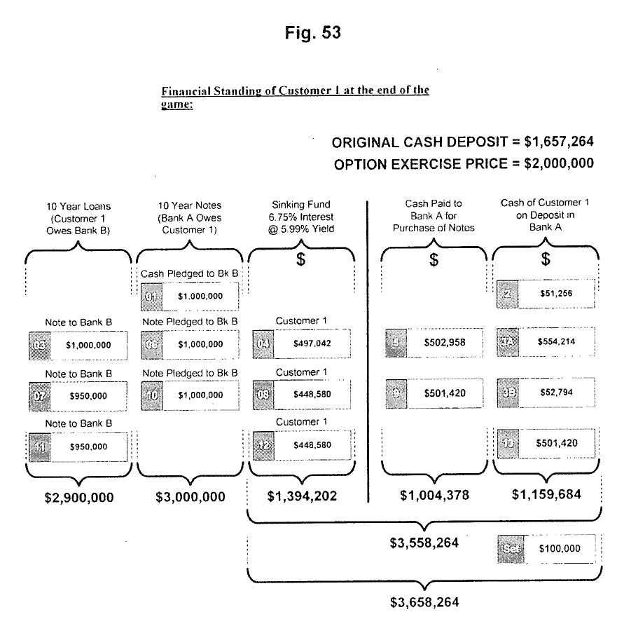

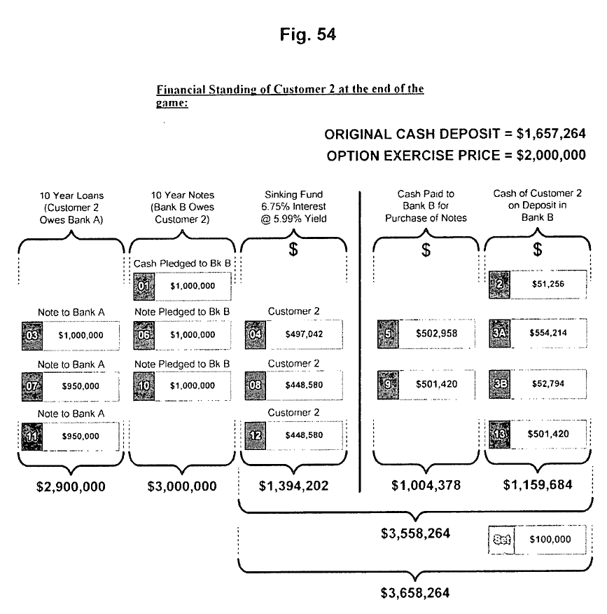

If these instructions are followed properly, the final results will be those, noted herein [Refer to FIG. 53 for the financial standing of Customer 1 and Refer to FIG. 54 for the financial standing of Customer 2] at the end.

What is interesting to observe is that all borrowings were fully securitized, principal and interest, meaning that the loan transactions were fully defeased, yet there is a total cash balance on the table of $7,116,528 after starting with a total cash outlay of $3,314,528 from Customers 1 and 2. The key observation from this demonstration is that money is actually created when promissory notes are issued in favor of a bank (grey and black pieces #3, #7, #11). In this demonstration, $3,802,000 was created strictly from the way the transaction was engineered and structured.

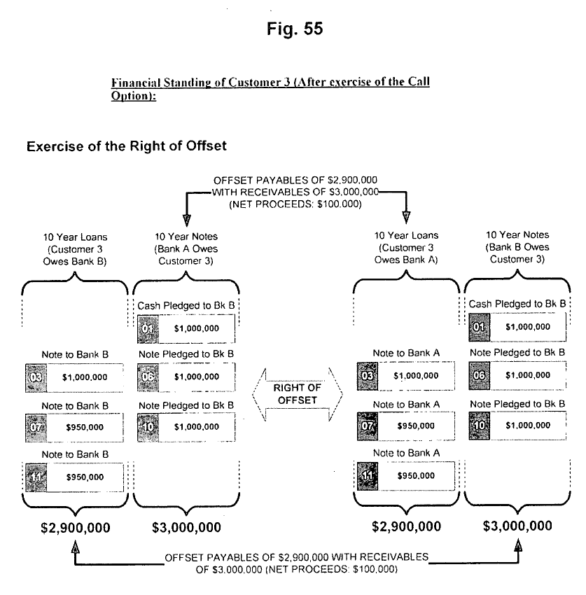

Following the exercise of the call option, by the Option Holder, (let's call him “Customer 3” henceforth) becomes the owner of all assets and liabilities that belong to Customers 1 and 2. Having paid $2,000,000 each to Customers #1 and #2, Customer #3 can now offset the assets and liabilities under the right of offset. As noted below, Customer #3 now owes each bank $2,900,000, but is owed by the two banks $3,000,000 each. Since both assets and liabilities are for 10 years and the conditions of the loan allow for both an early repayment without penalty and the right of offset [Refer to FIG. 55], this means that the assets and liabilities of Customer 3 and those of the two banks can be extinguished in exchange for payment of $100,000 each to Customer 3, wherein assets and liabilities=0 on both sides.

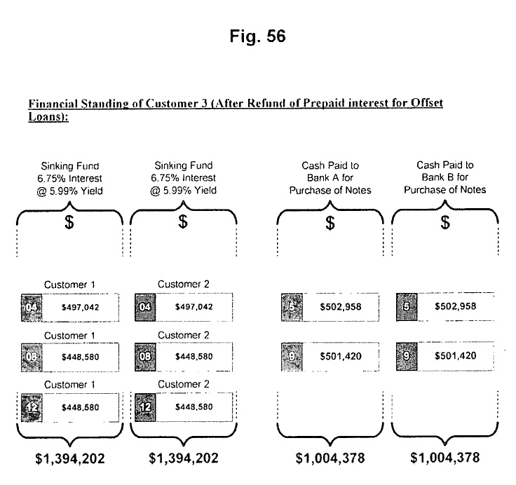

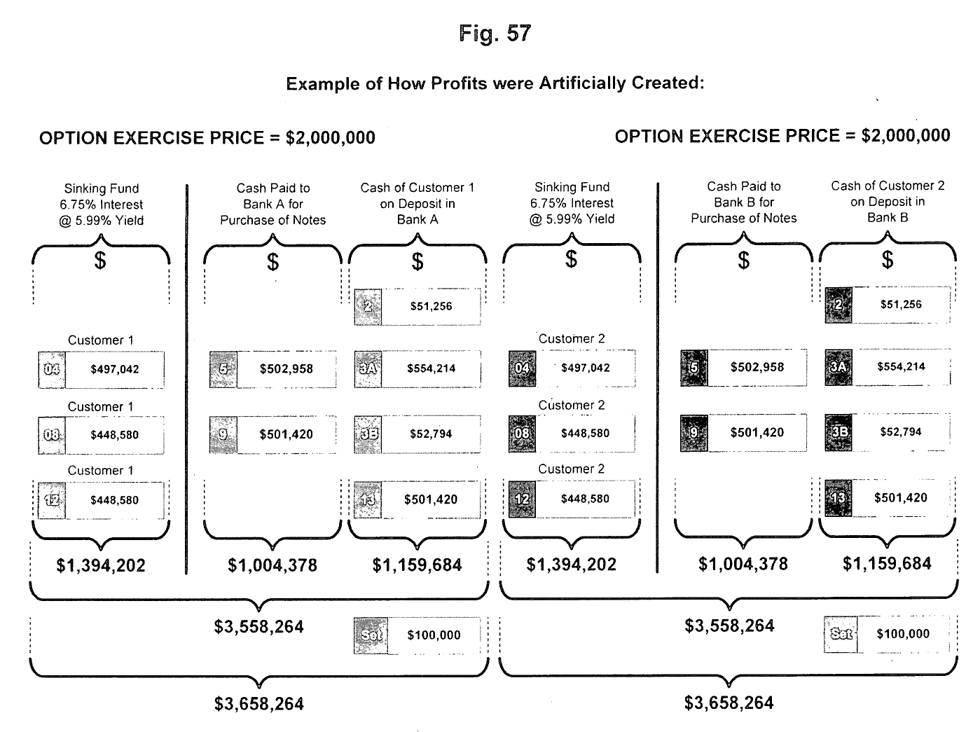

Additionally, since all interest payments for the next ten years were prepaid, and Customer #3 has no further liability to either bank, Customer #3 has the right to request that both bank A and bank B return prepaid interest amounting to a total of $2,788,404 [Refer to FIG. 56]. Similarly, both banks had liabilities of $3,000,000 each for which they had received payments of $1,004,378 each. Since their respective liabilities to Customer #3 have been extinguished through the offset, standard accounting practices leaves no other choice but to book the original revenue as a pure profit to the bank. Assuming that the bank is publicly traded and has a P/E of 15:1, this means that the bank will have just booked $15,065,670 of net additional market capitalization.

In this example each of the two banks used their own liquidity to make loans totaling $2,900,000. In that $1,657,264 were cash deposits made by Customers 1 & 2, no new money way actually created for that portion, thus leaving pure money creation at $1,900,000 each ($3,8000,000 in total). Since we have demonstrated that the two banks made a combined profit of $2,008,756, this leaves the banks with a combined cash flow shortfall of $1,791,240.

In the accounting summary that follows, we show Customer #3 having paid $4,000,000 to acquire the two portfolios and walking out of the transaction with a total of $7,316,528, having made a $3,3,16,528 profit in the process. Assuming that Customer #3 agrees to replenish the cash flow shortfall of the two banks through the purchase ten year zero coupon notes having a cost of $1,791,240, this means the banks will issue new notes totaling face values of $3,232,043 (assuming a 5.99% yield to maturity) which cannot be redeemed prior to maturity. This means that the banks will have made aggregated profits of $2,008,756 in addition to having regained liquidity shortfall of $1,791,240.

### Observations:

1. Each of Customers #1 and #2 made a profit of $342,736 ($2,000,000 less $1,657,264 each). Additionally each of Bank A and Bank B made a pure profit of $1,004,378 while Customer #3 (the option holder) made a pure profit of $3,316,528. Notice that all parties in the transaction made a profit despite the fact that all the loan transactions were fully defeased, principal and interest and involved little or no risk for the banks?

2. Few people can grasp the implications of this game simulation, for very few understand how money is created and distributed. What the present embodiment of this invention demonstrates is that the issuance of notes give rise to money creation as was explained in the background of this invention.

3. In this demonstration only 2½ full cycles produced the above results. As an example if the same 10:1 leverage is applied as do the banks (e.g. in the United States) through the fractional reserve banking process and 10 full cycles of the card game is completed (assuming the exact same yield to maturities, interest rates and loan to value), the following results will be obtained at the end of the game:

### After 10 Full Borrowing and Re-Lending Cycles:

Customer #1, #2 and #3 combined:

| | | |
|---|---|---|
| | Starting balance | $3,314,528 |
| | Ending Balance | $11,338,684 |
| Bank A | Short-term liquidity Loss | ($5,012,078) |
| | Profits resulting from Offset | $4,987,922 |
| | (Market Cap @15 × P/E = $74,818,833) | |
| Bank B | Short-term liquidity Loss | ($5,012,078) |
| | Profits resulting from Offset | $4,987,922 |
| | (Market Cap @15 × P/E = $74,818,833) | |

Assuming Customers #1, #2 and #3 reinvest their profits by acquiring ten year zero coupon notes from Banks A and B, this means the following addition income for the banks:

| | | |
|---|---|---|
| Bank A | Note sales Proceeds (Cash) | $4,012,078 |
| | Ten Year Liability | $7,239,221 |
| Bank B | Note sales Proceeds (Cash) | $4,012,078 |
| | Ten Year Liability | $7,239,221 |

The invention may also be understood by referring to the following sets of numbered paragraphs, with each set describing other embodiments of the invention:

### Second Embodiment

1. A method of providing an alternative international fiduciary financial system that manages investments and risks associated with the transfer of funds between different parties while enabling non-banking entities to provide traditional banking services without violating national and international banking laws, comprising:

providing plural unit participation trusts and equipping each with a trust corpus and terms and conditions defined in a corresponding trust agreement that forms a trust, and with sub-trust accounts of the trust;

connecting each sub-trust account to a corresponding bank account and connecting each corresponding bank account to corresponding check writing facilities and debit cards;

supplying a holder for each sub-trust account;

configuring each unit participation trust as a unit of ownership of the trust; and

selecting a trust beneficiary for each unit participation trust, and constructing at least one unit participation trust and choosing plural service providers to the trust and a non-bank promoter of the trust.

### Third Embodiment

1. A currency converter-indexer for an alternative international fiduciary financial system that involves an exchange, a trading account, a trust sub-account, and assets chosen from the group comprising currencies, traded commodities, real equities, and all items that have a commercial value, comprising:

a currency-converting mechanism that converts all assets into transaction units for use in financial transactions done on the exchange; and

a currency-indexing mechanism that enables any asset to be automatically converted into transaction units.

2. The converter-indexer of paragraph 1, wherein the transaction units are constructed to derive value from the underlying Asset.

3. The converter-indexer of paragraph 1, wherein the transaction units are constructed as standardized global units of trade that are tradable on the exchange and usable to create and trade in financial products chosen from the group comprising trust preferred notes trust-secured loans, repo reverse-repo financing.

4. The converter-indexer of paragraph 3, wherein the transaction units are constructed for denominating the financial products, thereby allowing the financial products to hedge risk associated with interest rate increases.

5. The converter-indexer of paragraph 1, wherein the currency-indexing system includes an index constructed to relate to every other currency of the world.

6. The converter-indexer of paragraph 5, wherein the index is constructed to make a transaction-unit equivalent for each currency of the world at pre-selected intervals.

7. The converter-indexer of paragraph 5, wherein the index is constructed to make a transaction-unit equivalent for any commodity at pre-selected intervals.

8. The converter-indexer of paragraph 5, wherein the index is constructed to make a transaction-unit equivalent for any item of commerce at pre-selected intervals so that trading in the item can take place through the trading of transaction-unit-denominated financial products on the exchange.

9. The converter-indexer of paragraph 5, wherein the index is constructed with a baseline.

10. The converter-indexer of paragraph 5, wherein the index is constructed to track the value of each asset relative to other assets via changes in the exchange rate of each asset relative to the index.

11. The converter-indexer of paragraph 1, further including a crediting subsystem for crediting a trading account with transaction units equal to the corresponding value of local currency deposits in the trust sub-account.

### Fourth Embodiment

1. A bid-and-ask assistant for an alternative international fiduciary financial system that is usable by a trade-account holder to trade electronically on an exchange that has an electronic trading floor by making trade orders according to a bidding strategy, and wherein trustees are associated with the exchange, comprising:

a communicator constructed to connect to the trade-account holder's trade account and to the exchange;

a bid-and-ask calculator-receiver-processor constructed to receive bid-and-ask data from the exchange, and to be usable by the trade-account holder via the communicator to change the bidding strategy by performing calculations;

a bid-and-ask processor-transmitter that is constructed to transmit trade orders to the exchange;

a preference-setting mechanism that is constructed to allow a trade-account holder to establish custom, pre-set trading preferences; and

a proxy-trading mechanism that is constructed to transfer trading authority from the trade-account holder to a trustee who can place bids of the trade-account holder in such a way to allow for automatic preparation and processing and subsequent submission to the electronic trading floor of the exchange, thereby to create a trade that is binding on the account holder.

2. The bid-and-ask assistant of paragraph 1, wherein the bid-and-ask calculator-receiver-processor is constructed so that a new trade order can be made and communicated to the electronic trading floor of the exchange.

3. The bid-and-ask assistant of paragraph 1, wherein the trade-account holder has a trust sub-account and the system further includes a suspense-escrow account, and wherein the bid-and-ask calculator-receiver-processor is constructed to simultaneously debit the trust sub-account when a trade order is made, and to move the total associated with the trade order to the suspense-escrow account to guarantee execution of the trade in the event the trade order is accepted.

4. The bid-and-ask assistant of paragraph 1, wherein the bid-and-ask calculator-receiver-processor is constructed to allow the trade-account holder to make changes to a previous trade order and to resubmit it to the electronic trading floor of the exchange.

5. The bid-and-ask assistant of paragraph 1, wherein the bid-and-ask calculator-receiver-processor is constructed to allow for the trade-account holder to make strategic decisions based upon input received from the trading floor that may increase trading profitability.

6. The bid-and-ask assistant of paragraph 1, wherein the bid-and-ask calculator-receiver-processor is constructed to allow for to be stored with account information of the trade-account holder.

7. The bid-and-ask assistant of paragraph 1, wherein the bid-and-ask calculator-receiver-processor is constructed to allow for an increased possibility that a bid or ask will be matched on the exchange.

8. The bid-and-ask assistant of paragraph 1, wherein the bid-and-ask processor-transmitter is constructed so that when a trade order is submitted automatically, the transmission of the trade order automatically causes the trust sub-account to be debited for the amount of the trade order and moves that debited amount to a suspense-escrow account to guarantee execution of the trade if accepted.

9. The bid-and-ask assistant of paragraph 1, wherein the preference-setting mechanism is constructed to select at least one currency that can be converted into a transaction unit.

10. The bid-and-ask assistant of paragraph 1, wherein the preference-setting mechanism is constructed to provide a method of guaranteeing performance execution associated with trade orders submitted to the exchange.

11. The bid-and-ask assistant of paragraph 1, wherein the preference-setting mechanism is constructed to provide a method of structuring and managing different trading strategies.

12. The bid-and-ask assistant of paragraph 1, wherein the preference-setting mechanism is constructed to provide a method of establishing upper and lower limits for trade orders.

13. The bid-and-ask assistant of paragraph 1, wherein the preference-setting mechanism is constructed to provide methods of changing preferences on the fly.

14. The bid-and-ask assistant of paragraph 1, wherein the preference-setting mechanism is constructed to provide a method of changing any underlying currency that supports the issuance of transaction units tradable on the exchange.

15. The bid-and-ask assistant of paragraph 1, wherein the preference-setting mechanism is constructed to provide a method of designing and managing currency-specific strategies for each currency underlying the issuance of tradable transaction units.

16. The bid-and-ask assistant of paragraph 1, wherein the preference-setting mechanism is constructed to provide a method of managing the trading account, and recording, calculating and allocating trading profits.

17. The bid-and-ask assistant of paragraph 1, wherein the preference-setting mechanism is constructed to provide a method of designing and submitting pre-approved recurring trade orders to the exchange at pre-selected times.

18. The bid-and-ask assistant of paragraph 1, wherein the preference-setting mechanism is constructed to provide a method of allowing the designing and submitting pre-approved recurring orders to the exchange at pre-established intervals or upon the occurrence of pre-defined events.

19. The bid-and-ask assistant of paragraph 1, wherein the proxy-trading mechanism is constructed to provide a method of advising the trade-account account holder via the communicator each time a trade order is submitted by the exchange on behalf of the trade-account holder and each time a profit is earned on behalf of the trade-account holder.

20. The bid-and-ask assistant of paragraph 1, wherein the proxy-trading mechanism is constructed to provide a method of automatically debiting and crediting the trust sub-account of the trade-account holder for binding trade orders processed by the exchange for the trade-account holder.

21. The bid-and-ask assistant of paragraph 1, wherein the proxy-trading mechanism is constructed to provide a method of maximizing trading profits for the trade-account holder by establishing upper and lower tolerance limits for bid or ask trade orders.

22. The bid-and-ask assistant of paragraph 1, wherein the proxy-trading mechanism is constructed to provide a method of delegating authority to the exchange to allow for making and automatically submitting a trade order that creates a link for the completion of a full-cycle arbitrage transaction in which all participants earn a pre-determined profit.

23. The bid-and-ask assistant of paragraph 1, wherein the proxy-trading mechanism is constructed to provide a method of crediting trading profits to the account of the account holder.

24. The bid-and-ask assistant of paragraph 1, wherein the proxy-trading mechanism is constructed to provide a method of sharing profits between the exchange and the account holder.

### Fifth Embodiment

1. A centralized escrow system for an alternative international fiduciary financial system that involves trade orders submitted on behalf of trade-account holders to an exchange that includes an electronic trading floor, and bids and asks that are components of full-cycle trade transactions, comprising:

an internal trust-managed escrow-account mechanism that guarantees the settlement of all trade orders submitted to the exchange in the event a bid or ask is accepted as a component required to complete a full-cycle arbitrage trade transaction.

2. The escrow system of paragraph 1, wherein the escrow-account mechanism includes an escrow account that is constructed to function as a temporary-suspense-account capable of receiving credits equal to the estimated settlement of a trade in the event the trade is accepted, and capable of receiving an offsetting debit in the event the trade is refused.

3. The escrow system of paragraph 2, wherein the escrow-account mechanism is constructed to hold a deposited amount for the entire life of a trade order, until that trade order is handled by the exchange.

4. The escrow system of paragraph 2, wherein the escrow-account mechanism is constructed to use the deposited amount to secure a new trade order that cancels and replaces a previous trade order.

5. The escrow system of paragraph 2, wherein the escrow-account mechanism is constructed to allow the deposited amount to be invested via the exchange in pre-approved principal-protected trades.

6. The escrow system of paragraph 2, wherein the escrow-account mechanism is constructed to allow the deposited amount to be invested in pre-approved overnight investments that earn revenue for the trade-account holder.

7. The escrow system of paragraph 1, wherein the escrow-account mechanism is constructed to respond to the submission of a trade order to the electronic floor of the exchange by automatically deducting a projected settlement amount of a trade and the automatically depositing that amount to an escrow-suspense account.

8. The escrow system of paragraph 7, wherein the escrow-account mechanism is constructed to guarantee execution of a trade on the exchange if the trade is accepted.

9. The escrow system of paragraph 7, wherein the escrow-account mechanism is constructed to release a trade order to the electronic trading floor of the exchange to allow the electronic trading floor to receive and process the order.

10. The escrow system of paragraph 7, wherein the escrow-account mechanism includes a digital-time-stamper and is constructed to direct the digital-time-stamper automatically to associate a digital time stamp with a trade order, as a way of ensuring the trade order is processed in the order it is received.

11. The escrow system of paragraph 1, wherein the escrow-account mechanism is constructed to respond to the rejection or cancellation of a trade order by the trade-account holder or the electronic trading floor of the exchange by automatically deducting from the escrow amount an amount corresponding to the rejected trade and by automatically crediting the same amount to the trading account of the unsuccessful bidder.

12. The escrow system of paragraph 11, wherein the escrow-account mechanism is constructed to respond to the rejection or cancellation of a trade order by automatically terminated it, causing the escrow manager to be released from any liability.

13. The escrow system of paragraph 11, wherein the escrow-account mechanism includes a digital-time-stamper and is constructed to direct the digital-time-stamper automatically to associate a digital time stamp with a canceled trade order.

### Sixth Embodiment

1. A switch for use in an alternative international fiduciary financial system that involves trust accounts, trust sub-accounts and trade accounts, comprising:

a switch mechanism constructed to connect automatically a trust sub-account to a trading account.

2. The switch of paragraph 1, wherein the switch mechanism is also constructed to connect automatically a trade account to an escrow-suspense account for guaranteeing the settlement of trade orders submitted to the electronic trading floor of the exchange.

3. The switch of paragraph 1, wherein the switch mechanism is also constructed to connect automatically a trust sub-account to a net-zero balance bank account.

4. The switch of paragraph 1, wherein the switch mechanism is also constructed to connect automatically to the trust sub-account at least one other account chosen from the group comprising a securities account, a savings account, a loan account, and an investment account.

5. The switch of paragraph 1, wherein the switch mechanism is also constructed automatically to pass debits and credits between accounts of the same account holder.

6. The switch of paragraph 5, wherein the switch mechanism is constructed automatically to cause a debit and a credit to be posted to both the trust sub-account and the trade account of the same account holder.

7. The switch of paragraph 5, wherein the switch mechanism is constructed automatically to cause a debit and a credit to be posted to both the trade account and the corresponding escrow-suspense account of the same account holder.

8. The switch of paragraph 5, wherein the switch mechanism is constructed automatically to post a debit in a particular local currency to a trust sub-account and post a corresponding credit in that same currency to a debit-card-settlement account, followed by posting a simultaneous offsetting debit and credit to the associated net-zero bank account.

9. The switch of paragraph 5, wherein the switch mechanism is constructed automatically to post a debit to the trust sub-account in a particular local currency and post a corresponding credit in transaction units to the corresponding trade account based upon the prevailing exchange rate of transaction units for that particular currency at the time the debit and credit are posted.

10. The switch of paragraph 5, wherein the switch mechanism is constructed automatically to perform a debit-credit process when a trade order is submitted, with the switch mechanism posting a debit to the trust sub-account in a particular local currency and posting a corresponding credit in transaction units to the corresponding escrow-suspense account based upon the prevailing exchange rate of transaction units for that particular currency at the time the debit and credit are posted.

11. The switch of paragraph 10, wherein the switch mechanism is constructed automatically to reverse the debit-credit process recited in G10 in the event the corresponding trade order is stopped.

### Seventh Embodiment

1. An ask-and-bid engine for use in an alternative international fiduciary financial system, comprising:

an ask-and-bid receiver-transmitter constructed to receive and transmit trade orders;

an ask-and-bid processor constructed to process trade orders that are guaranteed by an escrow-suspense-account deposit.

2. The engine of 1, wherein the receiver-transmitter and the processor are each constructed to handle a trade order that contains a minimum desired transaction profit expressed by the group comprising an annualized return on investment, and a pre-set anticipated return expressed in transaction units.

3. The engine of paragraph 2, wherein the processor is constructed to categorize and sort trade orders.

4. The engine of paragraph 3, wherein the processor is constructed to categorize and sort trade orders into retail bins numbers [1R, 2R, 3R, 4, 5R, 6R, 7R] and wholesale-institutional bin numbers [3W, 5W, 6W and 7W].

5. The engine of paragraph 4, wherein each bin is constructed to aggregate like-kind trade orders.

6. The engine of paragraph 1, wherein the processor is constructed to process trade orders chosen from the group comprising (i) a bid to provide a short-term loan for the leveraged purchase of a transaction-unit-(TU-)denominated trust-preferred note, (ii) an offer to buy a TU-denominated, cash-secured trust-preferred note, (iii) a bid to provide a repo loan by repurchasing a TU-denominated trust-preferred note, (iv) an offer to sell a hedge at a pre-set rate expressed as a number of basis points relative to the face value of the corresponding financial instrument or as a pre-set desired profit amount in TUs, (v) an offer to swap a TU-denominated trust-preferred note secured by an underlying cash deposit in a first currency with another similar financial instrument secured by an underlying cash deposit in a second currency that is different from the first currency, (vi) an offer to swap a cash-flow stream from a series of future variable-interest-rate payments due on a TU-denominated trust-secured loan secured by trust deposits in a particular currency for a cash-flow stream from a series of future fixed-interest-rate payments earned periodically on a cash-secured TU-denominated trust-preferred note.

7. The engine of paragraph 1, wherein processor is constructed to determine whether a trade order meets pre-selected conditions and is appropriate for submitting to the electronic trading floor of the exchange.

8. The engine of paragraph 7, wherein the processor is constructed to submit trade orders that meet the pre-selected conditions by delivery of the order to the floor of the exchange with a time stamp indicating the day and time of delivery; a notification to the order giver that the order was submitted and the time stamp details of the transmission.

### Eighth Embodiment

1. A financial-arbitrage engine for use in an alternative international fiduciary financial system, comprising:

an ask-and-bid processor-aggregator;

an ask-and-bid matcher for profit maximization;

an automated financial-product creator of customizable financial products;

an arbitrage builder/transaction assembler; and

a mechanism for simultaneous transaction closing, profit calculation and distribution.

2. The engine of paragraph 1, wherein the ask-and-bid processor-aggregator is constructed to process each trade order by converting the corresponding trade order into an actual cost to the arbitrage transaction.

3. The engine of paragraph 1, wherein the ask-and-bid processor-aggregator is constructed to process each trade order by converting a yield-to-maturity associated with the corresponding trade order into a price related to the face value of a note associated with the trade order.

4. The engine of paragraph 3, wherein the ask-and-bid processor-aggregator is constructed to process further each trade order by calculating a net cost of a security associated with the trade order and using the calculated net cost as a projected settlement amount if the trade order is accepted without changes.

5. The engine of paragraph 3, wherein the ask-and-bid processor-aggregator is constructed to process further each trade order that is submitted for an investment product that includes associated investment coupons by using information associated with the trade order, by converting associated future interest payments into a corresponding present value and aggregating that value according to pre-selected rules and using the aggregated value as the amount necessary to be deposited in escrow in the event a full defeasement of interest and principal is required in a collateralization process associated with implementing the trade order.

6. The engine of paragraph 3, wherein the ask-and-bid processor-aggregator is constructed to process further each trade order that is submitted for a loan by using information associated with the trade order to convert an associated interest rate into an interest cost, and by calculating the net cost of the loan using the converted interest cost.

7. The engine of paragraph 3, wherein the ask-and-bid processor-aggregator is constructed to process further each trade order that is submitted for a loan, by using information associated with the trade order to convert cash flow from each future interest payment into a corresponding present value, by aggregating that value according to pre-selected rules, and by having the aggregated value available for a future swap calculation.

8. The engine of paragraph 3, wherein the ask-and-bid processor-aggregator is constructed to process further each trade order that is submitted for a hedge product that provides a non-recourse exit from a repurchase agreement, by converting basis points associated with the trade order into a total cost of the transaction expressed in transaction units.

9. The engine of paragraph 1, wherein the ask-and-bid processor-aggregator is constructed to process each trade order by categorizing it, placing it in a bin based upon its categorization, and sorting it in the corresponding bin with other trade orders according to a first method by ordering the trade orders from highest to lowest in terms of revenue or cost to the arbitrage process, and according to a second method by time stamping each trade order so that trade orders of equal value are capable of being prioritized and selected based upon whether a trade order has an earlier associated time stamp.

10. The engine of paragraph 1, wherein the ask-and-bid matcher includes bins in which to sort categorized trade orders, with each bin constructed to store plural trade orders in a queue until each one is handled by the group comprising being accepted, being changed or being canceled.

11. The engine of paragraph 10, wherein each bin is constructed to identify that a trade order is a revolving bid.

12. The engine of paragraph 11, wherein each bin is constructed to resubmit automatically a revolving bid after it has been accepted and an associated transaction is closed.

13. The engine of paragraph 12, wherein the ask-and-bid matcher includes bins in which to sort categorized trade orders, and includes a scanner for scanning bins at pre-selected times to allow financial products associated with trade orders to be selected according to pre-selected rules related to transaction profitability.

14. The engine of paragraph 13, wherein the ask-and-bid matcher is constructed to determine when all arbitrage profit conditions are met, to select and aggregate a corresponding financial product associated with a trade order in a bin, to deliver the financial product to the transaction assembler and closing process, and to confirm simultaneously, with the delivery of the financial product, acceptance of the trade order to the holder of the trade order.

15. The engine of paragraph 14, wherein the ask-and-bid matcher is constructed to use as a source for tail-end liquidity, one from the group comprising a matched-trade-closing determination and a hedged-repo-sale determination.

16. The engine of paragraph 15, wherein the bins are numbered in at least three, with a first series being denoted by the symbol R and a second series being denoted by the symbol W, and wherein there are at least seven bins for each series so that the bins in the first series are 1R-7R, and the bins in the second series are 1W-7W, and a third series being denoted by the word “swap” and the bin in the third series is denoted swap bin.

17. The engine of paragraph 16, wherein the matched-trade-exit determination is made according to the following calculation: 2R+1R+(3R or 3W), 4R, (7R or 7W).

18. The engine of paragraph 17, wherein the hedged-repo-sale determination is made according to the following calculation: 2R+1R+(3R or 3W), 4R, (5R or 5W), (6R or 6W).

19. The engine of paragraph 18, wherein the ask-and-bid matcher is constructed to use the financial product associated with a trade order in bin 2R that is the highest yield-to-maturity offered at a desired time.

20. The engine of paragraph 19, wherein the ask-and-bid matcher is constructed to use the financial product associated with a trade order in bin 1R is the lowest yield-to-maturity offered at the desired time even though the bid price of trade orders in bin 2R may be higher than the lowest bid of trade orders in bin 1R.

21. The engine of paragraph 20, wherein the ask-and-bid matcher is constructed to use the financial product associated with a trade order chosen from the group comprising bin 3R and 3W that offers the lowest interest cost of refinancing at the desired time.

22. The engine of paragraph 21, wherein the ask-and-bid matcher is constructed to use the financial product associated with a trade order in bin 4R that is the lowest yield-to-maturity offered at the desired time.

23. The engine of paragraph 22, wherein the ask-and-bid matcher is constructed to use the financial product associated with a trade order chosen from the group comprising bin 5R and 5W that offers the highest sales proceeds available at the desired time for a repo sale of the financial product with the lowest interest cost associated with a trade order in bin 1R.

24. The engine of paragraph 23, wherein the ask-and-bid matcher is constructed to use the hedge product selected from bin [6R] or [6W] offers the lowest cost of hedge expressed in TUs.

25. The engine of paragraph 24, wherein the ask-and-bid matcher is constructed to use the swap selected from the swap bin that meets the criteria chosen from the group comprising the most advantageous swap or swap rates and present-value cash flows for notes and interest rate.

26. The engine of paragraph 14, wherein the ask-and-bid matcher is constructed to remove from the queue, after a transaction closing, the corresponding trade orders that have been handled by the closing, and direct the scanner to select a next arbitrage for closing that meets pre-selected conditions.

27. The engine of paragraph 26, wherein the ask-and-bid matcher is constructed to repeat removing corresponding trade orders from the bins after a transaction closing and scanning to select a next arbitrage for closing that meets pre-selected conditions.

28. The engine of paragraph 27, wherein the ask-and-bid matcher is constructed to repeat the removing and scanning for as many times as there are bids in each bin which meet pre-selected conditions.

29. The engine of paragraph 28, wherein the pre-selected conditions include the condition that a closeable transaction makes a profit.

30. The engine of paragraph 28, wherein the ask-and-bid matcher is constructed to stop the removing and scanning when, at a particular point in time, the last closed transaction failed to meet pre-selected conditions.

31. The engine of paragraph 30, wherein the pre-selected conditions include the condition that a closeable transaction generates at least a minimum pre-selected level of profit.

32. The engine of claim paragraph 31, wherein the automated financial-product creator is constructed communicate with the ask-and-bid matcher, and to make a financial product that meets the conditions of a trade order sent to it by the ask-and-bid matcher.

33. The engine of claim paragraph 32, wherein the automated financial-product creator is constructed to receive from the ask-and-bid matcher selected trade orders in the form of bids from each of bins [2R+1R+(3R or 3W), 4R, (7R or 7W)] or [2R+1R+(3R or 3W), 4R, (5R or 5W); (6R or 6W)], and for each of the selected trade orders, to make a customized financial product that meets the conditions of each selected bid.

34. The engine of claim paragraph 33, wherein the automated financial-product creator is constructed to use the parameters of the bid originating from bins 1R and 2R to create electronically a trust preferred note wherein the issuer/seller of the note is the successful bidder from bin 1R and the buyer of the note is the successful bidder from bin 2R.

35. The engine of claim paragraph 34, wherein the automated financial-product creator is constructed to use the parameters of the bid originating from bins 3R or 3W to create electronically a leveraged intra-day loan, wherein the lender is the successful bidder in 3R or 3W and the borrower is the successful bidder from bin 2R.

36. The engine of claim paragraph 35, wherein the automated financial-product creator is constructed to use the parameters of the bid originating from bin 4R to create electronically an exit resale of the trust preferred note at a profit, wherein the seller and buyer are from the group comprising: (a) the seller is the successful bidder in bin 2R and the buyer is the then current lowest yield-to-maturity bidder in 2R; and (b) the seller is the successful bidder in bin 2R and the buyer is the successful bidder in bin 5R or 5W.

37. The engine of claim paragraph 36, wherein the automated financial-product creator is constructed to use the parameters of the bids originating from bin chosen from the group comprising (5R or 5W) and (5R or 5W) to calculate: (a) the optimum mark-to-market reserve set aside given the cost of the hedge in 5R or 5W; (b) the optimum liquidation trigger price at which the repo lender in 5R or 5W will be authorized to liquidate the trust-preferred note on a non-recourse basis to the repo seller; (c) the portion of the mark-to-market reserve that will be lost due to the cost of the hedge derived from the bid of bin 6R or 6W; and (d) the balance that remains as a profit at the transaction-closing process.

38. The engine of claim paragraph 37, wherein the automated financial-product creator is constructed to use the parameters of the bid originating from bin 6R or 6W to create electronically a trust-secured, cash-backed hedge, and wherein the seller and buyer are chosen from the group comprising: (a) the seller is the successful bidder in bin 2R and the buyer is the then current lowest yield-to-maturity bidder in 2R; and (b) the seller is the successful bidder in bin 2R and the buyer is the successful bidder in bin 5R or 5W.

39. The engine of claim paragraph 38, wherein the automated financial-product creator is constructed to require each successful bidder to accept, as a condition of opening an account on the exchange, a set of standard legal agreements that govern all transactions and financial products associated with the exchange, and wherein the adoption of the standard legal agreements by all participants provides a standardized legal framework that supports all trading activity that takes place on the exchange and protects all parties and counterparties in a particular transaction.

40. The engine of claim paragraph 39, wherein the financial products are chosen from the group comprising a note purchase agreement, a master loan agreement, a global master-securities-repurchase agreement, a non-recourse hedge-insurance agreement, an escrow agreement, a trust-indenture agreement, a master-security-pledge-and-assignment agreement, a novation agreement, an option agreement, a master-loan-repurchase agreement, an interest-rate-swap agreement and a currency-swap agreement.

41. The engine of paragraph 40, wherein the arbitrage builder/transaction assembler is configured to combine all cost elements of a desired transaction into a single settlement worksheet and calculate the resulting profits that can be derived from either one from the group comprising a matched-trade-closing transaction and a repo-closing transaction.

42. The engine of paragraph 41, wherein arbitrage builder/transaction assembler is configured to establish a market-to-market reserve set aside for a repo trade that is sufficient to cover: (a) a potential loss of value of the collateral up to a pre-determined stop-loss limit, and (b) the cost of buying a non-recourse hedge from a trade order in bin 6R or 6W that automatically triggers a liquidation of the collateral when a loss of value reaches a pre-established liquidation amount and a transaction profit resulting from the arbitrage of yields and interest rates.

43. The engine of paragraph 42, wherein the arbitrage builder/transaction assembler is configured to establish a pre-determined profit prior to closing and to prevent a closing from occurring unless the pre-determined profit is met.

44. The engine of paragraph 43, wherein the arbitrage builder/transaction assembler is configured to abort a closing if the final arbitrage-transaction profit is insufficient to meet the pre-determined return expectation of all the participants to the arbitrage transaction.

45. The engine of paragraph 44, wherein the mechanism for simultaneous transaction closing, profit calculation and distribution is configured to cause all components of the arbitrage transaction to be completed at a simultaneous closing that is designed to close each component of the transaction simultaneously followed by a settlement process for each component of the transaction.

46. The engine of paragraph 45, wherein the mechanism for simultaneous transaction closing, profit calculation and distribution is configured, at a closing, to debit automatically from the suspense-escrow account the amounts deposited in that account by each successful bidder to guarantee each bid, and to credit the corresponding amounts debited from the suspense-escrow account, in transaction units, to a master-transaction-closing-escrow account identified by the closing number assigned to that closing to cover financial obligations of each successful bidder.

47. The engine of paragraph 46, wherein the mechanism for simultaneous transaction closing, profit calculation and distribution is configured to produce a master-settlement worksheet for the master-transaction closing and a sub-worksheet for each participant in the closing, wherein each worksheet includes pertinent debits and credits to be posted to each account following the closing.

### Ninth Embodiment

1. A wholesale platform of a financial-market exchange for an alternative international fiduciary financial system with an exchange, comprising:

a mechanism for regaining liquidity that is used to complete an arbitrage transaction at the tail-end of a closing of the transaction by connecting the retail and the wholesale markets, thereby to allow banks and financial institutions to bring liquidity to the exchange by enabling banks and financial institutions to submit blind bids in the retail and the wholesale markets of the exchange.

2. The platform of paragraph 1, further including a mechanism for allowing a party to bid to acquire a portfolio of trust-preferred notes secured by deposits in a desired local currency, wherein the party only needs to consider the present value of a future cash-flow stream in its own currency and does not have to consider the currency of the seller of the portfolio.

3. The platform of paragraph 2, further including a mechanism for allowing a financial institution to compete with retail customers by submitting bids in transaction units at the wholesale level that are posted blind on exchange.

4. The platform of paragraph 3, further including a mechanism for hiding the underlying currency that a party used to make a transaction on the exchange by using a notional indexed currency.

5. The platform of paragraph 4, further including a mechanism for on-demand converting a financial instrument in transaction units, chosen from the group comprising a trust-secured loan and a trust-preferred note, back to its original currency by reissuing the financial instrument to the currency that backed it originally.

### Tenth Embodiment

1. A system of financial-transaction clearing and settlement for an alternative international fiduciary financial system that involves an exchange, trade-account holders, trade accounts, trust sub-accounts, assets chosen from the group comprising currencies, traded commodities, real equities, and all items that have a commercial value, trade orders made by trade-account holders, and financial transactions made when trade orders are accepted, comprising:

a cash-posting mechanism for posting cash as a notional-indexed currency debit or credit to the trade account of corresponding trade-account holders.

2. The system of paragraph 1, wherein the currency is a transaction unit.

3. The system of paragraph 2, further including a note-producing mechanism for producing notes that are sold on the exchange in electronic form with a digitized, unique signature and an image accessible electronically, and for simultaneously posting as a credit to the trade account of the note buyer and as a liability to the trade account of the note issuer-seller.

4. The system of paragraph 3, wherein the note-producing mechanism is constructed to produce an image of each note with an icon that appears on an account summary of the trade-account holder of the note, so that the note may be viewed by electronically clicking on the icon symbolizing the note.

5. The system of paragraph 4, wherein all notes and loans used on the exchange are secured by equivalent cash deposits that are held in trust, and those notes and loans are issued in a dematerialized form, thereby to allow those notes and loans to be purchased and sold and traded on the exchange.

6. The system of paragraph 5, constructed to perform clearing and settlement of all transactions via an electronic book-entry process.

The specific embodiments of the invention as disclosed and illustrated herein are not to be considered in a limiting sense as numerous variations are possible. The subject matter of this disclosure includes all novel and non-obvious combinations and sub-combinations of the various features, elements, methods, functions and/or properties disclosed herein. No single feature, function, element or property of the disclosed embodiments is essential. The following claims define certain combinations and sub-combinations which are regarded as novel and non-obvious. Other combinations and sub-combinations of features, functions, elements, methods and/or properties may be claimed through amendment of the present claims or presentation of new claims in this or a related application. Such claims, whether they are different, broader, narrower or equal in scope to the original claims, are also regarded as included within the subject matter of the disclosure.

I claim:

1. A supply-and-demand-driven, bankless, interest-rate and yield-setting mechanism for a fiduciary-based financial system that includes parties who want to trade cash and assets as a way of originating arbitrage transactions for the purpose of making money, comprising:
an interest-rate and yield-setting mechanism constructed to provide the parties with the rates and yields necessary to cooperatively mine intra-currency or cross-currency arbitrage opportunities and, in turn, make money, wherein the mechanism is constructed to operate according to a market-driven, rate-setting process that establishes interest rates without the participation of banks.

2. The mechanism of claim 1, being constructed for a global fiduciary-based financial system to operate in parallel with the global banking system.

3. An automated arbitrage trading-account system, comprising:
a trust account configured with a trust sub-accounts and nested sub-accounts, constructed for access via remote communication;
a trading account constructed to record debits and credits related to trading activity, and being constructed for access via remote communication;
a trading exchange constructed for two-way remote communication between the trust account, trust sub-account, trading account and bank account, and for two-way communication with parties that submit offers and bids for financial transactions;
a trade-related suspense-escrow account constructed to further record debits and credits for guaranteed-execution deposits received by the exchange to support a trade order, and being constructed for access via remote communication;
a switch constructed for communication with the exchange, the trust sub-account, the trading account and bank account; and
wherein the trust sub-account, the trade account, the suspense-escrow account and the bank account are constructed for intercommunication via a switch.

4. The system of claim 3, wherein the trading account is designed to facilitate the placing of offers and bids on an exchange-like platform for components of a pre-engineered arbitrage in interest rates and yields.

5. The system of claim 4, wherein the trading account produces revenue for account holders from arbitrage profits by creating, managing and mining arbitrage-trading opportunities in intra-currency or cross-currency yields and interest rates.

6. The system of claim 3, wherein the trust-account and trust sub-account each have a corresponding trust-account balance and trust sub-account balance, with each balance reflecting a first amount of funds, and with the trust account and trust sub-account each being constructed to record debits and credits related to the trust-account balance, and each being interlinked via a switch.

7. The system of claim 6, wherein the trust account is also connected to a bank account having a bank-account balance reflecting an initial zero balance, being constructed to further record debits and credits related to the bank-account balance, and being constructed for access via remote communication.

8. The system of claim 4, wherein a trust sub-account holder can submit a trade order to the exchange via the switch, so that debits and credits associated with a trade order can pass to the trust sub-account from the exchange via the switch.

9. The system of claim 4, wherein funds reflected by the trust sub-account balance can be managed to support trading activity on the exchange.

10. The system of claim 8, further including a debit card constructed for communication with the trust sub-account and the bank account via the switch.
